(19) United States
(12) Patent Application Publication
(10) Pub. No.: US 2010/0167197 A1
(43) Pub. Date: Jul. 1, 2010

(54) TONER AND PROCESS FOR PRODUCING THE SAME

(75) Inventors: Yasuhito Yuasa, Fukuoka (JP); Masahisa Maeda, Fukuoka (JP); Hidekazu Arase, Fukuoka (JP)

Correspondence Address: HAMRE, SCHUMANN, MUELLER & LARSON P.C., P.O. BOX 2902, MINNEAPOLIS, MN, 55402-0902, US

(73) Assignee: Matsushita Electric Industrial Co., Ltd., Osaka (JP)

(21) Appl. No.: 11/997,825

(22) PCT Filed: Jul. 27, 2006
(86) PCT No.: PCT/JP2006/314830

§ 371 Date: Feb. 4, 2008

(30) Foreign Application Priority Data
Sep. 21, 2005 (JP) 2005-273346
Nov. 1, 2005 (JP) 2005-317929

(51) Int. Cl. G03G 9/12; G03G 9/08

(52) U.S. Cl. 430/112; 430/137.14

(57) ABSTRACT

A toner includes aggregated particles produced by preparing in an aqueous medium a mixed dispersion including at least a first resin particle dispersion in which first resin particles are dispersed, a colorant particle dispersion in which colorant particles are dispersed, and a wax particle dispersion in which wax particles are dispersed, heating the mixed dispersion so that at least part of the wax particles is melted, and aggregating the first resin particles, the colorant particles, and the wax particles at least part of which is melted by the addition of an aqueous solution containing an aggregating agent. Thus, the toner can have a smaller particle size and a sharp particle size distribution without requiring a classification process. Moreover, the toner can achieve a longer life and suppress transfer voids or scattering during transfer.

### TECHNICAL FIELD

The present invention relates to a toner used, e.g., in copiers, laser printers, plain paper facsimiles, color PPCs, color laser printers, color facsimiles or multifunctional devices, and a method for producing the toner.

### BACKGROUND ART

In recent years, the use of image forming apparatuses such as a printer has been shifting increasingly from office to personal purposes, and there is a growing demand for technologies that can achieve, e.g., a small size, a high speed, high image quality, or high reliability for those apparatuses. Under such circumstances, a cleanerless process, a tandem color process, and oilless fixing are required along with better maintainability and less ozone emission. The cleanerless process allows a waste toner, which is a transfer residue in an electrophotographic system, to be recycled for development without cleaning the waste toner. The tandem color process enables high-speed output of color images. The oilless fixing can provide both offset resistance and clear color images with high glossiness and high transmittance, even if no fixing oil is used to prevent offset during fixing. All of these functions should be performed at the same time, and therefore improvements in the toner characteristics as well as the processes are important factors.

In a fixing process for color images of a color printer, it is necessary for each color of toner to be melted and mixed sufficiently to increase the transmittance. In this case, a melt failure of the toner may cause light scattering on the surface or the inside of the toner image, and thus affects the original color of the toner pigment. Moreover, light does not reach the lower layer of the superimposed images, resulting in poor color reproduction. Therefore, the toner should have a property of complete melting and transmittance high enough not to reduce the original color. In particular, the need for light transmittance for an OHP sheet is increasing with an increase in opportunities to give a color presentation.

During the formation of color images, the toner may adhere to the surface of a fixing roller and cause offset. Therefore, a large amount of oil or the like should be applied to the fixing roller, which makes the handling or configuration of equipment more complicated. Thus, oilless fixing (no oil is used for fixing) is required to provide compact, maintenance-free, and low-cost equipment. To achieve the oilless fixing, e.g., a toner having a configuration in which a release agent (wax) is added in a binder resin with a sharp melting property is being put to practical use.

However, such a toner is very prone to a transfer failure or toner image disturbance during transfer because of its strong cohesiveness. Therefore, it is difficult to ensure the compatibility between transfer and fixing. When the toner is used as a two-component developer, so-called spent, in which a low-melting component of the toner adheres to the surface of a carrier, is likely to occur due to heat generated by mechanical collision or friction between the particles of the toner and the carrier or between the particles and the developing unit. This decreases the charging ability of the carrier for the toner and reduces the life of the two-component developer.

A variety of configurations for a toner have been proposed. As is well known, a toner for electrostatic charge development used in electrophotography generally includes a resin component as a binder resin, a coloring component of a pigment or dye, and any other additives such as a plasticizer, a charge control agent, and if necessary, a release agent. As the resin component, a natural or synthetic resin may be used alone or in combination appropriately.

After the above additives are pre-mixed in an appropriate ratio, the components are heated, kneaded, and thermally melted. Then, it is pulverized by an air stream collision board system and classified as fine powder, thus producing toner base particles. The toner base particles also may be produced by chemical polymerization. Subsequently, an additive such as hydrophobic silica is added to the toner base particles, so that the toner is completed. A single-component developer includes only the toner, while a two-component developer is obtained by mixing the toner and a carrier composed of magnetic particles.

Even with pulverization and classification of the conventional kneading and pulverizing processes, the actual particle size can be reduced to only about 8 μm in view of the economic and performance conditions. At present, various methods are considered to produce a toner having a smaller particle size. Moreover, a method for achieving the oilless fixing by adding a release agent (wax) in a resin with a low softening property during melting and kneading also is considered. However, there is a limit to the amount of wax that can be added, and increasing the amount of wax may cause problems such as low flowability of the toner, transfer voids, and filming of the toner on a photoconductive member.

Therefore, various ways of polymerization other than the kneading and pulverizing processes have been studied as a method for producing a toner. For example, a toner may be produced by suspension polymerization. In this method, however, it is difficult to control the particle size distribution of the toner to be narrower than that of a toner produced by the kneading and pulverizing processes, and in many cases further classification is necessary. Moreover, since the toner obtained by this method is almost spherical in shape, the toner remaining on the photoconductive member or the like cannot be cleaned successfully, and thus the reliability of the image quality is reduced.

Also, a toner may be produced by emulsion polymerization. This method includes the following steps: preparing an aggregated particle dispersion by forming aggregated particles in a dispersion in which at least resin particles and colorant particles are dispersed; adding a resin particle dispersion in which resin particles are dispersed to the aggregated particle dispersion and mixing them so that the resin particles adhere to the aggregated particles to form adhesive particles; and heating and fusing the adhesive particles.

Patent Document 1 discloses a toner that includes particles formed by polymerization and a coating layer of fine particles that is formed on the surface of the individual particles by emulsion polymerization. A water-soluble inorganic salt may be added, or the pH of the solution may be changed to form the coating layer of fine particles on the surface of the individual particles.

Patent Document 2 discloses a process of preparing a liquid mixture by mixing at least a resin particle dispersion in which resin particles are dispersed in a surface-active agent having a polarity and a colorant particle dispersion in which colorant particles are dispersed in a surface-active agent having a polarity. The surface-active agents included in the liquid mixture have the same polarity, so that a toner for electrostatic charge image development with high reliability and excellent charge and color development properties can be produced in a simple and easy manner.

Patent Document 3 discloses a release agent including at least one type of ester composed of at least one selected from a higher alcohol having a carbon number of 12 to 30 and a higher fatty acid having a carbon number of 12 to 30, and binder resin particles including at least two types of resin particles with different molecular weights. This configuration can provide a toner with an excellent fixing property, color development property, transparency, and color mixing property.

Patent Document 4 discloses toner particles having a resin layer (shell) formed by fusing resin particles with the surfaces of colored particles (core particles) by a salting-out/fusion method. The colored particles contain a resin and a colorant. It is described that since the amount of the colorant present on the particle surface is small, even if the toner is used for image formation under high humidity environment over a long period of time, it can suppress image density fluctuations, fog, and color changes caused by variations in the charging and developing properties of the toner.

Patent Document 5 discloses a toner for electrostatic charge image development that includes toner particles containing at least a resin and a colorant. The individual toner particles have a core containing a resin A and at least one layer of shell containing a resin B. The core is covered with the shell. The outermost layer of the shell has a thickness of 50 nm to 500 nm. It is described that the toner can exhibit excellent offset resistance and good storage property.

However, when the dispersibility of the release agent added is lowered, the toner images melted during fixing tend to have a dull color. This also decreases the pigment dispersibility, and thus the color development property of the toner becomes insufficient. In the subsequent process, when resin particles further adhere to the surfaces of aggregated particles, the adhesion of the resin particles is unstable due to the low dispersibility of the release agent or the like. Moreover, the release agent that once was aggregated with the resin is liberated into an aqueous medium. Depending on the polarity or the thermal properties such as a melting point, the release agent may have a considerable effect on aggregation of the particles. Further, a specified wax is added in a large amount to achieve the oilless fixing (no oil is used for fixing).

When particles are formed by an aggregation reaction in the medium containing at least a certain amount of wax, the particle size increases with the heat treatment time. Therefore, it is difficult to produce small particles having a narrow particle size distribution.

The use of a release agent may achieve the oilless fixing, reduce fog during development, and improve the transfer efficiency. However, such a release agent prevents uniform mixing and aggregation of the resin particles and the pigment particles in the aqueous medium during manufacture. Thus, the release agent is not aggregated but suspended in the aqueous medium, and the aggregated and fused particles are likely to be coarser due to the effect of the release agent.

In a method for allowing salting-out and fusion to occur simultaneously by adding a salting agent to a dispersion in which resin particles and colorant particles are dispersed, and then increasing the temperature of the dispersion to not less than the glass transition point of the resin particles, the aggregation occurs slowly with temperature-up time Therefore, it is difficult to produce particles having a small particle size and a narrow particle size distribution. Moreover, the aggregation state of non-fused particles is likely to vary, so that the particle size distribution of particles obtained by fusion may become broader, and the surface properties of toner particles as a final product may be changed.

In a method for fusing the resin particles with the surfaces of the colored particles (core particles), the resin particles and an aggregating agent such as magnesium chloride are added to a dispersion of the colored particles obtained by the above process, and then held at a temperature of at least the glass transition point. However, this method requires a long treatment time for fusion. Moreover, particles are likely to be coarser due to secondary aggregation of the core particles, and the particle size distribution tends to be broader. Thus, the growth of the particles needs to be controlled by adding a growth inhibitor.

Patent Document 1: JP 57 (1982)-045558 A

Patent Document 2: JP 10 (1998)-198070 A

Patent Document 3: JP 10 (1998)-301332 A

Patent Document 4: JP 2002-116574 A

Patent Document 5: JP 2004-191618 A

### DISCLOSURE OF INVENTION

### Problem to be Solved by the Invention

It is an object of the present invention to provide a toner that can have a small particle size and a sharp particle size distribution without requiring a classification process. It is another object of the present invention to provide a toner that can achieve low-temperature fixability, high-temperature offset resistance, separability of paper from a fixing roller or the like, and storage stability at high temperatures by using a release agent such as wax in the toner in oilless fixing (no oil is applied to the fixing roller).

### Means for Solving Problem

A toner of the present invention includes aggregated particles produced by preparing in an aqueous medium a mixed dispersion including at least a first resin particle dispersion in which first resin particles are dispersed, a colorant particle dispersion in which colorant particles are dispersed, and a wax particle dispersion in which wax particles are dispersed, heating the mixed dispersion so that at least part of the wax particles is melted, and aggregating the first resin particles, the colorant particles, and the wax particles at least part of which is melted by the addition of an aqueous solution containing an aggregating agent.

A method for producing a toner of the present invention includes the following: preparing in an aqueous medium a mixed dispersion including at least a first resin particle dispersion in which first resin particles are dispersed, a colorant particle dispersion in which colorant particles are dispersed, and a wax particle dispersion in which wax particles are dispersed; heating the mixed dispersion so that at least part of the wax particles is melted; and producing aggregated particles by aggregating the first resin particles, the colorant particles, and the wax particles at least part of which is melted by the addition of an aqueous solution containing an aggregating agent.

### BRIEF DESCRIPTION OF DRAWINGS

FIG. 1 is a cross-sectional view showing the configuration of an image forming apparatus used in an example of the present invention.

FIG. 2 is a cross-sectional view showing the configuration of a fixing unit used in an example of the present invention.

FIG. 3 is a schematic view showing a stirring/dispersing device used in an example of the present invention.

FIG. 4 is a plan view of the stirring/dispersing device in FIG. 3.

FIG. 5 is a schematic view showing a stirring/dispersing device used in an example of the present invention.

FIG. 6 is a plan view of the stirring/dispersing device in FIG. 5.

FIG. 7 shows a TEM (transmission electron microscope) cross-sectional image of toner base particles M1 produced in an example of the present invention (magnification: 20000×).

FIG. 8 shows a TEM cross-sectional image of the toner base particles M1 magnified by 50000 times.

FIG. 9 shows a TEM cross-sectional image of toner base particles M2 produced in an example of the present invention (magnification: 20000×).

FIG. 10 shows a TEM cross-sectional image of the toner base particles M2 magnified by 50000 times.

FIG. 11 shows a TEM cross-sectional image of toner base particles M5f produced in an example of the present invention (magnification: 20000×).

FIG. 12 shows a TEM cross-sectional image of the toner base particles M5f magnified by 50000 times.

FIG. 13 shows a TEM cross-sectional image of toner base particles M6 produced in an example of the present invention (magnification: 20000×).

FIG. 14 shows a TEM cross-sectional image of toner base particles M7 produced in an example of the present invention (magnification: 20000×).

FIG. 15 is a graph showing the relationship between the addition conditions of an aggregating agent and the particle size of a toner in an example of the present invention and a comparative example.

### BEST MODE FOR CARRYING OUT THE INVENTION

In the present invention, the particle dispersions of the resin particles, the colorant particles, and the wax particles are mixed and heated so that at least a part of the wax particles is melted, and then an aggregating agent is added so as to form aggregated particles. This configuration can reduce a treatment time for forming the aggregated particles, suppress the generation of suspended particles that are not incorporated into the aggregated particles, and prevent the aggregated particles from being coarser. Thus, the aggregated particles having a small particle size and a sharp particle size distribution can be produced. The present invention is effective particularly when the colorant particles are carbon particles, and the color of the toner is black.

The core particles may be fused with second resin particles, thereby improving the durability, the charge stability, and the storage stability.

Moreover, the pH value of a second resin particle dispersion in which second resin particles are dispersed may be adjusted within a predetermined range before fusing the second resin particles with the core particles. This configuration can suppress the generation of suspended resin particles that are not fused with the core particles and prevent the particles from being coarser by relieving secondary aggregation of the core particles. Thus, the toner base particles having a small particle size and a sharp particle size distribution can be produced without requiring a classification process.

It is possible not only to improve the low-temperature fixability, the glossiness, and the high-temperature offset resistance, but also to maintain the storage stability.

In a tandem color process, a plurality of image forming stations, each of which includes a photoconductive member and a developing unit, are provided, and the transfer process is performed by successively transferring each color of toner to a transfer member. The use of the toner of the present invention in such a tandem color process can suppress transfer voids or reverse transfer and ensure high transfer efficiency.

The present invention can provide a toner that allows color images with high image quality and high reliability to be formed without causing any toner scattering or fog, and also can provide a method for producing the toner.

Hereinafter, each of the treatment processes will be described.

(1) Polymerization Process

A resin particle dispersion is prepared by forming resin particles of a homopolymer or copolymer (vinyl resin) of vinyl monomers by emulsion or seed polymerization of the vinyl monomers in a surface-active agent and dispersing the resin particles in the surface-active agent. Any known dispersing devices such as a high-speed rotating emulsifier, a high-pressure emulsifier, a colloid-type emulsifier, and a ball mill, sand mill, and Dyno mill that use a medium can be used.

When the resin particles are made of resin other than the homopolymer or copolymer of the vinyl monomers, a resin particle dispersion may be prepared in the following manner. If the resin dissolves in an oil solvent that has a relatively low water solubility, a solution is obtained by mixing the resin with the oil solvent. The solution is blended with a surface-active agent or polyelectrolyte, and then is dispersed in water to produce a fine particle dispersion by using a dispersing device such as a homogenizer. Subsequently, the oil solvent is evaporated by heating or under reduced pressure. Thus, the resin particles made of resin other than the vinyl resin are dispersed in the surface-active agent.

Examples of a polymerization initiator include azo- or diazo-based initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile, persulfates (a potassium persulfate, an ammonium persulfate, etc.), azo compounds (4,4′-azobis-4-cyanovaleric acid and its salt, 2,2′-azobis(2-amidinopropane) and its salt, etc.), and peroxide compounds.

A colorant particle dispersion is prepared by adding colorant particles in water that includes a surface-active agent and dispersing the colorant particles using the above dispersing device.

A wax particle dispersion is prepared by adding wax particles in water that includes a surface-active agent and dispersing the wax particles using an appropriate dispersing device.

The toner is required to achieve fixing at lower temperatures, high-temperature offset resistance in the oilless fixing, releasability, high transmittance of color images, and storage stability at certain high temperatures. These requirements should be satisfied at the same time.

In a first preferred configuration of the toner of the present invention, toner base particles including aggregated particles are produced. The aggregated particles are produced by mixing in an aqueous medium at least the resin particle dispersion in which the resin particles are dispersed, the colorant particle dispersion in which the colorant particles are dispersed, and the wax particle dispersion in which the wax particles are dispersed, and aggregating the particles. Specifically, a mixed dispersion is prepared by mixing in an aqueous medium at least the resin particle dispersion in which the resin particles are dispersed, the colorant particle dispersion in which the colorant particles are dispersed, and the wax particle dispersion in which the wax particles are dispersed, and then the mixed dispersion is heated so that at least part of the wax particles is melted. Under these conditions, the aggregation reaction of the wax particles, the colorant particles, and the resin particles is allowed to occur, thereby forming the aggregated particles.

First, the resin particle dispersion in which the resin particles are dispersed, the colorant particle dispersion in which the colorant particles are dispersed, and the wax particle dispersion in which the wax particles are dispersed are mixed in an aqueous medium to form a mixed dispersion.

Next, this mixed dispersion is heated, and after the liquid temperature of the mixed dispersion reaches a predetermined temperature, a water-soluble inorganic salt is added to the mixed dispersion as an aggregating agent.

The aggregated particles may be formed by mixing the mixed dispersion and an aggregating agent beforehand, and heating the mixed dispersion so that the temperature is increased to not less than the glass transition point of the resin. In this method, however, the aggregation reaction occurs slowly with temperature-up time, and therefore it is difficult to produce particles having a small particle size and a narrow particle size distribution. Moreover, the aggregation state of non-fused particles is likely to vary, so that the particle size distribution of particles obtained by fusion may become broader, and the surface properties of toner particles as a final product may be changed. In particular, the particle size distribution and the surface properties tend to be affected by the wax and the colorant used.

When the aggregating agent is added after the temperature of the mixed dispersion reaches a predetermined temperature or more, a phenomenon in which the aggregation occurs slowly with temperature-up time can be avoided, and the aggregation reaction proceeds rapidly along with the addition of the aggregating agent. Thus, the aggregated particles can be formed in a short time. Moreover, it is possible to produce aggregated particles that incorporate the wax and the colorant uniformly, and have a small particle size and a narrow particle size distribution.

Even if the aggregating agent is added at the time the temperature of the mixed dispersion reaches a glass transition point of the resin, the particles are hardly aggregated to form aggregated particles. By adding the aggregating agent at the time the temperature of the mixed dispersion reaches a specific temperature of the wax, the aggregation of the particles starts, and then the mixed dispersion is heat-treated for 0.5 to 5 hours, preferably 0.5 to 3 hours, and more preferably 1 to 2 hours, thus forming aggregated particles with a predetermined particle size distribution. Although the heat treatment may be performed while maintaining the specific temperature of the wax, the mixture is heated preferably at 80° C. to 95° C., and more preferably at 90° C. to 95° C. The aggregation reaction can be accelerated to shorten the treatment time.

When the pH value of the mixed dispersion (including the resin particle dispersion, the colorant particle dispersion, and the wax particles dispersion) before the heat treatment and the addition of an aqueous solution containing the aggregating agent is identified as HG, it is preferable that the aqueous solution containing the aggregating agent is added with the pH value being adjusted in the range of HG+2 to HG−4. The range is preferable HG+2 to HG−3, more preferably HG+1.5 to HG−2, and further preferably HG+1 to HG−2.

If the aggregating agent aqueous solution whose pH value is different from that of the mixed dispersion is added to the mixed dispersion, the pH balance of the liquid is disturbed suddenly. As a result, there are some cases where the aggregation reaction slows and is difficult to proceed, or the aggregated particles are likely to be coarser. To suppress such phenomena, the pH adjustment of the aggregating agent aqueous solution is effective.

Although the reason is unclear, it may be more preferable that the pH value of the aqueous solution containing the aggregating agent is made lower than that of the mixed dispersion.

When the pH is HG−4 or more, the aggregation action of particles as the aggregating agent is improved further, and thus the aggregation reaction can be accelerated. When the pH is HG+2 or less, it is possible to suppress phenomena in which the aggregated particles become coarser, or the particle size distribution becomes broader.

The pH value of the mixed dispersion in which the resin particles, the colorant particles, and the wax particles are dispersed is preferably 8.4 to 10.4. As will be described later, the pH value of the mixed dispersion before raising the temperature is adjusted preferably in the range of 9.5 to 12.2 so as to make the particle formation better. The pH value tends to be slightly lower during the temperature rise, and when the pH value at the time of dropping the aggregating agent falls in the range of 8.4 to 10.4, the particle formation can be performed stably by aggregation.

In a second preferred configuration of the toner of the present invention, the second resin particle dispersion in which the second resin particles are dispersed is added to the core particle dispersion in which the aggregated particles (also referred to as core particles) produced by the first configuration are dispersed, and the resultant dispersion is mixed and heat-treated so that a resin fused layer is formed on the individual core particles by fusing the second resin particles with the core particles, thus providing toner base particles. This configuration is more effective for the improvement in durability, charge stability, high-temperature offset resistance, and storage stability.

In a third preferred configuration of the toner of the present invention, the second resin particle dispersion in which the second resin particles are dispersed is added to the core particle dispersion produced by the first configuration, and then heat-treated so that a resin fused layer is formed on the individual core particles by fusing the second resin particles with the core particles, and when the pH value of the core particle dispersion in which the core particles are dispersed is identified as HS, the second resin particle dispersion is added with the pH value being adjusted in the range of HS+4 to HS−4. The range is preferably HS+3 to HS−3, more preferably HS+3 to HS−2, and further preferably HS+2 to HS−1.

If the second resin particle dispersion whose pH value is different from that of the core particle dispersion is added to the core particle dispersion, the pH balance of the liquid is disturbed suddenly. As a result, there are some cases where the second resin particles do not adhere to the core particles, or the particles produced become coarser due to secondary aggregation of the core particles. To suppress such phenomena, the pH adjustment of the second resin particle dispersion is effective.

This configuration reduces the generation of suspended particles of the second resin particles, so that the second resin particles can adhere uniformly to the surface of the individual core particles. The adhesion of the second resin particles to the core particles can be promoted, which makes the fusion time shorter. Thus, the productivity can be improved. Moreover, when the second resin particles are fused with the core particles, the particles can be prevented from becoming coarser rapidly, and therefore can have a small particle size and a sharp particle size distribution. If the pH value is more than HS+4, the particles become coarser and the particle size distribution tends to be broader. If the pH value is less than HS−4, the adhesion of the second resin particles to the core particles does not proceed, and the process takes a long time. Moreover, the second resin particles continue to be suspended in the aqueous medium, and the reaction tends not to proceed while the liquid remains white and cloudy.

In the third preferred configuration of the present invention, it is preferable that the pH value of the second resin particle dispersion to be added to the core particle dispersion is adjusted in the range of 3.5 to 11.5 regardless of the pH value of the core particle dispersion in which the core particles are dispersed. The range is preferably 5.5 to 11.5, more preferably 6.5 to 11, and further preferably 6.5 to 10.5.

If the pH is less than 3.5, the adhesion of the second resin particles to the surface of the individual aggregated particles does not proceed, the second resin particles continue to be suspended in the aqueous medium, and thus the liquid remains white and cloudy. If the pH is more than 11.5, the particles produced are likely to be coarser rapidly.

When the pH of the second resin particle dispersion is adjusted to be higher in the range of HS to HS+4, the occurrence of secondary aggregation of the core particles can be controlled, and the shape of the toner base particles (end product) also can be controlled during the addition of the second resin particles.

In other words, the pH of the second resin particle dispersion can be adjusted closer to or higher than the pH of the core particle dispersion in which the core particles are dispersed. By adjusting the pH in this range, secondary aggregation of the core particles is allowed to occur partially while the second resin particles are fused with the core particles. Thus, the particle shape can be controlled from spherical particles to potato-shaped particles.

There is a strong tendency to determine the shape of the toner by its compatibility with the development, transfer, and cleaning processes. Therefore, when the importance of the cleaning properties of a photoconductive member or a transfer belt is stressed, a wider margin for cleaning can be ensured with the potato-shaped particles than the spherical particles of the toner. When the importance of the transfer properties is stressed, the shape of the toner is dose to a sphere so as to improve the transfer efficiency.

In the first, second, and third preferred configurations of the present invention, it is preferable that the pH of the mixed dispersion prepared by mixing in an aqueous medium at least the resin particle dispersion in which the resin particles are dispersed, the colorant particle dispersion in which the colorant particles are dispersed, and the wax particle dispersion in which the wax particles are dispersed is adjusted under predetermined conditions. Such pH adjustment makes it possible to control the aggregation state of the particles, to prevent the particles produced from being coarser, and to suppress the generation of liberated wax or colorant particles.

The pH of the mixed dispersion is adjusted preferably in the range of 9.5 to 12.2, more preferably in the range of 10.5 to 12.2, and further preferably in the range of 11.2 to 12.2. In this case, 1N NaOH can be used for the pH adjustment. If the pH is less than 9.5, the particles produced become coarser. If the pH is more than 12.2, the numbers of liberated wax particles or colorant particles are increased, and it is difficult to incorporate the wax and the colorant uniformly into the resin.

The pH of the liquid at the time of forming the aggregated particles with a predetermined volume-average particle size is maintained in the range of 7.0 to 9.5. This can reduce the liberation of the wax or the colorant, and thus allows the aggregated particles incorporating the wax and the colorant to have a small particle size and a narrow particle size distribution. The amount of NaOH added, the type or amount of the aggregating agent, the pH values of the emulsion-polymerized resin dispersion, the colorant dispersion and the wax dispersion, a heating temperature, or time may be selected appropriately. If the pH of the liquid is less than 7.0 at the time of forming the aggregated particles, the aggregated particles become coarser. If the pH of the liquid is more than 9.5, the amount of liberated wax is increased due to poor aggregation. As a preferred example, the pH of the mixed dispersion obtained by dispersing the first resin particles (preferably, at least part of the first resin particles is melted), the colorant particles, and the wax particles at least part of which is melted in an aqueous medium is set to 7 to 8, and the aggregating agent solution having a pH of 8.5 to 9.5 is added to the mixed dispersion while being heated. This can suppress the liberation of the wax and the colorant (e.g., carbon black that is black in color), and provide the aggregated particles having a small particle size and a narrow particle size distribution.

When persulfate (e.g., potassium persulfate) is used as a polymerization initiator in the emulsion polymerization of the resin to prepare a resin particle dispersion, the residue may be decomposed by heat applied during the aggregation process and may change (reduce) the pH of the mixed dispersion. Therefore, it is preferable that a heat treatment is performed at temperatures not less than a predetermined temperature (preferably 80° C. or more for sufficient decomposition of the residue) for a predetermined time (preferably about 1 to 5 hours) after the emulsion polymerization. The pH of the resin particle dispersion is preferably 4 or less, and more preferably 1.8 or less.

The pH may be measured in the following manner. A sample (the liquid to be measured) is taken out from a liquid tank in an amount of 10 ml with a pipet and put into a beaker having approximately the same capacity. Then, this beaker is immersed in cold water, and the sample is cooled to room temperature (30° C. or less). Using a pH meter (SevenMulti manufactured by Mettler-Tolede Inc.), a measuring probe is dipped into the sample that has been cooled to room temperature. When the display of the meter is stabilized, the numerical value is read as a pH value.

After adjusting the pH of the mixed dispersion, the liquid temperature of the mixed dispersion is raised while stirring. The rate of temperature rise is preferably 0.1 to 10° C./min. If it is slow, the productivity is reduced. If it is too fast, the particle surface has not been smooth before the particles become spherical in shape

With respect to the heating temperature of the wax, it is preferable that the aggregating agent is added after the temperature reaches a melting point or more of the wax measured by a DSC method, which will be described later. When the aggregating agent is added while the wax has started to melt, the molten wax particles, the resin particles, and the colorant particles are aggregated rapidly. Further, the continuation of the heat treatment can promote the melting of the wax particles and the resin particles, and thus the particle formation can be carried out.

As will be described later, when two or more types of waxes are included, the temperature of the mixed dispersion is set to a melting point or more of the wax having a lower melting point. More preferably, the temperature of the mixed dispersion is adjusted to a melting point or more of the wax having a higher melting point. It is appropriate that the aggregating agent is added at the temperature at which the wax particles have started to melt. Even if the aggregating agent is added at the time the temperature of the mixed dispersion reaches a glass transition point of the resin particles, the aggregation hardly proceeds.

Although the entire amount of the aggregating agent may be added collectively, it is preferable that the aggregating agent is dropped for 1 to 120 minutes. The dropping may be performed intermittently, but continuous dropping is preferred. By dropping the aggregating agent at a constant rate into the heated mixed dispersion, the aggregating agent is mixed gradually and uniformly with the whole mixed dispersion in the reaction system. This can prevent the particle size distribution from being broader due to uneven distribution, and also can suppress the generation of suspended particles of the wax and the colorant. The drop time is preferably 5 to 60 minutes, more preferably 10 to 40 minutes, and further preferably 15 to 35 minutes. This can suppress the presence of colorant or wax particles that are suspended independently because of aggregation failure.

The aggregating agent is dropped in an amount of 1 to 50 parts by weight, preferably 1 to 20 parts by weight, more preferably 5 to 15 parts by weight, and further preferably 5 to 10 parts by weight per 100 parts by weight of the mixed dispersion including the resin particle dispersion in which the resin particles are dispersed, the colorant particle dispersion in which the colorant particles are dispersed, and wax particle dispersion in which the wax particles are dispersed. If the amount of the aggregating agent is small, the aggregation reaction does not proceed. If the amount of the aggregating agent is large, the particles produced are likely to be coarser.

The mixed dispersion also may include ion-exchanged water other than the resin particle dispersion, the colorant particle dispersion, and the wax particle dispersion so as to adjust the solid concentration in the liquid. The solid concentration in the liquid is preferably 5 to 40 wt %.

As the aggregating agent, it is also preferable to use the water-soluble inorganic salt after being adjusted to a predetermined concentration with ion-exchanged water or the like. The concentration of the aqueous solution is preferably 5 to 50 wt %.

In the second or third preferred configuration of the present invention, it is preferable that the second resin particle dispersion is dropped continuously into the core particle dispersion after the core particles reach a predetermined particle size.

In this case, it is preferable that the second resin particle dispersion is dropped while maintaining the liquid temperature of the core particle dispersion in which the core particles have been formed. It is also preferable that the second resin particle dispersion is dropped while suppressing a variation in liquid temperature of the core particle dispersion in which the core particles have been formed. Thus, it is preferable that the second resin particle dispersion is dropped while suppressing a variation in liquid temperature of the core particle dispersion within 10% of the liquid temperature of the core particle dispersion before dropping the second resin particle dispersion. This is because the second resin particles dropped are fused uniformly with the core particles without being suspended. If the liquid temperature of the core particle dispersion is changed to a higher temperature, secondary aggregation of the core particles is likely to occur. If the liquid temperature of the core particle dispersion is changed to a lower temperature, the fusion of the second resin particles with the core particles is slow, so that aggregation of the second resin particles is likely to occur.

Moreover, it is preferable that the second resin particle dispersion is dropped at a constant rate. The drop rate is 1 to 120 minutes, preferably 5 to 60 minutes, and further preferably 10 to 40 minutes. When the drop rate is 1 minute or more, the second resin particles dropped can be fused uniformly with the core particles without being suspended. When the drop rate is 120 minutes or less, it is possible to suppress the aggregation of the second resin particles themselves and prevent the core particles from being coarser.

Moreover, it is also preferable that the second resin particle dispersion is dropped so that the stirring speed of the core particle dispersion during the dropping of the second resin particle dispersion is reduced by 5 to 50% of the stirring speed of the core particle dispersion at the time of forming the core particles. This is because the occurrence of secondary aggregation of the core particles is suppressed, and the second resin particles dropped are fused uniformly with the core particles without being suspended. If the stirring speed is reduced excessively, the particle size tends to be larger.

It is also preferable that the pH of the aqueous medium further is adjusted in the range of 7.5 to 11 after the second resin particles adhere to the surface of the individual core particles, and then the aqueous medium is heat-treated at temperatures not less than the glass transition point of the second resin particles for 0.5 to 5 hours. This further can improve the surface smoothness of the particles while suppressing secondary aggregation of the core particles.

To improve the durability, storage stability, and high-temperature offset resistance of the toner, the thickness of a resin layer formed by the fusion of the second resin particles is preferably 0.5 μm to 2 μm. If the thickness is less than 0.5 μm, the effects of the storage stability and the high-temperature offset resistance cannot be obtained. If the thickness is more than 2 μm, the low-temperature fixability is impaired.

In the first, second or third preferred configuration of the present invention, it is preferable that the main component of the surface-active agent used for each of the first resin particle dispersion, the colorant particle dispersion, and the wax particle dispersion is a nonionic surface-active agent.

It is also preferable that the surface-active agent used for the first resin particle dispersion is a mixture of a nonionic surface-active agent and an ionic surface-active agent, and the main component of the surface-active agent used for the wax particle dispersion is only a nonionic surface-active agent.

Moreover, it is preferable that the surface-active agent used for the first resin particle dispersion is a mixture of a nonionic surface-active agent and an ionic surface-active agent, the main component of the surface-active agent used for the colorant particle dispersion is only a nonionic surface-active agent, and the main component of the surface-active agent used for the wax particle dispersion is only a nonionic surface-active agent.

In the surface-active agent used for each of the colorant particle dispersion and the wax particle dispersion, the nonionic surface-active agent is preferably 50 to 100 wt %, more preferably 60 to 100 wt %, and further preferably 60 to 90 wt % of the total surface-active agent.

This configuration eliminates the presence of colorant or wax particles that are not aggregated but suspended in the aqueous medium, and thus can form the core particles having a smaller particle size and a uniform, narrow and sharp particle size distribution. Moreover, the numbers of suspended second resin particles are reduced, and the second resin particles can be fused uniformly with the surface of the individual core particles, providing a sharp particle size distribution.

It is preferable that the surface-active agent used for the first resin particle dispersion in which the first resin particles are dispersed is a mixture of a nonionic surface-active agent and an ionic surface-active agent. The nonionic surface-active agent is preferably 50 to 95 wt %, more preferably 55 to 90 wt %, and further preferably 60 to 85 wt % of the total surface-active agent. If the nonionic surface-active agent is less than 50 wt %, stable aggregated particles are not likely to be produced. If the nonionic surface-active agent is more than 95 wt %, the dispersion of the resin particles is not stable.

Further, it is preferable that the main component of the surface-active agent used for the second resin particle dispersion is a nonionic surface-active agent. The surface-active agent used for the second resin particle dispersion may be a mixture of a nonionic surface-active agent and an ionic surface-active agent, and the nonionic surface-active agent is preferably 50 to 95 wt %, more preferably 55 to 90 wt %, and further preferably 60 to 85 wt % of the total surface-active agent. If the nonionic surface-active agent is less than 50 wt %, it is difficult to promote the adhesion of the second resin particles to the core particles. If the nonionic surface-active agent is more than 95 wt %, the dispersion of the resin particles is not stable.

The surface-active agent allows the dispersed particles of the wax and the resin to be hydrated by many water molecules. Therefore, the particles are not likely to adhere to each other. However, when an electrolyte is added, it takes the water molecules away from the hydrated particles. Accordingly, the particles can adhere easily, so that more and more particles join and grow into larger particles. In this case, when an ionic surface-active agent, e.g., an anionic surface-active agent is used for both resin dispersion and wax dispersion, although the aggregated particles are formed, some wax particles repel each other while the water molecules are taken away by the electrolyte. Thus, there may be particles formed by aggregating only the wax particles suspended independently. The presence of such particles that are not involved in the aggregation reaction can cause filming of the toner on a photoconductive member, a reduction in image density during development, and an increase in fog. Moreover, the suspended particles gradually join with the aggregated particles as the aggregation reaction proceeds by heating for a predetermined time Consequently, the resultant particles become coarser and have a broad particle size distribution.

In the case of the wax particle dispersion using a nonionic surface-active agent, when an electrolyte is added, it takes the water molecules away from the hydrated particles. Accordingly, the particles can adhere easily, so that more and more particles join and grow into larger particles. Since the nonionic surface-active agent is used, the effect of repulsion of the wax particles is small while the water molecules are taken away by the electrolyte. This can suppress the presence of particles formed by aggregating only the wax particles suspended independently. Thus, it is possible to produce particles having a uniform sharp particle size distribution.

After the second resin particles are fused with the core particles to form a resin fused layer, cleaning, liquid-solid separation, and drying processes may be performed as desired to provide toner base particles. The cleaning process preferably involves sufficient substitution cleaning with ion-exchanged water to improve the chargeability. The liquid-solid separation process is not particularly limited, and any known filtration methods such as suction filtration and pressure filtration can be used preferably in view of productivity. The drying process is not particularly limited, and any known drying methods such as flash-jet drying, flow drying, and vibration-type flow drying can be used preferably in view of productivity.

The water-soluble inorganic salt is selected as an aggregating agent, and may be, e.g., an alkali metal salt or alkaline-earth metal salt. Examples of the alkali metal include lithium, potassium, and sodium. Examples of the alkaline-earth metal include magnesium, calcium, strontium, and barium. Among these, potassium, sodium, magnesium, calcium, and barium are preferred. The counter ions (the anions constituting a salt) of the above alkali metals or alkaline-earth metals may be, e.g., a chloride ion, bromide ion, iodide ion, carbonate ion, or sulfate ion.

The nonionic surface-active agent may be, e.g., a polyethylene glycol-type nonionic surface-active agent or a polyol-type nonionic surface-active agent. Examples of the polyethylene glycol-type nonionic surface-active agent include a higher alcohol ethylene oxide adduct, alkylphenol ethylene oxide adduct, fatty acid ethylene oxide adduct, polyol fatty acid ester ethylene oxide adduct, fatty acid amide ethylene oxide adduct, ethylene oxide adduct of fats and oils, and polypropylene glycol ethylene oxide adduct. Examples of the polyol-type nonionic surface-active agent include fatty acid ester of glycerol, fatty acid ester of pentaerythritol, fatty acid ester of sorbitol and sorbitan, fatty acid ester of cane sugar, polyol alkyl ether, and fatty acid amide of alkanolamines.

In particular, the polyethylene glycol-type nonionic surface-active agent such as a higher alcohol ethylene oxide adduct or alkylphenol ethylene oxide adduct can be used preferably.

Examples of the aqueous medium include water such as distilled water or ion-exchanged water, and alcohols. They can be used individually or in combinations of two or more. The content of the polar surface-active agent need not be defined generally and may be selected appropriately depending on the purposes.

When the nonionic surface-active agent is used with the ionic surface-active agent, the polar surface-active agent may be, e.g., a sulfate-based, sulfonate-based, or phosphate-based anionic surface-active agent or an amine salt-type or quaternary ammonium salt-type cationic surface-active agent.

Specific examples of the anionic surface-active agent include sodium dodecyl benzene sulfonate, sodium dodecyl sulfate, sodium alkyl naphthalene sulfonate, and sodium dialkyl sulfosuccinate.

Specific examples of the cationic surface-active agent include alkyl benzene dimethyl ammonium chloride, alkyl trimethyl ammonium chloride, and distearyl ammonium chloride. They can be used individually or in combinations of two or more.

(2) Wax

It is preferable that a plurality of types of waxes are added so as to improve the low-temperature fixability, the high-temperature offset resistance, or the separability of a transfer medium such as copy paper, on which the molten toner is put during fixing, from a heating roller or the like, to increase tolerances for the opposing fixing characteristics of low-temperature fixability, high-temperature offset resistance and storage stability, and also to enhance the functionality.

The wax particle dispersion may be prepared in such a manner that wax is mixed in an aqueous medium (e.g., ion-exchanged water) including the surface-active agent, and then is heated, melted, and dispersed.

As a first preferred configuration, the wax may include at least a first wax and a second wax, the endothermic peak temperature (melting point: Tmw1 (° C.)) of the first wax based on a DSC method is 50° C. to 90° C., and the endothermic peak temperature (melting point: Tmw2 (° C.)) of the second wax based on the DSC method is 80° C. to 120° C. Tmw1 is preferably 55° C. to 85° C., more preferably 60° C. to 85° C., and further preferably 65° C. to 75° C. If Tmw1 is lower than 50° C., the storage stability is likely to be degraded. If Tmw1 is higher than 90° C., the low-temperature fixability and the color glossiness are not likely to be improved. Tmw2 is more preferably 85° C. to 100° C., and further preferably 90° C. to 100° C. If Tmw2 is lower than 80° C., the high-temperature offset resistance and the separability of paper are likely to be weakened. If Tmw2 is higher than 120° C., the aggregation of the wax is reduced, and the numbers of liberated particles are increased in the aqueous medium.

In the first preferred configuration of the wax, the waxes with different melting points are aggregated with the resin and the colorant in the aqueous medium to form toner particles. In this case, when a dispersion obtained by emulsifying and dispersing the first wax and the second wax separately is mixed with the resin particle dispersion and the colorant particle dispersion, and then this mixed dispersion is heated and aggregated, some wax is not incorporated into the molten aggregated particles (toner particles) due to a difference in melting rate between the waxes, and suspended particles are present in the aqueous medium. Thus, the aggregation of the aggregated particles does not proceed, and the particle size distribution tends to be broader. Therefore, it may be difficult to incorporate the wax uniformly into the toner, and to form particles having a small particle size and a narrow particle size distribution. Moreover, the problem of a rapid change of the particles produced to become coarse particles when the second resin is fused with the core particles (to form a shell) also cannot be solved satisfactorily.

Accordingly, it is preferable that the wax particle dispersion is produced by mixing, emulsifying, and dispersing the first wax and the second wax together. In this case, the first wax and the second wax may be mixed at a predetermined mixing ratio, and then heated, emulsified, and dispersed in an emulsifying and dispersing device. The first wax and the second wax may be put in the device either separately or simultaneously. However, it is preferable that the wax particle dispersion thus produced includes the first wax and the second wax in the mixed state.

As a second preferred configuration, the wax may include at least a first wax and a second wax, the first wax may include an ester wax composed of at least one of a higher alcohol having a carbon number of 16 to 24 and a higher fatty acid having a carbon number of 16 to 24, and the second wax may include an aliphatic hydrocarbon wax.

As a third preferred configuration, the wax may include at least a first wax and a second wax, the first wax may include a wax having an iodine value of not more than 25 and a saponification value of 30 to 300, and the second wax may include an aliphatic hydrocarbon wax.

In the second and third preferred configurations of the wax, the endothermic peak temperature (melting point: Tmw1 (° C.)) of the first wax based on the DSC method is 50° C. to 90° C., preferably 55° C. to 85° C., more preferably 60° C. to 85° C., and further preferably 65° C. to 75° C. If Tmw1 is lower than 50° C., the storage stability and the heat resistance of the toner are likely to be degraded. If Tmw1 is higher than 90° C., the aggregation of the wax is reduced, and the numbers of liberated particles are increased in the aqueous medium. Moreover, the low-temperature fixability and the glossiness are not likely to be improved.

In the second and third preferred configurations of the wax, the endothermic peak temperature (melting point: Tmw2 (° C.))) of the second wax based on the DSC method is 80° C. to 120° C., preferably 85° C. to 100° C., and more preferably 90° C. to 100° C. If Tmw2 is lower than 80° C., the storage stability is degraded, and the high-temperature offset resistance and the separability of paper are likely to be weakened. If Tmw2 is higher than 120° C., the aggregation of the wax is reduced, and the numbers of liberated particles are increased in the aqueous medium. Moreover, the low-temperature fixability and the color transmittance are likely to be impaired.

In the second or third preferred configuration of the wax, when the resin, the colorant, and the aliphatic hydrocarbon wax are mixed to form aggregated particles in an aqueous medium, the aliphatic hydrocarbon wax is unlikely to be aggregated with the resin because of its conformability with the resin. Therefore, some wax is not incorporated into the molten aggregated particles, and suspended particles are present in the aqueous medium. Such presence of the suspended particles may hinder the progress of aggregation and make the particle size distribution broader.

However, if the temperature or time of the heat treatment is changed to reduce the suspended particles or to prevent a broad particle size distribution, the particle size is increased. Moreover, when the second resin particles are added further to form a shell, the aggregated particles become coarser rapidly.

By using the wax that includes the first wax including a specified wax and the second wax including a specified aliphatic hydrocarbon wax, it is possible to suppress the presence of suspended particles that do not incorporate the aliphatic hydrocarbon wax and to prevent the particle size distribution of the aggregated particles from being broader. Moreover, when the second resin particles are added to form a shell, it is also possible to reduce a phenomenon in which the aggregated particles become coarser rapidly.

In the heating and aggregation processes, it is assumed that the first wax continues to be compatibilized with the resin, which promotes aggregation of the aliphatic hydrocarbon wax and the resin, and therefore the wax is incorporated uniformly, and the generation of suspended particles can be suppressed. When the first wax is partially compatibilized with the resin, it tends to improve the low-temperature fixability further. The aliphatic hydrocarbon wax is not compatibilized with the resin, and thus can have the effects of improving the high-temperature offset resistance and the separability of paper. In other words, the first wax may function as both a dispersion assistant for emulsifying and dispersing the aliphatic hydrocarbon wax and a low-temperature fixing assistant.

In the second or third preferred configuration of the wax, as described in the first preferred configuration, it is preferable that the wax particle dispersion is produced by mixing, emulsifying, and dispersing the first wax and the second wax together. This can suppress the presence of suspended particles that do not incorporate the wax and reduce a phenomenon in which the aggregated particles become coarser rapidly in forming a shell. Thus, it is possible to incorporate the wax uniformly into the toner, and to form particles having a smaller particle size and a narrower particle size distribution.

In the first, second or third preferred configuration of the wax, it is preferable that FT2/ES1 is 0.2 to 10, more preferably 1 to 9, and further preferably 1.5 to 5, where ES1 and FT2 are weight ratios of the first wax and the second wax to 100 parts by weight of the wax in the wax particle dispersion, respectively. If FT2/ES1 is less than 0.2 (i.e., the weight ratio of the first wax is too large), the effect of the high-temperature offset resistance cannot be obtained, and the storage stability is degraded. If FT2/IS1 is more than 10 (i.e., the weight ratio of the second wax is too large), the low-temperature fixing cannot be achieved, and the aggregated particles are likely to be coarser. Moreover, FT2 of 50 wt % or more, and preferably 60 wt % or more is a well-balanced ratio at which the low-temperature fixability, the high-temperature storage stability, and the high-temperature offset resistance can be achieved.

In the first, second or third preferred configuration of the wax, although the dispersion stability is improved by treating the wax, particularly the aliphatic hydrocarbon wax with an anionic surface-active agent, when the particles are aggregated to form aggregated particles, the aggregated particles become coarser, and it may be difficult to obtain particles having a sharp particle size distribution.

Therefore, the wax particle dispersion is produced preferably by mixing, emulsifying, and dispersing the first wax and the second wax with a surface-active agent that includes a nonionic surface-active agent as the main component.

When the first wax and the second wax are mixed and dispersed to form an emulsion dispersion by using the surface-active agent that includes a nonionic surface-active agent as the main component, aggregation of the wax particles themselves can be suppressed, and the dispersion stability can be improved. Then, this wax particle dispersion is mixed with the resin particle dispersion and the colorant particle dispersion, so that the aggregated particles are formed. In this manner, the wax particles are not liberated, and the aggregated particles can have a small particle size and a narrow sharp particle size distribution.

In the first, second or third preferred configuration of the wax, the total amount of the wax added is preferably 5 to 30 parts by weight, more preferably 8 to 25 parts by weight, and further preferably 10 to 20 parts by weight per 100 parts by weight of the binder resin. If the amount is less than 5 parts by weight, the effects of the low-temperature fixability, the high-temperature offset resistance, and the separability of paper cannot be obtained. If the amount is more than 30 parts by weight, it is difficult to control particles with a small particle size.

In the first, second or third preferred configuration of the wax, it is preferable that Tmw2 is 5° C. to 50° C., more preferably 10° C. to 40° C., and further preferably 15° C. to 35° C. higher than Tmw1. Thus, the functions of the waxes can be separated efficiently, so that the low-temperature fixability, the high-temperature offset resistance, and the separability of paper can be ensured together. If the temperature difference is less than 5° C., it is difficult to exhibit the effects of the low-temperature fixability, the high-temperature offset resistance, and the separability of paper. If the temperature difference is more than 50° C., the first and second waxes are phase-separated and not incorporated uniformly into the toner particles.

As a preferred configuration of the first wax, the first wax may include at least one type of ester composed of at least one of a higher alcohol having a carbon number of 16 to 24 and a higher fatty acid having a carbon number of 16 to 24. The use of this wax can suppress the presence of suspended particles that do not incorporate the aliphatic hydrocarbon wax and prevent the particle size distribution of the aggregated particles from being broader. Moreover, when the second resin particles are added to form a shell, it is also possible to reduce a phenomenon in which the aggregated particles become coarser rapidly. Further, the low-temperature fixing is allowed to proceed. By using the first wax with the second wax, it is possible to achieve the high-temperature offset resistance and the separability of paper, to prevent an increase in the particle size, and to produce toner base particles having a small particle size and a narrow particle size distribution.

Examples of the alcohol components include methyl, ethyl, propyl, or butyl monoalcohol, glycols such as ethylene glycol or propylene glycol or polymers thereof, triols such as glycerin or polymers thereof, polyalcohols such as pentaerythritol, sorbitan, and cholesterol. When these alcohol components are polyalcohols, the higher fatty acid may be either monosubstituted or polysubstituted.

Specific examples include the following:

(1) esters composed of a higher alcohol having a carbon number of 16 to 24 and a higher fatty acid having a carbon number of 16 to 24 such as stearyl stearate, palmityl palmitate, behenyl behenate or stearyl montanate;

(2) esters composed of a higher fatty acid having a carbon number of 16 to 24 and a lower monoalcohol such as butyl stearate, isobutyl behenate, propyl montanate or 2-ethylhexyl oleate; and

(3) esters composed of a higher fatty acid having a carbon number of 16 to 24 and polyalcohol such as montanic acid monoethylene glycol ester, ethylene glycol distearate, glyceride monostearate, glyceride monobehenate, glyceride tripalmitate, pentaerythritol monobehenate, pentaerythritol dilinoleate, pentaerythritol trioleate or pentaerythritol tetrastearate; or esters composed of a higher fatty acid having a carbon number of 16 to 24 and a polyalcohol polymer such as diethylene glycol monobehenate, diethylene glycol dibehenate, dipropylene glycol monostearate, diglyceride distearate, triglyceride tetrastearate, tetraglyceride hexabehenate or decaglyceride decastearate.

These waxes can be used individually or in combinations of two or more.

If the carbon number of the alcohol component and/or the acid component is less than 16, the wax is not likely to function as a dispersion assistant. If it is more than 24, the wax is not likely to function as a low-temperature fixing assistant.

As a preferred configuration of the first wax, the first wax may include a wax having an iodine value of not more than 25 and a saponification value of 30 to 300. By using the first wax with the second wax, an increase in the particle size can be prevented, thus producing toner base particles having a small particle size and a narrow particle size distribution. When the iodine value is defined, the dispersion stability of the wax can be improved, and the wax, resin, and colorant particles can be formed uniformly into aggregated particles, so that particles having a small size and a narrow particle size distribution can be produced. However, if the iodine value is more than 25, the dispersion stability is too high, and the wax, resin, and colorant particles cannot be formed uniformly into aggregated particles. Thus, the numbers of suspended particles of the wax are likely to be increased, the particles become coarser, and the particle size distribution tends to be broader. The suspended particles may remain in the toner and cause filming of the toner on a photoconductive member or the like. Therefore, the repulsion due to the charging action of the toner cannot be relieved easily during multilayer transfer in the primary transfer process. If the saponification value is less than 30, the presence of unsaponifiable matter and hydrocarbon is increased and makes it difficult to form small uniform aggregated particles. This may result in filming of the toner on a photoconductive member, low chargeability of the toner, and a reduction in chargeability during continuous use. If the saponification value is more than 300, the number of suspended solids in the aqueous medium is increased significantly. The repulsion due to the charging action of the toner cannot be relieved easily. Moreover, fog or toner scattering may be increased.

The wax with a predetermined iodine value and a predetermined saponification value preferably has a heating loss of not more than 8 wt % at 220° C. If the heating loss is more than 8 wt %, the glass transition point of the toner becomes low, and the storage stability is degraded. Therefore, such wax adversely affects the development property and allows fog or filming of the toner on a photoconductive member to occur. The particle size distribution of the toner becomes broader.

In the molecular weight characteristics of the wax with a predetermined iodine value and a predetermined saponification value, based on gel permeation chromatography (GPC), it is preferable that the number-average molecular weight is 100 to 5000, the weight-average molecular weight is 200 to 10000, the ratio (weight-average molecular weight/number-average molecular weight) of the weight-average molecular weight to the number-average molecular weight is 1.01 to 8, the ratio (Z-average molecular weight/number-average molecular weight) of the Z-average molecular weight to the number-average molecular weight is 1.02 to 10, and there is at least one molecular weight maximum peak in the range of 5×10² to 1×10⁴. It is more preferable that the number-average molecular weight is 500 to 4500, the weight-average molecular weight is 600 to 9000, the weight-average molecular weight/number-average molecular weight ratio is 1.01 to 7, and the Z-average molecular weight/number-average molecular weight ratio is 1.02 to 9. It is further preferable that the number-average molecular weight is 700 to 4000, the weight-average molecular weight is 800 to 8000, the weight-average molecular weight/number-average molecular weight ratio is 1.01 to 6, and the Z-average molecular weight/number-average molecular weight ratio is 1.02 to 8.

If the number-average molecular weight is less than 100, the weight-average molecular weight is less than 200, or the molecular weight maximum peak is in the range smaller than 5×10², the storage stability is degraded. Moreover, the handling property of the toner in a developing unit is reduced and thus impairs the uniformity of the toner concentration. The filming of the toner on a photoconductive member may occur. The particle size distribution of the toner tends to be broader.

If the number-average molecular weight is more than 5000, the weight-average molecular weight is more than 10000, the weight-average molecular weight/number-average molecular weight ratio is more than 8, the Z-average molecular weight/number-average molecular weight ratio is more than 10, and the molecular weight maximum peak is in the range larger than 1×10⁴, the releasing action is weakened, and the low-temperature fixability is degraded. Moreover, it is difficult to reduce the particle size of the emulsified and dispersed particles of the wax.

Suitable materials for the first wax may be, e.g., meadowfoam oil, carnauba wax, jojoba oil, Japan wax, beeswax, ozocerite, candelilla wax, ceresin wax, and rice wax, and derivatives of these materials also are preferred. They can be used individually or in combinations of two or more.

Examples of the meadowfoam oil derivative include a meadowfoam oil fatty acid, a metal salt of the meadowfoam oil fatty acid, meadowfoam oil fatty acid ester, hydrogenated meadowfoam oil, and meadowfoam oil triester. These materials can be used to produce an emulsified dispersion having a small particle size and a uniform particle size distribution. Moreover, the materials are effective to improve the low-temperature fixability in the oilless fixing, the life of a developer, and the transfer property. They can be used individually or in combinations of two or more.

The meadowfoam oil fatty acid obtained by saponifying meadowfoam oil preferably includes a fatty acid having 4 to 30 carbon atoms. As a metal salt of the meadowfoam oil fatty acid, e.g., metal salts of sodium, potassium, calcium, magnesium, barium, zinc, lead, manganese, iron, nickel, cobalt, aluminum or the like can be used. With these materials, the high-temperature offset resistance can be improved.

Examples of the meadowfoam oil fatty acid ester include esters of methyl, ethyl, butyl, glycerin, pentaerythritol, polypropylene glycol, and trimethylol propane. In particular, e.g., meadowfoam oil fatty acid pentaerythritol monoester, meadowfoam oil fatty acid pentaerythritol triester, or meadowfoam oil fatty acid trimethylol propane ester is preferred. These materials are effective for the low-temperature fixability.

The hydrogenated meadowfoam oil can be obtained by adding hydrogen to meadowfoam oil to convert unsaturated bonds to saturated bonds. This material can improve the low-temperature fixability and the glossiness.

Moreover, an isocyanate polymer of meadowfoam oil fatty acid polyol ester, which is obtained by cross-linking a product of the esterification reaction between the meadowfoam oil fatty acid and polyalcohol (e.g., glycerin, pentaerythritol, or trimethylol propane) with isocyanate such as tolylene diisocyanate (TDI) or diphenylmetane-4,4′-diisocyanate (MDI), can be used preferably. This material can suppress spent on a carrier, so that the life of a two-component developer can be made even longer.

Examples of the jojoba oil derivative include a jojoba oil fatty acid, a metal salt of the jojoba oil fatty acid, jojoba oil fatty acid ester, hydrogenated jojoba oil, jojoba oil triester, a maleic acid derivative of epoxidized jojoba oil, an isocyanate polymer of jojoba oil fatty acid polyol ester, and halogenated modified jojoba oil. These materials can be used to produce an emulsified dispersion having a small particle size and a uniform particle size distribution. The resin and the wax can be mixed and dispersed uniformly. Moreover, the materials are effective to improve the low-temperature fixability in the oilless fixing, the life of a developer, and the transfer property. They can be used individually or in combinations of two or more.

The jojoba oil fatty acid obtained by saponifying jojoba oil preferably includes a fatty acid having 4 to 30 carbon atoms. As a metal salt of the jojoba oil fatty acid, e.g., metal salts of sodium, potassium, calcium, magnesium, barium, zinc, lead, manganese, iron, nickel, cobalt, aluminum or the like can be used. With these materials, the high-temperature offset resistance can be improved.

Examples of the jojoba oil fatty acid ester include esters of methyl, ethyl, butyl, glycerin, pentaerythritol, polypropylene glycol, and trimethylol propane. In particular, e.g., jojoba oil fatty acid pentaerythritol monoester, jojoba oil fatty acid pentaerythritol triester, or jojoba oil fatty acid trimethylol propane ester is preferred. These materials are effective for the low-temperature fixability.

The hydrogenated jojoba oil can be obtained by adding hydrogen to jojoba oil to convert unsaturated bonds to saturated bonds. This material can improve the low-temperature fixability and the glossiness.

Moreover, an isocyanate polymer of jojoba oil fatty acid polyol ester, which is obtained by cross-linking a product of the esterification reaction between the jojoba oil fatty acid and polyalcohol (e.g., glycerin, pentaerythritol, or trimethylol propane) with isocyanate such as tolylene diisocyanate (TDI) or diphenylmetane-4,4′-diisocyanate (MDI), can be used preferably. This material can suppress spent on a carrier, so that the life of a two-component developer can be made even longer.

The saponification value is the milligrams of potassium hydroxide (KOH) required to saponify a 1 g sample and corresponds to the sum of an acid value and an ester value. When the saponification value is measured, a sample is saponified with approximately 0.5N potassium hydroxide in an alcohol solution, and then excess potassium hydroxide is titrated with 0.5N hydrochloric acid.

The iodine value may be determined in the following manner. The amount of halogen absorbed by a sample is measured while the halogen acts on the sample. Then, the amount of halogen absorbed is converted to iodine and expressed in grams per 100 g of the sample. The iodine value is grams of iodine absorbed, and the degree of unsaturation of a fatty acid in the sample increases as the iodine value becomes larger. A chloroform or carbon tetrachloride solution is prepared as a sample, and an alcohol solution of iodine and mercuric chloride or a glacial acetic acid solution of iodine chloride is added to the sample. After the sample is allowed to stand, the iodine that remains without undergoing any reaction is titrated with a sodium thiosulfate standard solution, thus calculating the amount of iodine absorbed.

The heating loss may be measured in the following manner. A sample cell is weighed precisely to the first decimal place (W1 mg). Then, 10 to 15 mg of sample is placed in the sample cell and weighed precisely to the first decimal place (W2 mg). This sample cell is set in a differential thermal balance and measured with a weighing sensitivity of 5 mg. After measurement, the weight loss (W3 mg) of the sample at 220° C. is read to the first decimal place using a chart. The measuring device is, e.g., TGD-3000 (manufactured by ULVAC-RICO, Inc.), the rate of temperature rise is 10° C./min, the maximum temperature is 220° C., and the retention time is 1 min. Accordingly, the heating loss can be determined by the following equation.

Heating loss (wt %)=W3/(W2−W1)×100

The endothermic peak temperature (melting point ° C.) of the wax based on the DSC method and the onset temperature may be measured with a Q100 type (in which a genuine electric refrigerator is used for cooling) manufactured by TA Instruments. The measurement mode is set to “standard”, and the flow rate of a purge gas (N₂) is set to 50 ml/min. After the power is turned on, a measurement cell is set at 30° C. and allowed to stand as it is for 1 hour. Then, 10 mg±2 mg of a sample to be measured is put in a pure aluminum pan, and the aluminum pan containing the sample is placed in the measuring equipment. Subsequently, the sample is held at 5° C. for 5 minutes, and the temperature is raised to 150° C. at a rate of temperature rise of 1° C./min. The analysis is conducted using “Universal Analysis Version 4.0” included with the device. In a graph, the temperature inside the vessel is plotted on the horizontal axis and the heat flow is plotted on the vertical axis. The temperature at which an endothermic curve starts to rise from the base line is identified as the onset temperature, and the peak value of the endothermic curve is identified as the endothermic peak temperature (melting point).

Preferred materials that can be used together or instead of the above wax as the first wax may be, e.g., a derivative of hydroxystearic acid, glycerin fatty acid ester, glycol fatty acid ester, or sorbitan fatty acid ester. They can be used individually or in combinations of two or more. These materials can produce smaller particles that are emulsified and dispersed uniformly. By using the first wax with the second wax, an increase in the particle size can be prevented, thus producing toner base particles having a small particle size and a narrow particle size distribution.

The oilless fixing that provides high glossiness and high transmittance can be achieved at low temperatures. Moreover, the life of a developer can be made longer while achieving the oilless fixing.

Examples of the derivative of hydroxystearic acid include methyl 12-hydroxystearate, butyl 12-hydroxystearate, propylene glycol mono12-hydroxystearate, glycerin mono12-hydroxystearate, and ethylene glycol mono12-hydroxystearate. These materials have the effects of improving the low-temperature fixability and the separability of paper in the oilless fixing and preventing filming of the toner on a photoconductive member.

Examples of the glycerin fatty acid ester include glycerol stearate, glycerol distearate, glycerol tristearate, glycerol monopalmitate, glycerol dipalmitate, glycerol tripalmitate, glycerol behenate, glycerol dibehenate, glycerol tribehenate, glycerol monomyristate, glycerol dimyristate, and glycerol trimyristate. These materials have the effects of relieving cold offset at low temperatures in the oilless fixing and preventing a reduction in the transfer property.

Examples of the glycol fatty acid ester include propylene glycol fatty acid ester such as propylene glycol monopalmitate or propylene glycol monostearate and ethylene glycol fatty acid ester such as ethylene glycol monostearate or ethylene glycol monopalmitate. These materials have the effects of improving the low-temperature fixability and preventing spent on a carrier while increasing the sliding property in development.

Examples of the sorbitan fatty acid ester include sorbitan monopalmitate, sorbitan monostearate, sorbitan tripalmitate, and sorbitan tristearate. Moreover, stearic acid ester of pentaerythritol, mixed esters of adipic acid and stearic acid or oleic acid, and the like are preferred. They can be used individually or in combinations of two or more. These materials have the effects of improving the separability of paper in the oilless fixing and preventing filming of the toner on a photoconductive member.

Preferred examples of the second wax include fatty acid hydrocarbon waxes such as a polypropylene wax, polyethylene wax, polypropylene-polyethylene copolymer wax, microcrystalline wax, paraffin wax, and Fischer-Tropsch wax.

As the second wax, e.g., a modified wax obtained by the reaction of long chain alkyl alcohol, unsaturated polycarboxylic acid or its anhydride, and synthetic hydrocarbon wax also can be used.

In this modified second wax, it is preferable that the long chain alkyl group has a carbon number of 4 to 30, and the acid value is 10 to 80 mgKOH/g. Moreover, the second wax may be obtained by the reaction of long chain alkylamine, unsaturated polycarboxylic acid or its anhydride, and unsaturated hydrocarbon wax. Alternatively, the second wax may be obtained by the reaction of long chain fluoroalkyl alcohol, unsaturated polycarboxylic acid or its anhydride, and unsaturated hydrocarbon wax. In either case, the long chain alkyl group can promote the releasing action, the ester group can improve the dispersibility of the wax with the resin, and the vinyl group can enhance the durability and the offset resistance.

For the molecular weight distribution of the modified second wax based on GPC, it is preferable that the weight-average molecular weight is 1000 to 6000, the Z-average molecular weight is 1500 to 9000, the ratio (weight-average molecular weight/number-average molecular weight) of the weight-average molecular weight to the number-average molecular weight is 1.1 to 3.8, the ratio (Z-average molecular weight/number-average molecular weight) of the Z-average molecular weight to the number-average molecular weight is 1.5 to 6.5, there is at least one molecular weight maximum peak in the range of 1×10³ to 3×10⁴, the acid value is 10 to 80 mgKOH/g, the melting point is 80° C. to 120° C., and the penetration number is not more than 4 at 25° C. It is more preferable that the weight-average molecular weight is 1000 to 5000, the Z-average molecular weight is 1700 to 8000, the weight-average molecular weight/number-average molecular weight ratio is 1.1 to 2.8, the Z-average molecular weight/number-average molecular weight ratio is 1.5 to 4.5, there is at least one molecular weight maximum peak in the range of 1×10³ to 1×10⁴, the acid value is 10 to 50 mgKOH/g, and the melting point is 85° C. to 100° C. It is further preferable that the weight-average molecular weight is 1000 to 2500, the Z-average molecular weight is 1900 to 3000, the weight-average molecular weight/number-average molecular weight ratio is 1.2 to 1.8, the Z-average molecular weight/number-average molecular weight ratio is 1.7 to 2.5, there is at least one molecular weight maximum peak in the range of 1×10³ to 3×10³, the acid value is 35 to 50 mgKOH/g, and the melting point is 90° C. to 100° C.

The modified second wax can improve the high-temperature offset resistance in the oilless fixing and does not decrease the storage stability. When an image is formed by arranging three layers of color toner on a thin paper, the modified second wax is particularly effective to improve the separability of the paper from the fixing roller or the fixing belt.

By combining the toner to which the modified second wax is added with a carrier, it is possible not only to achieve the oilless fixing but also to suppress the occurrence of spent on the carrier. Thus, the life of a developer can be made longer. Moreover, it is also possible to ensure the compatibility between the fixability and the development stability.

If the carbon number of the long chain alkyl group of the modified wax is less than 4, the releasing action is weakened, so that the separability and the high-temperature offset resistance are degraded. If the carbon number is more than 30, the mixing and aggregation of the wax with the resin become poor, resulting in low dispersibility. If the acid value is less than 10 mgKOH/g, the charge amount of the toner is reduced over a long period of use. If the acid value is more than 80 mgKOH/g, the moisture resistance is decreased to increase fog under high humidity. Moreover, it is difficult to reduce the particle size of the emulsified and dispersed particles of the wax. If the melting point is less than 80° C., the storage stability of the toner is reduced, and the high-temperature offset resistance is degraded. If the melting point is more than 120° C., the low-temperature fixability is weakened, and the color glossiness is lowered. Moreover, it is difficult to reduce the particle size of the emulsified and dispersed particles of the wax. If the penetration number is more than 4 at 25° C., the toughness is reduced to cause filming of the toner on a photoconductive member over a long period of use. If the weight-average molecular weight is less than 1000, the Z-average molecular weight is less than 1500, the weight-average molecular weight/number-average molecular weight ratio is less than 1.1, the Z-average molecular weight/number-average molecular weight ratio is less than 1.5, and the molecular weight maximum peak is in the range smaller than 1×10³, the storage stability of the toner is degraded, and filming of the toner on a photoconductive member or intermediate transfer member is likely to occur. The handling property of the toner in a developing unit is reduced, and the uniformity of the toner concentration tends to be lower. The particle size distribution of the emulsified and dispersed particles becomes broader. If the weight-average molecular weight is more than 6000, the Z-average molecular weight is more than 9000, the weight-average molecular weight/number-average molecular weight ratio is more than 3.8, the Z-average molecular weight/number-average molecular weight ratio is more than 6.5, and the molecular weight maximum peak is in the range larger than 3×10⁴, the releasing action is weakened, and the high-temperature offset resistance is degraded. Moreover, it is difficult to reduce the particle size of the emulsified and dispersed particles of the wax.

Examples of the alcohol used for the modified second wax include alcohols having an alkyl chain with a carbon number of 4 to 30 such as octanol (C₈H₁₇OH) dodecanol (C₁₂H₂₅OH), stearyl alcohol (C₁₈H₃₇OH), nonacosanol (C₂₉H₅₉OH), and pentadecanol (C₁₅H₃₁OH). Examples of the amines include N-methylhexylamine, nonylamine, stearylamine, and nonadecylamine. In addition, 1-methoxy-(perfluoro-2-methyl-1-propene), 3-perfluorooctyl-1,2-epoxypropane, or the like can be used preferably as a fluoroalkyl alcohol.

Examples of the unsaturated polycarboxylic acid or its anhydride used for the modified second wax include maleic acid, maleic anhydride, itaconic acid, itaconic anhydride, citraconic acid, and citraconic anhydride. They can be used individually or in combinations of two or more. In particular, the maleic acid and the maleic anhydride are preferred. Examples of the unsaturated hydrocarbon wax include ethylene, propylene, and α-olefin.

The unsaturated polycarboxylic acid or its anhydride is polymerized using alcohol or amine, and then is added to the synthetic hydrocarbon wax in the presence of dicumyl peroxide or tert-butylperoxy isopropyl monocarbonate.

The wax should be incorporated uniformly into the resin so as not to be liberated or suspended during mixing and aggregation. This may be affected by the particle size distribution, composition, and melting property of the wax.

The wax particle dispersion may be prepared in such a manner that the wax is mixed in an aqueous medium (e.g., ion-exchanged water) including the surface-active agent, and then is heated, melted, and dispersed.

In this case, the wax may be emulsified and dispersed so that the particle size is 20 to 200 nm for 16% diameter (PR16), 40 to 300 nm for 50% diameter (PR50), not more than 400 nm for 84% diameter (PR84), and PR84/PR16 is 1.2 to 2.0 in a cumulative volume particle size distribution obtained by accumulation from the smaller particle diameter side. It is preferable that the ratio of particles having a diameter not greater than 200 nm is 65 vol % or more, and the ratio of particles having a diameter greater than 500 nm is 10 vol % or less.

Preferably, the particle size may be 20 to 100 nm for 16% diameter (PR16), 40 to 160 nm for 50% diameter (PR50), not more than 260 nm for 84% diameter (PR84), and PR84/PR16 is 1.2 to 1.8 in the cumulative volume particle size distribution obtained by accumulation from the smaller particle diameter side. It is preferable that the ratio of particles having a diameter not greater than 150 nm is 65 vol % or more, and the ratio of particles having a diameter greater than 400 nm is 10 vol % or less.

More preferably, the particle size may be 20 to 60 nm for 16% diameter (PR16), 40 to 120 nm for 50% diameter (PR50), not more than 220 nm for 84% diameter (PR84), and PR84/PR16 is 1.2 to 1.8 in the cumulative volume particle size distribution obtained by accumulation from the smaller particle diameter side. It is preferable that, the ratio of particles having a diameter not greater than 130 nm is 65 vol % or more, and the ratio of particles having a diameter greater than 300 nm is 10 vol % or less.

When the resin particle dispersion, the colorant particle dispersion, and the wax particle dispersion are mixed and aggregated to form aggregated particles, the wax with a particle size of 40 to 300 nm for 50% diameter (PR50) is dispersed finely and thus incorporated easily into the resin particles. Therefore, it is possible to prevent aggregation of the wax particles themselves that are not aggregated with the resin particles and the colorant particles, to achieve uniform dispersion, and to eliminate the suspended particles in the aqueous medium.

Moreover, when the aggregated particles are heated and melted in the aqueous medium, the molten wax particles are surrounded by the molten resin particles due to surface tension, so that the wax can be incorporated easily into the resin particles.

If the particle sin is more than 200 nm for PR16, more than 300 nm for PR50, and more than 400 nm for PR84, PR84/PR16 is more than 2.0, the ratio of particles having a diameter not greater than 200 nm is less than 65 vol %, or the ratio of particles having a diameter greater than 500 nm is more than 10 vol %, the wax particles are not incorporated easily into the resin particles and thus are prone to aggregation by themselves. Therefore, a large number of particles that are not incorporated into the resin particles are likely to be suspended in the aqueous medium. When the aggregated particles are heated and melted in the aqueous medium, the molten wax particles are not surrounded by the molten resin particles, so that the wax cannot be incorporated easily into the resin particles. Moreover, the amount of wax that is exposed on the surfaces of the toner base particles and liberated therefrom is increased while further resin particles are fused. This may increase filming of the toner on a photoconductive member or spent of the toner on a carrier, reduce the handling property of the toner in a developing unit, and cause a developing memory.

If the particle size is less than 20 nm for PR16 and less than 40 nm for PR50, and PR84/PR16 is less than 1.2, it is difficult to maintain the dispersion state, and reaggregation of the wax occurs during the time it is allowed to stand, so that the standing stability of the particle size distribution can be degraded. Moreover, the load and heat generation are increased while the particles are dispersed, thus reducing productivity.

When the particle size for 50% diameter (PR50) of the wax particles dispersed in the wax particle dispersion is smaller than the particle size for 50% diameter (PR50) of the resin particles in forming the aggregated particles, the wax can be incorporated easily into the resin particles.

Therefore, it is possible to prevent aggregation of the wax particles themselves that are not aggregated with the resin particles and the colorant particles, to achieve uniform dispersion, and to eliminate the suspended particles in the aqueous medium. Moreover, when the aggregated particles are heated and melted in the aqueous medium, the molten wax particles are surrounded by the molten resin particles due to surface tension, so that the wax can be incorporated easily into the resin particles. It is more preferable that the particle size for 50% diameter (PR50) of the wax particles is at least 20% smaller than that of the resin particles.

The wax particles can be dispersed finely in the following manner. A wax melt in which the wax is melted at a concentration of not more than 40 wt % is emulsified and dispersed into a medium that includes a surface-active agent and is maintained at temperatures not less than the melting point of the wax by utilizing the effect of a strong shearing force generated when a rotating body rotates at high speed relative to a fixed body with a predetermined gap between them.

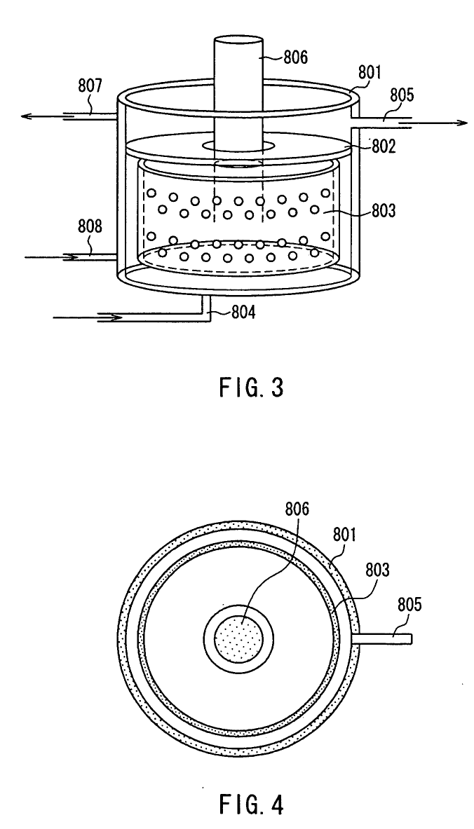

As shown in FIGS. 3 and 4, e.g., a rotating body may be placed in a tank having a certain capacity so that there is a gap of about 0.1 mm to 10 mm between the side of the rotating body and the tank wall. The rotating body rotates at a high speed of not less than 30 m/s, preferably not less than 40 m/s, and more preferably not less than 50 m/s and exerts a strong shearing force on the liquid, thus producing an emulsified dispersion with a finer particle size. A 30-second to 5-minute treatment may be enough to obtain the fine dispersion.

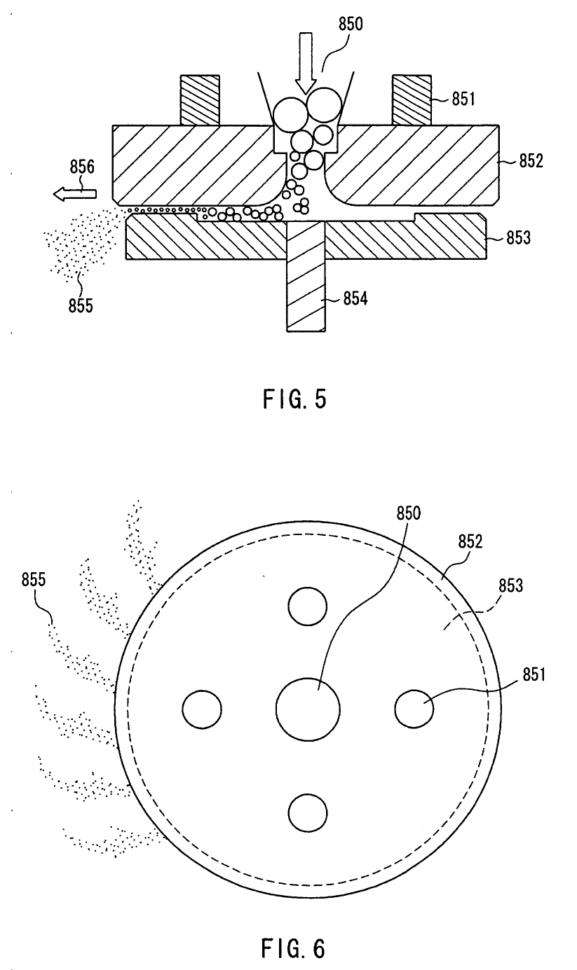

As shown in FIGS. 5 and 6, e.g., a rotor may rotate at a speed of not less than 30 m/s, preferably not less than 40 m/s, and more preferably not less than 50 m/s relative to a stator, while a gap of about 1 to 100 μm is kept between them. This configuration also can provide the effect of a strong shearing force, thus producing a fine dispersion.

In this manner, it is possible to form a narrower and sharper particle size distribution of the fine particles than using a dispersing device such as a homogenizer. It is also possible to maintain a stable dispersion state without causing any reaggregation of the fine particles in the dispersion even when left standing for a long time. Thus, the standing stability of the particle size distribution can be improved.

When the wax has a high melting point, it may be heated under high pressure to form a melt. Alternatively, the wax may be dissolved in an oil solvent. This solution is blended with a surface-active agent or polyelectrolyte and dispersed in water to make a fine particle dispersion by using either of the dispersing devices as shown in FIGS. 3 and 4 and FIGS. 5 and 6, and then the oil solvent is evaporated by heating or under reduced pressure.

The particle size can be measured, e.g., by using a laser diffraction particle size analyzer LA920 (manufactured by Horiba, Ltd.) or SALD2100 (manufactured by Shimadzu Corporation).

(3) Resin

As the resin particles of the toner of this embodiment, e.g., a thermoplastic binder resin can be used. Specific examples of the thermoplastic binder resin include the following: styrenes such as styrene, parachloro styrene, and α-methyl styrene; acrylic monomers such as methyl acrylate, ethyl acrylate, n-propyl acrylate, lauryl acrylate, and 2-ethylhexyl acrylate; methacrylic monomers such as methyl methacrylate, ethyl methacrylate, n-propyl methacrylate, lauryl methacrylate, and 2-ethylhexyl methacrylate; a homopolymer of unsaturated polycarboxylic acid monomers having a carboxyl group as a dissociation group such as acrylic acid, methacrylic acid, maleic acid, or fumaric acid; a copolymer of two or more types of these monomers; or a mixture of these substances.

The content of the resin particles in the resin particle dispersion is generally 5 to 50 wt %, and preferably 10 to 40 wt %.

To produce aggregated particles (also referred to as core particles) having a sharp particle size distribution by the aggregation reaction of the first resin particles, the wax particles, and the colorant particles while eliminating the presence of suspended particles, the first resin particles preferably have a glass transition point of 45° C. to 60° C. and a softening point of 90° C. to 140° C., more preferably a glass transition point of 45° C. to 55° C. and a softening point of 90° C. to 135° C., and further preferably a glass transition point of 45° C. to 52° C. and a softening point of 90° C. to 130° C. As a preferred configuration of the first resin particles, the weight-average molecular weight (Mw) is 10000 to 60000, and the ratio (Mw/Mn) of the weight-average molecular weight (Mw) to the number average molecular weight (Mn) is 1.5 to 6. It is more preferable that the weight-average molecular weight (Mw) is 10000 to 50000, and the ratio (Mw/Mn) of the weight-average molecular weight (Mw) to the number-average molecular weight (Mn) is 1.5 to 3.9. It is further preferable that the weight-average molecular weight (Mw) is 10000 to 30000, and the ratio (Mw/Mn) of the weight-average molecular weight (Mw) to the number-average molecular weight (Mn) is 1.5 to 3.

By including the first resin particles and the wax, the core particles can be prevented from being coarser and can be produced efficiently with a narrow particle size distribution. It is also possible to ensure the low-temperature fixability, to reduce a change in image glossiness with respect to a fixing temperature, and to make the image glossiness constant. Since the image glossiness generally increases with the fixing temperature, the glossiness of an image varies depending on the fixing temperature. Therefore, the fixing temperature has had to be controlled strictly. However, the above configuration is effective to reduce variations in the image glossiness, even if the fixing temperature changes.

If the glass transition point of the first resin particles is lower than 45° C., the core particles become coarser, and the storage stability and the heat resistance are reduced. If the glass transition point is higher than 60° C., the low-temperature fixability is degraded. If Mw is smaller than 10000, the core particles become coarser, and the storage stability and the heat resistance are reduced. If Mw is larger than 60000, the low-temperature fixability is degraded. If Mw/Mn is larger than 6, the core particles are not stable but irregular in shape, have uneven surfaces, and thus may result in poor surface smoothness.

Moreover, it is preferable that the second resin particles are fused with the core particles to form a resin fused layer. As a preferred configuration of the second resin particles, the glass transition point is 55° C. to 75° C., the softening point is 140° C. to 180° C., the weight-average molecular weight (Mw) is 50000 to 500000, and the ratio (Mw/Mn) of the weight-average molecular weight (Mw) to the number average molecular weight (Mn) is 2 to 10, measured by gel permeation chromatography (GPC). It is more preferable that the glass transition point is 60° C. to 70° C., the softening point is 145° C. to 180° C., Mw is 80000 to 500000, and Mw/Mn is 2 to 7. It is further preferable that the glass transition point is 65° C. to 70° C., the softening point is 150° C. to 180° C., Mw is 120000 to 500000, and Mw/Mn is 2 to 5.

With this configuration, the thermal adhesiveness of the second resin particles to the surface of the individual core particles is promoted, and the softening point is set to be higher, thereby improving the durability, high-temperature offset resistance, and separability. If the glass transition point of the second resin particles is lower than 55° C., secondary aggregation is likely to occur, and the storage stability is degraded. If it is higher than 75° C., the thermal adhesiveness is degraded, and the uniform adhesion of the second resin particles is reduced. If the softening point of the second resin particles is lower than 140° C., the durability, the high-temperature offset resistance, and the separability are reduced. If it is higher than 180° C., the glossiness and the transmittance are reduced. The molecular weight distribution is brought closer to a monodisperse state by decreasing Mw/Mn of the second resin particles, so that the second resin particles can be fused uniformly with the surface of the individual core particles. If Mw of the second resin particles is smaller than 50000, the durability, the high-temperature offset resistance, and the separability of paper are reduced. If it is larger than 500000, the low-temperature fixability, the glossiness, and the transmittance are reduced.

The first resin particles are preferably 60 wt % or more, more preferably 70 wt % or more, and further preferably 80 wt % or more of the total resin of the toner.

The molecular weights of the resin, wax, and toner can be measured by gel permeation chromatography (GPC) using several types of monodisperse polystyrene as standard samples.

The measurement may be performed with HLC 8120 GPC series manufactured by TOSOH CORP., using TSK gel super HM-H H4000/H3000/H2000 (6.0 mm I.D.-150 mm×3) as a column and THF (tetrahydrofuran) as an eluent, at a flow rate of 0.6 mL/min, a sample concentration of 0.1%, an injection amount of 20 μL, RI as a detector, and at a temperature of 40° C. Prior to the measurement, the sample is dissolved in THF and allowed to stand overnight, and then is filtered through a 0.45 μm membrane filter so that additives such as silica are removed, to measure the resin component. The measurement requirement is that the molecular weight distribution of the subject sample is in the range where the logarithms and the count numbers of the molecular weights in the analytical curve obtained from the several types of monodisperse polystyrene standard samples form a straight line.

The wax obtained by the reaction of long chain alkyl alcohol, unsaturated polycarboxylic acid or its anhydride, and synthetic hydrocarbon wax can be measured with GPC-150C (manufactured by Waters Corporation), using Shodex HT-806M (8.0 mm I.D.-30 cm×2) as a column and o-dichlorobenzene as an eluent, at a flow rate of 1.0 mL/min, a sample concentration of 0.3%, an injection amount of 200 μL, RI as a detector, and at a temperature of 130° C. Prior to the measurement, the sample is dissolved in a solvent, and then is filtered through a 0.5 μm sintered metal filter. The measurement requirement is that the molecular weight distribution of the subject sample is in the range where the logarithms and the count numbers of the molecular weights in the analytical curve obtained from the several types of monodisperse polystyrene standard samples form a straight line.

The softening point of the binder resin can be measured with a capillary rheometer flow tester (CFT-500, constant-pressure extrusion system, manufactured by Shimadzu Corporation). A load of about 9.8×10⁵ N/m² is applied to a 1 cm³ sample with a plunger while heating the sample at a rate of temperature rise of 6° C./min, so that the sample is extruded from a die having a diameter of 1 mm and a length of 1 mm. Based on the relationship between the piston stroke of the plunger and the temperature increase characteristics, when the temperature at which the piston stroke starts to occur is a flow start temperature (Tfb), one-half the difference between the minimum value of a curve of the piston stroke characteristics and the flow end point is determined. Then, the resultant value and the minimum value of the curve are added to define a point, and the temperature of this point is identified as a melting point (softening point Ts° C.) according to a ½ method.

The glass transition point of the resin can be measured with a differential scanning calorimeter (DSC-50 manufactured by Shimadzu Corporation). The temperature of a sample is raised to 100° C., retained for 3 minutes, and reduced to room temperature at 10° C./min. Subsequently, the temperature is raised at 10° C./min, and a thermal history of the sample is measured. In the thermal history, an intersection point of an extension line of the base line lower than a glass transition point and a tangent that shows the maximum inclination between the rising point and the highest point of a peak is determined. The temperature of this intersection point is identified as a glass transition point.

(4) Pigment

Examples of the colorant (pigment) used in this embodiment include the following. As a black pigment, carbon black, iron black, graphite, nigrosine, or a metal complex of azo dyes can be used preferably. The present invention is suitable particularly for a black toner. For example, preferred materials are #52 (particle size: 27 nm, DBP (dibutyl phthalate) oil absorption: 63 ml/100 g), #50 (particle size: 28 nm, DBP oil absorption: 65 ml/100 g), #47 (particle size: 23 nm, DBP oil absorption: 64 ml/100 g), #45 (particle size: 24 nm, DBP oil absorption: 53 ml/100 g), and #45L (particle size: 24 nm, DBP oil absorption: 45 ml/100 g) that are manufactured by Mitsubishi Chemical Corporation, and REGAL 250R (particle size: 35 nm, DBP oil absorption: 46 ml/100 g), REGAL 330R (particle size: 25 nm, DBP oil absorption: 65 ml/100 g), and MOGULL (particle size: 24 nm, DBP oil absorption: 60 ml/100 g) that are manufactured by Cabot Corporation. Among them, more preferred materials are #45, #45L, and REGAL 250R.

The DBP oil absorption is measured in accordance with JIS K6217. Specifically, 20 g of a sample (A) is dried at 150° C.±1° C. for 1 hour, and then is put into a mixing chamber of an “Absorptometer” (with a spring tension of 2.68 kg/cm, manufactured by Brabender Inc.). After the limit switch has been set to about 70% of the maximum torque, a mixing machine is rotated. At the same time, DBP (specific gravity: 1.045 to 1.050 g/cm³) is added at a rate of 4 ml/min from an automatic buret. When it is close to the end point, the torque increases rapidly, and the limit switch is turned off. Based on the amount of DBP added (B ml) to that point and the weight of the sample, the DBP oil absorption per 100 g of the sample (=B×100/A) (ml/100 g) is determined.

As a yellow pigment, acetoacetic acid aryl amide monoazo yellow pigments such as C.I. Pigment Yellow 1, 3, 74, 97 and 98, acetoacetic acid aryl amide disazo yellow pigments such as C.I. Pigment Yellow 12, 13, 14 and 17, C.I. Solvent Yellow 19, 77 and 79, or C.I. Disperse Yellow 164 can be used. In particular, benzimidazolone pigments of C.I. Pigment Yellow 93, 180 and 185 are preferred.

As a magenta pigment, red pigments such as C.I. Pigment Red 48, 49:1, 53:1, 57, 57:1, 81, 122 and 5, or red dyes such as C.I. Solvent Red 49, 52, 58 and 8 can be used preferably.

As a cyan pigment, blue dyes/pigments of phthalocyanine and its derivative such as C.I. Pigment Blue 15:3 can be used preferably. The added amount is preferably 3 to 8 parts by weight per 100 parts by weight of the binder resin.

The median diameter of the pigment particles is generally 1 μm or less, and preferably 0.01 to 1 μm. If the median diameter is more than 1 μm, the toner as a final product for electrostatic charge image development can have a broader particle size distribution. Moreover, liberated particles are generated and tend to reduce the performance or reliability. When the median diameter is within the above range, these disadvantages are eliminated, and the uneven distribution of the toner is decreased. Therefore, the dispersion of the pigment particles in the toner can be improved, resulting in a smaller variation in performance and reliability. The median diameter can be measured, e.g., by a laser diffraction particle size analyzer (LA 920 manufactured by Horiba, Ltd.).

(5) Additive

In this embodiment, an inorganic fine powder is added as an additive. Examples of the additive include a metal oxide fine powder such as silica, alumina, titanium oxide, zirconia, magnesia, ferrite or magnetite, titanate such as barium titanate, calcium titanate or strontium titanate, zirconate such as barium zirconate, calcium zirconate or strontium zirconate, and a mixture of these substances. The additive can be made hydrophobic as needed.

Examples of silicone oil materials used to treat the additive include dimethyl silicone oil, methyl hydrogen silicone oil, methyl phenyl silicone oil, epoxy modified silicone oil, carboxyl modified silicone oil, methacrylic modified silicone oil, alkyl modified silicone oil, fluorine modified silicone oil, amino modified silicone oil, and chlorophenyl modified silicone oil. The additive that is treated with at least one of the above silicone oil materials is used preferably. For example, SH200, SH510, SF230, SH203, BY16-823, or BY16-855B manufactured by Toray-Dow Corning Co., Ltd can be used.

The treatment may be performed by mixing the additive and the silicone oil material with a mixer (e.g., a Henshel mixer, FM20B manufactured by Mitsui Mining Co., Ltd.). Moreover, the silicone oil material may be sprayed onto the additive. Alternatively, the silicone oil material may be dissolved or dispersed in a solvent, and mixed with the additive, followed by removal of the solvent. The amount of the silicone oil material is preferably 1 to 20 parts by weight per 100 parts by weight of the additive.

Examples of a silane coupling agent include dimethyldichlorosilane, trimethylchlorosilane, allyldimethylchlorosilane, hexamethyldisilazane, allylphenyldichlorosilane, benzyl methyl chlorosilane, vinyltriethoxysilane, γ-methacryloxypropyltrimethoxysilane, vinyltriacetoxysilane, divinylchlorosilane, and dimethylvinylchlorosilane. The silane coupling agent may be treated by a dry treatment in which the additive is fluidized by agitation or the like, and an evaporated silane coupling agent is reacted with the fluidized additive, or a wet treatment in which a silane coupling agent dispersed in a solvent is added dropwise to the additive.

It is also preferable that the silicone oil material is treated after a silane coupling treatment.

The additive having positive chargeability may be treated with aminosilane, amino modified silicone oil, or epoxy modified silicone oil.

To enhance a hydrophobic treatment, hexamethyldisilazane, dimethyldichlorosilane, or other silicone oils also can be used along with the above materials. For example, at least one selected from dimethyl silicone oil, methylphenyl silicone oil, and alkyl modified silicone oil is preferred to treat the additive.

It is also preferable that the surface of the additive is treated with one or more selected from fatty acid ester, fatty acid amide, a fatty acid, and a fatty acid metal salt (referred to as “fatty acid or the like” in the following). The surface-treated silica or titanium oxide fine powder is more preferred.

Examples of the fatty acid and the fatty acid metal salt include a caprylic acid, capric acid, undecylic acid, lauric acid, myristic acid, palmitic acid, stearic acid, behenic acid, montanic acid, lacceric acid, oleic acid, erucic acid, sorbic acid, and linoleic acid. In particular, the fatty acid having a carbon number of 12 to 22 is preferred.

Metals of the fatty acid metal salt may be, e.g., aluminum, zinc, calcium, magnesium, lithium, sodium, lead, or barium. Among these metals, aluminum, zinc, and sodium are preferred. Further, mono- and di-fatty acid aluminum such as aluminum distearate (Al(OH)(C₁₇H₃₅COO)₂) or aluminum monostearate (Al(OH)₂(C₁₇H₃₅COO)) are particularly preferred. The presence of a hydroxy group can prevent overcharge and suppress a transfer failure. Moreover, it may be possible to improve the treatment of the additive.

Preferred examples of aliphatic amide include saturated or mono-unsaturated aliphatic amide having a carbon number of 16 to 24 such as palmitic acid amide, palmitoleic acid amide, stearic acid amide, oleic acid amide, arachidic acid amide, eicosanoic acid amide, behenic acid amide, erucic acid amide, or lignoceric acid amide.

Preferred examples of the fatty acid ester include the following: esters composed of a higher alcohol having a carbon number of 16 to 24 and a higher fatty acid having a carbon number of 16 to 24 such as stearyl stearate, palmityl palmitate, behenyl behenate, or stearyl montanate; esters composed of a higher fatty acid having a carbon number of 16 to 24 and a lower monoalcohol such as butyl stearate, isobutyl behenate, propyl montanate, or 2-ethylhexyl oleate; fatty acid pentaerythritol monoester; fatty acid pentaerythritol triester; and fatty acid trimethylol propane ester.

Moreover, materials such as a derivative of hydroxystearic acid and polyol fatty acid ester such as glycerin fatty acid ester, glycol fatty acid ester, or sorbitan fatty acid ester are preferred. They can be used individually or in combinations of two or more.

In a preferred surface treatment, the surface of the additive may be treated with a coupling agent and/or polysiloxane such as silicone oil, and subsequently treated with the fatty acid or the like. This is because a more uniform treatment can be performed than when hydrophilic silica is merely treated with a fatty acid, high charging of the toner can be achieved, and the flowability can be improved when the additive is added to the toner. The above effect also can be obtained by treating with the fatty acid or the like along with a coupling agent and/or silicone oil.

The surface treatment may be performed by dissolving the fatty acid or the like in a hydrocarbon organic solvent such as toluene, xylene, or hexane, wet mixing this solution with an additive such as silica, a titanium oxide, or alumina in a dispersing device, and allowing the fatty acid or the like to adhere to the surface of the additive with the treatment agent. After the surface treatment, the solvent is removed, and a drying process is performed.

It is preferable that the mixing ratio of polysiloxane to the fatty acid or the like is 1:2 to 20:1. If the fatty acid or the like is increased to a ratio higher than 1:2, the charge amount of the additive becomes high, the image density is reduced, and charge-up is likely to occur in two-component development. If the fatty acid or the like is decreased to a ratio lower than 20:1, the effect of suppressing transfer voids or reverse transfer is reduced.

In this case, the ignition loss of the additive whose surface has been treated with the fatty acid or the like is preferably 1.5 to 25 wt %, more preferably 5 to 25 wt %, and further preferably 8 to 20 wt %. If the ignition loss is smaller than 1.5 wt %, the treatment agent does not function sufficiently, and the effects of improving the chargeability and the transfer property are not likely to be observed. If the ignition loss is larger than 25 wt %, the treatment agent remains unused and may affect the developing property or durability adversely.

Unlike the conventional pulverizing process, the surface of the individual toner base particles produced in the present invention consists mainly of resin. Therefore, it is advantageous in terms of charge uniformity, but affinity with the additive used for the charge-imparting property or charge-retaining property becomes important.

It is preferable that the additive having an average particle size of 6 nm to 200 nm is added in an amount of 1 to 6 parts by weight per 100 parts by weight of toner base particles. If the average particle size is less than 6 nm, suspended particles are generated, and filming of the toner on a photoconductive member is likely to occur. Therefore, it is difficult to avoid the occurrence of reverse transfer. If the average particle size is more than 200 nm, the flowability of the toner is decreased. If the amount of the additive is less than 1 part by weight, the flowability of the toner is decreased, and it is difficult to avoid the occurrence of reverse transfer. If the amount of the additive is more than 6 parts by weight, suspended particles are generated, and filming of the toner on a photoconductive member is likely to occur, thus degrading the high-temperature offset resistance.

Moreover, it is preferable that at least the additive having an average particle size of 6 nm to 20 nm is added in an amount of 0.5 to 2.5 parts by weight per 100 parts by weight of the toner base particles, and the additive having an average particle size of 20 nm to 200 nm is added in an amount of 0.5 to 3.5 parts by weight per 100 parts by weight of toner base particles. With this configuration, the additives of different functions can improve both the charge-imparting property and the charge-retaining property, and also can ensure larger tolerances against reverse transfer, transfer voids, and scattering of the toner during transfer. In this case, the ignition loss of the additive having an average particle size of 6 nm to 20 nm is preferably 0.5 to 20 wt %, and the ignition loss of the additive having an average particle size of 20 nm to 200 nm is preferably 1.5 to 25 wt %. When the ignition loss of the additive having an average particle size of 20 nm to 200 nm is larger than that of the additive having an average particle size of 6 nm to 20 nm, it is effective in improving the charge-retaining property and suppressing reverse transfer and transfer voids.

By specifying the ignition loss of the additive, larger tolerances can be ensured against reverse transfer, transfer voids, and scattering of the toner during transfer. Moreover, the handling property of the toner in a developing unit can be improved, thus increasing the uniformity of the toner concentration.

If the ignition loss of the additive having an average particle size of 6 nm to 20 nm is less than 0.5 wt %, the tolerances against reverse transfer and transfer voids become narrow. If the ignition loss is more than 20 wt %, the surface treatment is not uniform, resulting in charge variations. The ignition loss is preferably 1.5 to 17 wt %, and more preferably 4 to 10 wt %.

If the ignition loss of the additive having an average particle size of 20 nm to 200 nm is less than 1.5 wt %, the tolerances against reverse transfer and transfer voids become narrow. If the ignition loss is more than 25 wt %, the surface treatment is not uniform, resulting in charge variations. The ignition loss is preferably 2.5 to 20 wt %, and more preferably 5 to 15 wt %.

Further, it is preferable that at least the additive having an average particle size of 6 nm to 20 nm and an ignition loss of 0.5 to 20 wt % is added in an amount of 0.5 to 2 parts by weight per 100 parts by weight of the toner base particles, the additive having an average particle size of 20 nm to 100 nm and an ignition loss of 1.5 to 25 wt % is added in an amount of 0.5 to 3.5 parts by weight per 100 parts by weight of the toner base particles, and the additive having an average particle size of 100 nm to 200 nm and an ignition loss of 0.1 to 10 wt % is added in an amount of 0.5 to 2.5 parts by weight per 100 parts by weight of toner base particles. With this configuration, the additives of different functions, each having the specified average particle size and ignition loss, are effective in improving both the charge-imparting property and the charge-retaining property, suppressing reverse transfer and transfer voids, and removing substances attached to the surface of a carrier.

It is also preferable that a positively charged additive having an average particle size of 6 nm to 200 nm and an ignition loss of 0.5 to 25 wt % is added further in an amount of 0.2 to 1.5 parts by weight per 100 parts by weight of toner base particles.

The addition of the positively charged additive can suppress the overcharge of the toner for a long period of continuous use and increase the life of a developer. Therefore, the scattering of the toner during transfer caused by overcharge also can be reduced. Moreover, it is possible to prevent spent on a carrier. If the amount of positively charged additive is less than 0.2 parts by weight, these effects are not likely to be obtained. If it is more than 1.5 parts by weight, fog is, increased significantly during development. The ignition loss is preferably 1.5 to 20 wt %, and more preferably 5 to 19 wt %.

A drying loss (%) may be determined in the following manner. A container is dried, allowed to stand and cool, and weighed precisely beforehand. Then, a sample (about 1 g) is put in the container, weighed precisely, and dried for 2 hours with a hot-air dryer at 105° C.±1° C. After cooling for 30 minutes in a desiccator, the weight is measured, and the drying loss is calculated by the following formula.

Drying loss (wt %)=[weight loss (g) by drying/sample amount (g)]×100.

An ignition loss may be determined in the following manner. A magnetic crucible is dried, allowed to stand and cool, and weighed precisely beforehand. Then, a sample (about 1 g) is put in the crucible, weighed precisely, and ignited for 2 hours in an electric furnace at 500° C. After cooling for 1 hour in a desiccator, the weight is measured, and the ignition loss is calculated by the following formula.

Ignition loss (wt %)=[weight loss (g) by ignition/sample amount (g)]×100.

The amount of moisture absorption of the surface-treated additive may be 1 wt % or less, preferably 0.5 wt % or less, more preferably 0.1 wt % or less, and further preferably 0.05 wt % or less. If the amount is more than 1 wt %, the chargeability is degraded, and filming of the toner on a photoconductive member occurs over time. The amount of moisture absorption can be measured by using a continuous vapor absorption measuring device (BELSORP 18 manufactured by BEL JAPAN, INC.).

The degree of hydrophobicity may be determined in the following manner. A sample (0.2 g) is weighed out and added to 50 ml of distilled water placed in a 250 ml beaker. Then, methanol is added dropwise from a buret, whose end is put into the liquid, until the entire amount of the additive is wetted while continuing the stirring slowly with a magnetic stirrer. Based on the amount a (ml) of methanol required to wet the additive completely, the degree of hydrophobicity is calculated by the following formula.

Degree of hydrophobicity (%)=(a/(50+a))×100

(6) Powder Physical Characteristics of Toner

In this embodiment, it is preferable that toner base particles including a binder resin, a colorant, and wax have a volume-average particle size of 3 to 7 μm, the content of the toner base particles having a particle size of 2.52 to 4 μm in a number distribution is 10 to 75% by number, the toner base particles having a particle size of 4 to 6.06 μm in a volume distribution is 25 to 75% by volume, the toner base particles having a particle size of not less than 8 μm in the volume distribution is not more than 5% by volume, P46/V46 is in the range of 0.5 to 1.5 where V46 is the volume percentage of the toner base particles having a particle size of 4 to 6.06 μm in the volume distribution and P46 is the number percentage of the toner base particles having a particle size of 4 to 6.06 μm in the number distribution, the coefficient of variation in the volume-average particle size is 10 to 25%, and the coefficient of variation in the number particle size distribution is 10 to 28%.

More preferably, the toner base particles have a volume-average particle size of 3 to 6.5 μm, the content of the toner base particles having a particle size of 2.52 to 4 μm in the number distribution is 20 to 75% by number, the toner base particles having a particle size of 4 to 6.06 μm in the volume distribution is 35 to 75% by volume, the toner base particles having a particle size of not less than 8 μm in the volume distribution is not more than 3% by volume, P46/V46 is in the range of 0.5 to 1.3 where V46 is the volume percentage of the toner base particles having a particle size of 4 to 6.06 μm in the volume distribution and P46 is the number percentage of the toner base particles having a particle size of 4 to 6.06 μm in the number distribution, the coefficient of variation in the volume-average particle size is 10 to 20%, and the coefficient of variation in the number particle size distribution is 10 to 23%.

Further preferably, the toner base particles have a volume-average particle size of 3 to 5 μm, the content of the toner base particles having a particle size of 2.52 to 4 μm in the number distribution is 40 to 75% by number, the toner base particles having a particle size of 4 to 6.06 μm in the volume distribution is 45 to 75% by volume, the toner base particles having a particle size of not less than 8 μm in the volume distribution is not more than 1% by volume, P46/V46 is in the range of 0.5 to 0.9 where V46 is the volume percentage of the toner base particles having a particle size of 4 to 6.06 μm in the volume distribution and P46 is the number percentage of the toner base particles having a particle size of 4 to 6.06 μm in the number distribution the coefficient of variation in the volume-average particle size is 10 to 15%, and the coefficient of variation in the number particle size distribution is 10 to 18%.

The toner base particles with the above characteristics can provide high-resolution image quality, prevent reverse transfer and transfer voids during tandem transfer, and achieve the oilless fixing. The fine powder in the toner affects the flowability, image quality, and storage stability of the toner, filming of the toner on a photoconductive member, developing roller, or transfer member, the aging property, the transfer property, and particularly the multilayer transfer property in a tandem system. The fine powder also affects the offset resistance, glossiness, and transmittance in the oilless fixing. When the toner includes wax or the like to achieve the oilless fixing, the amount of fine powder may affect the compatibility between the oilless fixing and the tandem transfer property.

If the volume-average particle size is more than 7 μm, the image quality and the transfer property cannot be ensured together. If the volume-average particle size is less than 3 μm, the handling property of the toner particles in development is reduced.

If the content of the toner base particles having a particle size of 2.52 to 4 μm in the number distribution is less than 10% by number, the image quality and the transfer property cannot be ensured together. If it is more than 75% by number, the handling property of the toner particles in development is reduced. Moreover, the filming of the toner on a photoconductive member, developing roller, or transfer member is likely to occur. The adhesion of the fine powder to a heat roller is large, and thus tends to cause offset. In the tandem system, the agglomeration of the toner is likely to be stronger, which easily leads to a transfer failure of the second color during multilayer transfer. Therefore, an appropriate range is necessary.

If the toner base particles having a particle size of 4 to 6.06 μm in the volume distribution is more than 75% by volume, the image quality and the transfer property cannot be ensured together. If it is less than 30% by volume, the image quality is degraded.

If the toner base particles having a particle size of not less than 8 μm in the volume distribution is more than 5% by volume, the image quality is degraded, and a transfer failure is likely to occur.

If P46/V46 is less than 0.5, where V46 is the volume percentage of the toner base particles having a particle size of 4 to 6.06 μm in the volume distribution and P46 is the number percentage of the toner base particles having a particle size of 4 to 6.06 μm in the number distribution, the amount of fine powder is increased excessively, so that the flowability and the transfer property are decreased, and fog becomes worse. If P46/V46 is more than 1.5, the number of large particles is increased, and the particle size distribution becomes broader. Thus, high image quality cannot be achieved.

The purpose of controlling P46/V46 is to provide an index for reducing the size of the toner particles and narrowing the particle size distribution.

The coefficient of variation is obtained by dividing a standard deviation by an average particle size of the toner particles based on the measurement using a Coulter Counter (manufactured by Coulter Electronics, Inc.). When the particle sizes of n particles are measured, the standard deviation can be expressed by the square root of the value that is obtained by dividing the square of a difference between each of the n measured values and the mean value by (n−1).

In other words, the coefficient of variation indicates the degree of expansion of the particle size distribution. When the coefficient of variation of the volume particle size distribution or the number particle size distribution is less than 10%, the production becomes difficult, and the cost is increased. When the coefficient of variation of the volume particle size distribution is more than 25%, or when the coefficient of variation of the number particle size distribution is more than 28%, the particle size distribution is broader, and the agglomeration of toner is stronger. This may lead to filming of the toner on a photoconductive member, a transfer failure, and difficulty in recycling the residual toner in a cleanerless process.

The particle size distribution is measured, e.g., by using a Coulter Counter TA-II (manufactured by Coulter Electronics, Inc.). An interface (manufactured by Nikkaki Bios Co., Ltd.) and a personal computer for outputting a number distribution and a volume distribution are connected to the Coulter Counter TA-II. An electrolytic solution (about 50 ml) is prepared by including a surface-active agent (sodium lauryl sulfate) so as to have a concentration of 1 wt %. About 2 mg of toner to be measured is added to the electrolytic solution. This electrolytic solution in which the sample is suspended is dispersed for about 3 minutes with an ultrasonic dispersing device, and then is measured using the 70 μm aperture of the Coulter Counter TA-II. In the 70 μm aperture system, the measurement range of the particle size distribution is 1.26 μm to 50.8 μm. However, the region smaller than 2.0 μm is not suitable for practical use because the measurement accuracy or reproducibility is low due to the influence of external noise or the like. Therefore, the measurement range is set from 2.0 μm to 50.8 μm.

A compression ratio calculated from a static bulk density and a dynamic bulk density can be used as an index of the flowability of the toner. The toner flowability may be affected by the particle size distribution and particle shape of the toner, the additive, and the type or amount of the wax. When the particle size distribution of the toner is narrow, less fine powder is present, the toner surface is not rough, the toner shape is close to spherical, a large amount of additive is added, and the additive has a small particle size, the compression ratio is reduced, and the toner flowability is increased. The compression ratio is preferably 5 to 40%, and more preferably 10 to 30%. This can ensure the compatibility between the oilless fixing and the multilayer transfer property in the tandem system. If the compression ratio is less than 5%, the friability is degraded, and particularly the transmittance is likely to be lower. Moreover, toner scattering from the developing roller may be increased. If the compression ratio is more than 40%, the transfer property is decreased to cause a transfer failure such as transfer voids in the tandem system.

(7) Carrier

A preferred carrier includes magnetic particles as a core material, and the surface of the core material is coated with a fluorine modified silicone resin containing an aminosilane coupling agent.

Moreover, it is preferable to use a carrier that includes composite magnetic particles including at least magnetic particles and a binder resin, and the surfaces of the composite magnetic particles are coated with the fluorine modified silicone resin containing an aminosilane coupling agent.

A thermosetting resin is suitable for the binder resin of the composite magnetic particles. Examples of the thermosetting resin include a phenol resin, an epoxy resin, a polyamide resin, a melamine resin, a urea resin, an unsaturated polyester resin, an alkyd resin, a xylene resin, an acetoguanamine resin, a furan resin, a silicone resin, a polyimide resin, and a urethane resin. Although these resins can be used individually or in combinations of two or more, it is preferable to include at least the phenol resin.

The composite magnetic particles of the present invention may be spherical particles having an average particle size of 10 to 50 μm, preferably 10 to 40 μm, more preferably 10 to 30 μm, and most preferably 15 to 30 μm. The specific gravity of the composite magnetic particles may be 2.5 to 4.5, and particularly 2.5 to 4.0. The BET specific surface area based on nitrogen adsorption of the carrier is preferably 0.03 to 0.3 m²/g. If the average particle size of the carrier is less than 10 μm, the abundance ratio of fine particles in the carrier particle distribution is increased, and the magnetization per carrier particle is reduced. Therefore, the carrier is likely to be developed on a photoconductive member. If the average particle size of the carrier is more than 50 μm, the specific surface area of the carrier particles is smaller, and the toner retaining ability is decreased, causing toner scattering.

A conventional carrier including ferrite core particles has a large specific gravity of 5 to 6, and also has a large particle size of 50 to 80 μm. Therefore, the BET specific surface area is small, and the mixing of the carrier with the toner is weak during stirring. Thus, the charge build-up property is insufficient when the toner is supplied, and toner consumption is increased. For this reason, at the time of supplying a large amount of toner, considerable fog is likely to be generated. Moreover, if the concentration ratio of the toner to the carrier is not controlled in a narrow range, it is difficult to reduce fog and toner scattering while maintaining the image density.

However, the carrier having a large specific surface area value can suppress the degradation of the image quality, even if the concentration ratio is controlled in a broad range, so that the toner concentration can be controlled roughly. Moreover, the carrier and the toner can be mixed more uniformly by stirring, and the charge build-up property is good when the toner is supplied. Even if the concentration ratio of the toner to the carrier is controlled in a broader range, the image quality is not likely to be degraded, and fog and toner scattering can be reduced while maintaining the image density.

In this case, the image quality can be stabilized by satisfying the relationship TS/CS is 2 to 110, where TS (m²/g) represents the specific surface area value of the toner and CS (m²/g) represents the specific surface area value of the carrier. TS/CS is preferably 2 to 50, and more preferably 2 to 30. If TS/CS is less than 2, the adhesion of the carrier is likely to occur. If TS/CS is more than 110, the concentration ratio of the toner to the carrier has to be narrow so as to reduce fog and toner scattering while maintaining the image density. Thus, the image quality can be degraded easily. The conventional carrier including ferrite core particles has a small specific surface area value. The conventional pulverized toner is irregular in shape and has a large specific surface area value.

The composite magnetic particles including magnetic particles and a phenol resin may be produced in such a manner that phenols and aldehydes react and cure while they are stirred into an aqueous medium in the presence of the magnetic particles and a basic catalyst.

The average particle size of the composite magnetic particles can be controlled by controlling the rate of rotation of the blades of an agitator so that appropriate shear or consolidation is applied in accordance with the amount of water used.

The composite magnetic particles using an epoxy resin as the binder resin may be produced in such a manner that bisphenols, epihalohydrin, and lipophilized inorganic compound particles are dispersed in an aqueous medium and allowed to react in an alkaline aqueous medium.

The composite magnetic particles of the present invention may include 1 to 20 wt % of a binder resin and 80 to 99 wt % of magnetic particles. If the content of the magnetic particles is less than 80 wt %, the saturation magnetization is reduced. If it is more than 99 wt %, the binding between the magnetic particles with the phenol resin is likely to be weaker. In view of the strength of the composite magnetic particles, the content of the magnetic particles is preferably 97 wt % or less.

Examples of the magnetic particles include spinel ferrite such as magnetite or gamma iron oxide, spinel ferrite including one or more than one metal (Mn, Ni, Zn, Mg, Cu, etc.) other than iron, magnetoplumbite ferrite such as barium ferrite, and iron or alloy fine particles having an oxide layer on the surface thereof. The magnetic particles may be granular, spherical, or acicular in shape. Ferromagnetic fine particles of iron or the like also can be used, particularly when high magnetization is required. In view of the chemical stability, however, it is preferable to use ferromagnetic fine particles of the spinel ferrite such as magnetite or gamma iron oxide or the magnetoplumbite ferrite such as barium ferrite. The composite magnetic particles with desired saturation magnetization can be obtained by selecting the type and content of the ferromagnetic fine particles appropriately.

According to the measurement under a magnetic field of 1000 oersted (79.57 kA/m), the magnetization strength may be 30 to 70 Am²/kg, and preferably 35 to 60 Am²/kg, the residual magnetization (σr) may be 0.1 to 20 Am²/kg, and preferably 0.1 to 10 Am²/kg, and the specific resistance value may be 1×10⁶ to 1×10¹⁴ Ωcm, preferably 5×10⁶ to 5×10¹³ Ωcm, and more preferably 5×10⁶ to 5×10⁶ Ωcm.

In a method for producing the carrier of the present invention, phenols and aldehydes, together with magnetic particles and a suspension stabilizer, react in an aqueous medium in the presence of a basic catalyst.

Examples of the phenols used as the binder resin include phenol, alkylphenols such as m-cresol, p-tert-butyl phenol, o-propylphenol, resorcinol, and bisphenol A, and a compound having a phenolic hydroxyl group such as halogenated phenol in which part or all of the benzene nucleus or the alkyl group is substituted with chlorine or bromine atoms. Above all, phenol is most preferred. When compounds other than phenol are used, particles are not formed easily or may have an irregular shape, even if they are formed. Therefore, phenol is most preferred in view of the shape of the particles.

Examples of the aldehydes used in the method for producing the composite magnetic particles include formaldehyde in the form of either formalin or paraformaldehyde and furfural. Above all, formaldehyde is particularly preferred.

A fluorine modified silicone resin is preferred as the resin coating layer of the present invention. The fluorine modified silicone resin may be a cross-linked fluorine modified silicone resin obtained by the reaction between an organosilicon compound containing a perfluoroalkyl group and polyorganosiloxane. As a mixing ratio of the polyorganosiloxane and the organosilicon compound containing a perfluoroalkyl group, it is preferable that 3 to 20 parts by weight of the organosilicon compound containing a perfluoroalkyl group is mixed with 100 parts by weight of the polyorganosiloxane. Compared to the coating on the conventional ferrite core particles, the adhesion of the composite magnetic particles in which the magnetic particles are dispersed in a curable resin is strengthened, thus improving the durability along with the chargeability (as will be described later).

The polyorganosiloxane preferably has at least one repeating unit selected from the following Chemical Formulas (1) and (2).

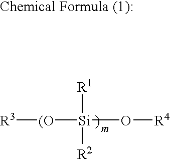

(where R¹ and R² are a hydrogen atom, a halogen atom, a hydroxy group, a methoxy group, an alkyl group having a carbon number of 1 to 4, or a phenyl group, R³ and R⁴ are an alkyl group having a carbon number of 1 to 4 or a phenyl group, and m represents a mean degree of polymerization and is positive integers (preferably in the range of 2 to 500, and more preferably in the range of 5 to 200)).

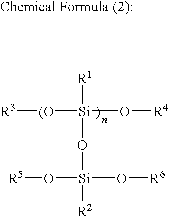

(where R¹ and R² are a hydrogen atom, a halogen atom, a hydroxy group, a methoxy group, an alkyl group having a carbon number of 1 to 4, or a phenyl group, R³, R⁴, R⁵ and R⁶ are an alkyl group having a carbon number of 1 to 4 or a phenyl group, and n represents a mean degree of polymerization and is positive integers (preferably in the range of 2 to 500, and more preferably in the range of 5 to 200)).

Examples of the organosilicon compound containing a perfluoroalkyl group include CF₃CH₂CH₂Si(OCH₃)₃, C₄F₉CH₂CH₂Si(CH₃)(OCH₃)₂, C₈F₁₇CH₂CH₂Si(OCH₃)₃, C₈F₁₇CH₂CH₂Si(OCH₃)₂, and (CF₃)₂CF(CF₂)₈CH₂CH₂Si(OCH₃)₃. In particular, a compound containing a trifluoropropyl group is preferred.

In this embodiment, the aminosilane coupling agent is included in the resin coating layer. As the aminosilane coupling agent, e.g., the following known materials can be used: γ-(2-aminoethyl)aminopropyltrimethoxysilane, γ-(2-aminoethyl)aminopropylmethyldimethoxysilane, and octadecylmethyl [3-(trimethoxysilyl)propyl] ammonium chloride (corresponding to SH6020, SZ6023, and AY43-021 manufactured by Toray-Dow Corning Co., Ltd.); KBM602, KBM603, KBE903, and KBM573 (manufactured by Shin-Etsu Chemical Co., Ltd.). In particular, the primary amine is preferred. The secondary or tertiary amine that is substituted with a methyl group, an ethyl group, or a phenyl group has weak polarity and is less effective for the charge build-up property of the toner. When the amino group is replaced by an aminomethyl group, an aminoethyl group, or an aminophenyl group, the end of a straight chain extended from silane of the silane coupling agent can be the primary amine. However, the amino group contained in the organic group of the straight chain does not contribute to the charge build-up property and is affected by moisture under high humidity. Therefore, although the carrier may have charging ability for the initial toner because the amino group is at the end, the charging ability is decreased during printing, resulting in a short life of the carrier.

By using the above aminosilane coupling agent with the fluorine modified silicone resin of this embodiment, the toner can be charged negatively while maintaining a sharp charge distribution. When the toner is supplied, it shows a quick rise in charge, and thus the toner consumption can be reduced. Moreover, the aminosilane coupling agent has the effect comparable to that of a cross-linking agent, and therefore can increase the degree of cross-linking of the coating layer of the fluorine modified silicone resin as a base resin. The hardness of the resin coating layer is improved further, so that abrasion or peeling can be reduced over a long period of use. Accordingly, higher resistance to spent can be obtained, and the electrification can be stabilized by suppressing a decrease in the charging ability of the carrier, thus improving the durability. In particular, when the toner is configured by fusing the second resin particles with the core particles to form a resin fused layer, the carrier serves to improve the charge build-up property, reduce fog, and increase the uniformity of a solid image. Moreover, it also can suppress transfer voids or skipping in characters during transfer, improve the handling property of the toner in a developing unit, and reduce a so-called developing memory, in which a history remains after forming a solid image.

The ratio of the aminosilane coupling agent to the resin is 5 to 40 wt %, and preferably 10 to 30 wt %. If the ratio is less than 5 wt %, no effect of the aminosilane coupling agent is observed. If the ratio is more than 40 wt %, the degree of cross-linking of the resin coating layer is excessively high, and a charge-up phenomenon is likely to occur. This may lead to image defects such as underdevelopment and low image density.

The resin coating layer also may include conductive fine particles to stabilize the electrification and to prevent charge-up. Examples of the conductive fine particles include carbon black such as oil furnace black or acetylene black, a semiconductive oxide such as a titanium oxide or zinc oxide, and a powder of titanium oxide, zinc oxide, barium sulfate, aluminum borate, or potassium titanate coated with a tin oxide, carbon black, or metal. The specific resistance is preferably not more than 10¹⁰Ω·cm. The content of the conductive fine particles is preferably 1 to 15 wt %. When the conductive fine particles are included to some extent in the resin coating layer, the hardness of the resin coating layer can be improved by a filler effect. However, if the content is more than 15 wt %, the conductive fine particles may interfere with the formation of the resin coating layer, resulting in lower adherence and hardness. An excessive amount of the conductive fine particles in a full color developer may cause the color contamination of the toner that is transferred and fixed on paper.

A method for forming a coating layer on the composite magnetic particles is not particularly limited, and any known coating methods can be used, such as a dipping method of dipping the composite magnetic particles in a solution for forming a coating layer, a spraying method of spraying a solution for forming a coating layer on the surfaces of the composite magnetic particles, a fluidized bed method of spraying a solution for forming a coating layer onto the composite magnetic particles that are floated by fluidizing air, and a kneader and coater method of mixing the composite magnetic particles and a solution for forming a coating layer in a kneader and coater, and removing a solvent. In addition to these wet coating methods, a dry coating method also can be used. The dry coating method includes, e.g., mixing a resin powder and the composite magnetic particles at high speed, and fusing the resin powder on the surfaces of the composite magnetic particles by utilizing the frictional heat. Although either method can be applied to the present invention, the wet coating method is preferred particularly for coating of the fluorine modified silicone resin containing an aminosilane coupling agent of the present invention.

A solvent of the solution for forming a coating layer is not particularly limited as long as it dissolves the coating resin, and can be selected in accordance with the coating resin to be used. Examples of the solvent include aromatic hydrocarbons such as toluene and xylene, ketones such as acetone and methyl ethyl ketone, and ethers such as tetrahydrofuran and dioxane.

The amount of the coating resin is preferably 0.2 to 6.0 wt %, more preferably 0.5 to 5.0 wt %, further preferably 0.6 to 4.0 wt %, and most preferably 0.7 to 3 wt % with respect to the composite magnetic particles. If the amount of the coating resin is less than 0.2 wt %, a uniform coating cannot be formed on the surfaces of the composite magnetic particles. Therefore, the carrier is affected significantly by the characteristics of the composite magnetic particles and cannot provide a sufficient effect of the fluorine modified silicone resin containing an aminosilane coupling agent. If the amount of the coating resin is more than 6.0 wt %, the coating layer is too thick, and granulation between the composite magnetic particles occurs. Therefore, the composite magnetic particles are not likely to be uniform.

It is preferable that a baking treatment is performed after coating the surfaces of the composite magnetic particles with the fluorine modified silicone resin containing an aminosilane coupling agent. A system for the baking treatment is not particularly limited, and either of external and internal heating systems may be used. For example, a fixed or fluidized electric furnace, a rotary kiln electric furnace, or a burner furnace can be used as well. Alternatively, baking may be performed with a microwave. The baking temperature should be high enough to provide the effect of the fluorine modified silicone that can improve the spent resistance of the resin coating layer, e.g., preferably 200° C. to 350° C., and more preferably 220° C. to 280° C. The treatment time is preferably 1.5 to 2.5 hours. A lower temperature may degrade the hardness of the coating resin itself, while an excessively high temperature may cause a charge reduction.

(8) Two-Component Development

In a development process, both direct-current bias and alternating-current bias are applied between a photoconductive member and a developing roller. In this case, it is preferable that the frequency is 1 to 10 kHz, the alternating-current bias is 1.0 to 2.5 kV (p-p), and the circumferential velocity ratio of the photoconductive member to the developing roller is 1:1.2 to 1:2. More preferably, the frequency is 3.5 to 8 kHz, the alternating-current bias is 1.2 to 2.0 kV (p-p), and the circumferential velocity ratio of the photoconductive member to the developing roller is 1:1.5 to 1:1.8. Further preferably, the frequency is 5.5 to 7 kHz, the alternating-current bias is 1.5 to 2.0 kV (p-p), and the circumferential velocity ratio of the photoconductive member to the developing roller is 1:1.6 to 1:1.8.

By using the above development process configuration with the toner or two-component developer of this embodiment, a high image density can be achieved, fog can be reduced, and dots can be reproduced faithfully. Thus, a high quality image and the oilless fixability can be ensured together.

If the frequency is less than 1 kHz, the dot reproducibility is decreased, resulting in poor reproduction of middle tones. If the frequency is more than 10 kHz, the toner cannot follow in the development region, and no effect is observed. In the two-component development using a high resistance carrier, the frequency within the above range is more effective for reciprocating action between the carrier and the toner than between the developing roller and the photoconductive member. Thus, the toner can be liberated slightly from the carrier. This improves the dot reproducibility and the middle tone reproducibility, and also provides a high image density.

If the alternating-current bias is lower than 1.0 kV (p-p), the effect of suppressing charge-up cannot be obtained. If the alternating-current bias is more than 2.5 kV (p-p), fog is increased. If the circumferential velocity ratio is less than 1:1.2 (the developing roller gets slower), it is difficult to ensure the image density. If the circumferential velocity ratio is more than 1:2 (the developing roller gets faster), toner scattering is increased.

(9) Tandem Color Process

This embodiment employs the following transfer process for high-speed color image formation. A plurality of toner image forming stations, each of which includes a photoconductive member, a charging member, and a toner support member, are used. In a primary transfer process, an electrostatic latent image formed on the photoconductive member is made visible by development, and a toner image thus developed is transferred to an endless transfer member that is in contact with the photoconductive member. The primary transfer process is performed continuously in sequence so that a multilayer toner image is formed on the transfer member. Then, a secondary transfer process is performed by collectively transferring the multilayer toner image from the transfer member to a transfer medium such as paper or OHP sheet. The transfer process satisfies the relationship expressed as

d1/v≦0.65

where d1 (mm) is a distance between the first primary transfer position and the second primary transfer position, and v (mm/s) is a circumferential velocity of the photoconductive member. This configuration can reduce the machine size and improve the printing speed. To process at least 20 sheets (A4) per minute and to make the size small enough to be used for SOHO (small office/home office) purposes, a distance between the toner image forming stations should be as short as possible, while the processing speed should be enhanced. Thus, d1/v≦0.65 is considered to be the minimum requirement to achieve both small size and high printing speed.

However, when the distance between the toner image forming stations is too short, e.g., when a period of time from the primary transfer of the first color (yellow toner) to that of the second color (magenta toner) is extremely short, the charge of the transfer member or the charge of the transferred toner hardly is eliminated. Therefore, when the magenta toner is transferred onto the yellow toner, it is repelled by the charging action of the yellow toner. This may lead to lower transfer efficiency and transfer voids. When the third color (cyan toner) is transferred onto the yellow and the magenta toner, the cyan toner may be scattered to cause a transfer failure or considerable transfer voids. Moreover, the toner having a specified particle size is developed selectively with repeated use, and the individual toner particles differ significantly in flowability, so that frictional charge opportunities are different. Thus, the charge amount is varied and the transfer property is reduced further.

In such a case, therefore, the toner or two-component developer of this embodiment can be used to stabilize the charge distribution and suppress the overcharge and flowability variations. Accordingly, it is possible to prevent lower transfer efficiency, transfer voids, and reverse transfer without sacrificing the fixing property.

(10) Oilless Color Fixing

The toner of this embodiment can be used preferably in an electrographic apparatus having a fixing process with an oilless fixing configuration that applies no oil to any fixing means. For heating, electromagnetic induction heating is suitable in view of reducing the warm-up time and power consumption. The oilless fixing configuration includes a magnetic field generation means and a heating and pressing means. The heating and pressing means includes a rotational heating member and a rotational pressing member. The rotational heating member includes at least a heat generation layer for generating heat by electromagnetic induction and a release layer. There is a certain nip between the rotational heating member and the rotational pressing member. The toner that has been transferred to a transfer medium such as copy paper is fixed by passing the transfer medium between the rotational heating member and the rotational pressing member. This configuration is characterized by the warm-up time of the rotational heating member that has a quick rising property as compared with a conventional configuration using a halogen lamp. Therefore, the copying operation starts before the temperature of the rotational pressing member is raised sufficiently. Thus, the toner is required to have the low-temperature fixability and a wide range of the offset resistance.

Another configuration in which a heating member is separated from a fixing member and a fixing belt runs between the two members also may be used preferably. The fixing belt may be, e.g., a nickel electroformed belt having heat resistance and deformability or a heat-resistant polyimide belt. Silicone rubber, fluorocarbon rubber, or fluorocarbon resin may be used as a surface coating to improve the releasability.

In the conventional fixing process, release oil has been applied to prevent offset. The toner that exhibits releasability without using oil can eliminate the need for application of the release oil. However, if the release oil is not applied to the fixing means, it can be charged easily. Therefore, when an unfixed toner image is close to the heating member or the fixing member, the toner may be scattered due to the influence of charge. Such scattering is likely to occur, particularly at low temperature and low humidity.

In contrast, the toner of this embodiment can achieve the low-temperature fixability and a wide range of the offset resistance without using oil. The toner also can provide high color transmittance. Thus, the use of the toner of this embodiment can suppress overcharge as well as scattering caused by the charging action of the heating member or the fixing member.

### EXAMPLES

### (1) Carrier Core Producing Example

In a 1 liter flask were placed 52 g of phenol, 75 g of formalin (37 wt %), 400 g of spherical magnetite particles with an average particle size of 0.24 μm, 15 g of ammonia water (28 wt %), 1.0 g of calcium fluoride, and 50 g of water, and then the temperature was raised to 85° C. for 60 minutes while stirring the mixture. Subsequently, the mixture was reacted and hardened for 120 minutes at the same temperature, thus producing composite magnetic particles of the phenol resin and the spherical magnetite particles.

After the content of the flask was cooled to 30° C., 0.5 liter of water was added, and the supernatant liquor was removed. The precipitate on the bottom, of the flask was washed with water and air-dried. This further was dried at 50° C. to 60° C. under a reduced pressure (5 mmHg or less), so that the composite magnetic particles (carrier core A) were obtained.

In a 1 liter flask were placed 50 g of phenol, 65 g of formalin (37 wt %), 450 g of spherical magnetite particles with an average particle size of 0.24 μm, 15 g of ammonia water (28 wt %), 1.0 g of calcium fluoride, and 50 g of water, and then the temperature was raised to 85° C. for 60 minutes while stirring the mixture. Subsequently, the mixture was reacted and hardened for 120 minutes at the same temperature, thus producing composite magnetic particles of the phenol resin and the spherical magnetite particles.

After the content of the flask was cooled to 30° C., 0.5 liter of water was added, and the supernatant liquor was removed. The precipitate on the bottom of the flask was washed with water and air-dried. This further was dried at 50° C. to 60° C. under a reduced pressure (5 mmHg or less), so that the composite magnetic particles (carrier core B) were obtained.

In a 1 liter flask were placed 47.5 g of phenol, 62 g of formalin (37 wt %), 480 g of spherical magnetite particles with an average particle size of 0.24 μm, 15 g of ammonia water (28 wt %), 1.0 g of calcium fluoride, and 50 g of water, and then the temperature was raised to 85° C. for 60 minutes while stirring the mixture. Subsequently, the mixture was reacted and hardened for 120 minutes at the same temperature, thus producing composite magnetic particles of the phenol resin and the spherical magnetite particles.

After the content of the flask was cooled to 30° C., 0.5 liter of water was added, and the supernatant liquor was removed. The precipitate on the bottom of the flask was washed with water and air-dried. This further was dried at 50° C. to 60° C. under a reduced pressure (5 mmHg or less), so that the composite magnetic particles (carrier core C) were obtained.

A core material d of ferrite particles having an average particle size of 50 μm and a saturation magnetization of 65 μm²/kg in an applied magnetic field of 238.74 kA/m (3000 oersted) was used.

### Carrier Producing Example 1

Next, 250 g of polyorganosiloxane expressed as the following Chemical Formula (3) in which R¹ and R² are a methyl group, i.e., (CH₃)₂SiO_{2/2} unit is 15.4 mol % and the following Chemical Formula (4) in which R³ is a methyl group, i.e., CH₃SiO_{3/2} unit is 84.6 mol % was allowed to react with 21 g of CF₃CH₂CH₂Si(OCH₃)₃ to produce a fluorine modified silicone resin. Then, 100 g of the fluorine modified silicone resin (as represented in terms of solid content) and 10 g of aminosilane coupling agent (γ-aminopropyltriethoxysilane) were weighed out and dissolved in 300 cc of toluene solvent.

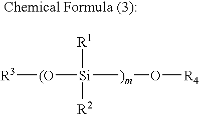

(where R¹, R², R³, and R⁴ are a methyl group, and m represents a mean degree of polymerization of 100)

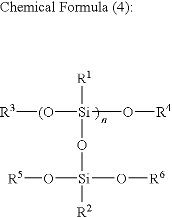

(where R¹, R², R³, R⁴, R⁵, and R⁶ are a methyl group, and n represents a mean degree of polymerization of 80)

Using a dip and dry coater, 10 kg of the carrier core A was coated by stirring the resin coating solution for 20 minutes, and then was baked at 260° C. for 1 hour, providing a carrier A1.

The carrier A1 was spherical particles including 80.4 mass % spherical magnetite particles and had an average particle size of 30 μm, a specific gravity of 3.05, a magnetization value of 61 μm²/kg, a volume resistivity of 3×10⁹ Ωcm, and a specific surface area of 0.098 m²/g.

### Carrier Producing Example 2

A carrier B1 was produced in the same manner as the Carrier Producing Example 1 except that the carrier core B was used, and CF₃CH₂CH₂Si(OCH₃)₃ was changed to C₈F₁₇CH₂CH₂Si(OCH₃)₃.

The carrier B1 was spherical particles including 88.4 mass % spherical magnetite particles and had an average particle size of 45 μm, a specific gravity of 3.56, a magnetization value of 65 Am²/kg, a volume resistivity of 8×10¹⁰ Ωcm, and a specific surface area of 0.057 m²/g.

### Carrier Producing Example 3

A carrier C1 was produced in the same manner as the Carrier Producing Example 1 except that the carrier core C was used, and a conductive carbon (manufactured by Ketjenblack International Corporation EC) was dispersed in an amount of 5 wt % per the resin solid content by using a ball mill.

The carrier C1 was spherical particles including 92.5 mass % spherical magnetite particles and had an average particle size of 48 μm, a specific gravity of 3.98, a magnetization value of 69 Am²/kg, a volume resistivity of 2×10⁷ Ωcm, and a specific surface area of 0.043 m²/g.

### Carrier Producing Example 4

A carrier A2 was produced in the same manner as the Carrier Producing Example 1 except that the amount of the aminosilane coupling agent to be added was changed to 30 g.

The carrier A2 was spherical particles including 80.4 mass % spherical magnetite particles and had an average particle size of 30 μm, a specific gravity of 3.05, a magnetization value of 61 Am²/kg, a volume resistivity of 2×10¹⁰ Ωcm, and a specific surface area of 0.01 m²/g.

### Carrier Comparative Example 5

A core material was produced in the same manner as the Carrier Producing Example 1 except that the amount of the aminosilane coupling agent to be added was changed to 50 g, and a coating was applied, thus providing a carrier a1.

### Carrier Comparative Example 6

As a coating resin, 100 g of straight silicone (SR-2411 manufactured by Dow Corning Toray Silicone Co., Ltd.) was weighed in terms of solid content and dissolved in 300 cc of toluene solvent. Using a dip and dry coater, 10 kg of the ferrite particles d were coated by stirring the resin coating solution for 20 minutes, and then were baked at 210° C. for 1 hour, providing a carrier d2. The carrier d2 had an average particle size of 80 μm, a specific gravity of 5.5, a magnetization value of 75 Am²/kg, a volume resistivity of 2×10¹² Ωcm, and a specific surface area of 0.024 m²/g.

### Carrier Comparative Example 7

As a coating resin, 100 g of acrylic modified silicone resin (KR-9706 manufactured by Shin-Etsu Chemical Co., Ltd.) was weighed in terms of solid content and dissolved in 300 cc of toluene solvent. Using a dip and dry coater, 10 kg of the ferrite particles d were coated by stirring the resin coating solution for 20 minutes, and then were baked at 210° C. for 1 hour, providing a carrier d3. The carrier d3 had an average particle size of 80 μm, a specific gravity of 5.5, a magnetization value of 75 Am²/kg, a volume resistivity of 2×10¹¹ Ωcm, and a specific surface area of 0.022 m²/g.

### (2) Resin Particle Dispersion Production

Next, examples of the toner of the present invention will be described, but the present invention is not limited by any of the following examples.

Table 1 shows the characteristics of the binder resin obtained in each of resin particle dispersions (RL1, RL2, RL3, RH1, and RH2) of the present invention and comparative resin particle dispersions (rl4, rl5, rh3 and rh4) that were prepared as examples of producing the resin particle dispersion. In Table 1, “Mn” represents a number-average molecular weight, “Mw” represents a weight-average molecular weight, “Mz” represents a Z-average molecular weight, “Mw/Mn” represents the ratio of the weight-average molecular weight (Mw) to the number-average molecular weight (Mn), “Mz/Mn” represents the ratio of the Z-average molecular weight (Mz) to the number-average molecular weight (Mn), “Mp” represents a peak value of the molecular weight, Tg (° C.) represents a glass transition point, and Ts (° C.) represents a softening point. Table 2 shows the amount of nonion (g) and the amount of anion (g) of the surface-active agents used for each of the resin particle dispersions, and the ratio (wt %) of the amount of nonion to the total amount of the surface-active agents.

TABLE 1

| | Mn(×10⁴) | Mw(×10⁴) | Mz(×10⁴) | Wm = Mw/Mn | Wz = Mz/Mn | Mp(×10⁴) | Tg ° C. | Ts ° C. |
|---|---|---|---|---|---|---|---|---|
| RL1 | 0.72 | 1.38 | 2.05 | 1.92 | 2.85 | 1.08 | 52 | 98 |
| RL2 | 0.75 | 1.76 | 3.01 | 2.35 | 4.01 | 1.85 | 47 | 106 |
| RL3 | 1.53 | 5.14 | 8.74 | 3.36 | 5.71 | 3.14 | 54 | 126 |
| rl4 | 0.41 | 0.76 | 4.30 | 1.85 | 10.49 | 0.70 | 39 | 89 |
| rl5 | 0.89 | 6.12 | 10.84 | 6.88 | 12.18 | 5.28 | 57 | 142 |
| RH1 | 1.43 | 5.14 | 18.90 | 3.59 | 13.22 | 5.80 | 58 | 144 |
| RH2 | 2.34 | 20.85 | 49.32 | 8.91 | 21.08 | 16.36 | 68 | 170 |
| rh3 | 0.26 | 2.83 | 9.62 | 10.88 | 37.00 | 0.27 | 43 | 135 |
| rh4 | 1.86 | 23.87 | 52.90 | 12.83 | 28.44 | 16.36 | 67 | 182 |

TABLE 2

| | Amount of | Amount of | |
|---|---|---|---|
| | nonion (g) | anion (g) | Ratio of nonion |
| RL1 | 7.2 | 4.8 | 60.0% |
| RL2 | 7.5 | 4.5 | 62.5% |
| RL3 | 10 | 2 | 83.3% |
| rl4 | 5.8 | 6.2 | 48.3% |
| rl5 | 4.5 | 7.5 | 37.5% |
| RH1 | 6.5 | 5.5 | 54.2% |
| RH2 | 10.2 | 1.8 | 85.0% |
| rh3 | 5.5 | 6.5 | 45.8% |
| rh4 | 4.5 | 7.5 | 37.5% |

(a) Preparation of Resin Particle Dispersion RL1

A monomer solution including 240.1 g of styrene, 59.9 g of n-butylacrylate, and 4.5 g of acrylic acid was dispersed in 440 g of ion-exchanged water with 7.2 g of nonionic surface-active agent (NONIPOL 400 manufactured by Sanyo Chemical Industries, Ltd.), 24 g of anionic surface-active agent (S20-F, a 20 wt % concentration aqueous solution, manufactured by Sanyo Chemical Industries, Ltd.), and 6 g of dodecanethiol. Then, 4.5 g of potassium persulfate was added to the resultant solution, and emulsion polymerization was performed at 75° C. for 4 hours, followed by an aging treatment at 90° C. for 2 hours. Thus, a resin particle dispersion RL1 was prepared, in which the resin particles having Mn of 7200, Mw of 13800, Mz of 20500, Mp of 10800, Ts of 98° C., Tg of 52° C., and a median diameter of 0.14 μm were dispersed. The pH of this resin particle dispersion was 1.8.

(b) Preparation of Resin Particle Dispersion RL2

A monomer solution including 230.1 g of styrene, 69.9 g of n-butylacrylate, and 4.5 g of acrylic acid was dispersed in 440 g of ion-exchanged water with 7.5 g of nonionic surface-active agent (NONIPOL 400 manufactured by Sanyo Chemical Industries, Ltd.), 22.5 g of anionic surface-active agent (S20-F, a 20 wt % concentration aqueous solution, manufactured by Sanyo Chemical Industries, Ltd.), and 6 g of dodecanethiol. Then, 4.5 g of potassium persulfate was added to the resultant solution, and emulsion polymerization was performed at 75° C. for 4 hours, followed by an aging treatment at 90° C. for 5 hours. Thus, a resin particle dispersion RL2 was prepared, in which the resin particles having Mn of 7500, Mw of 17600, Mz of 30100, Mp of 18500, Ts of 106° C., Tg of 47° C., and a median diameter of 0.18 μm were dispersed. The pH of this resin particle dispersion was 1.9.

(c) Preparation of Resin Particle Dispersion RL3

A monomer solution including 230.1 g of styrene, 69.9 g of n-butylacrylate, and 4.5 g of acrylic acid was dispersed in 440 g of ion-exchanged water with 10 g of nonionic surface-active agent (NONIPOL 400 manufactured by Sanyo Chemical Industries, Ltd.), 10 g of anionic surface-active agent (S20-F, a 20 wt % concentration aqueous solution, manufactured by Sanyo Chemical Industries, Ltd.), and 1.5 g of dodecanethiol. Then, 4.5 g of potassium persulfate was added to the resultant solution, and emulsion polymerization was performed at 75° C. for 4 hours, followed by an aging treatment at 90° C. for 4 hours. Thus, a resin particle dispersion RL2 was prepared, in which the resin particles having Mn of 15300, Mw of 51400, Mz of 87400, Mp of 31400, Ts of 126° C., Tg of 54° C., and a median diameter of 0.18 μm were dispersed. The pH of this resin particle dispersion was 1.8.

(d) Preparation of Resin Particle Dispersion RH1

A monomer solution including 230.1 g of styrene, 69.9 g of n-butylacrylate, and 4.5 g of acrylic acid was dispersed in 440 g of ion-exchanged water with 6.5 g of nonionic surface-active agent (NONIPOL 400 manufactured by Sanyo Chemical Industries, Ltd.), 27.5 g of anionic surface-active agent (S20-F, a 20 wt % concentration aqueous solution, manufactured by Sanyo Chemical Industries, Ltd.), and 1.5 g of dodecanethiol. Then, 1.5 g of potassium persulfate was added to the resultant solution, and emulsion polymerization was performed at 75° C. for 4 hours, followed by an aging treatment at 90° C. for 4 hours. Thus, a resin particle dispersion RH1 was prepared, in which the resin particles having Mn of 14300, Mw of 51400, Mz of 189000, Mp of 58000, Ts of 144° C., Tg of 58° C., and a median diameter of 0.14 μm were dispersed. The pH of this resin particle dispersion was 2.0.

(e) Preparation of Resin Particle Dispersion RH2

A monomer solution including 235 g of styrene, 65 g of n-butylacrylate, and 4.5 g of acrylic acid was dispersed in 440 g of ion-exchanged water with 10.2 g of nonionic surface-active agent (NONIPOL 400 manufactured by Sanyo Chemical Industries, Ltd.) and 9 g of anionic surface-active agent (S20-F, a 20 wt % concentration aqueous solution, manufactured by Sanyo Chemical Industries, Ltd.). Then, 3 g of potassium persulfate was added to the resultant solution, and emulsion polymerization was performed at 80° C. for 4 hours, followed by an aging treatment at 90° C. for 2 hours. Thus, a resin particle dispersion RH2 was prepared, in which the resin particles having Mn of 23400, Mw of 208500, Mz of 493200, Mp of 89100, Ts of 170° C., Tg of 68° C., and a median diameter of 0.18 μm were dispersed. The pH of this resin particle dispersion was 1.8.

(f) Preparation of Resin Particle Dispersion rl4

A monomer solution including 240 g of styrene, 60 g of n-butylacrylate, and 4.5 g of acrylic acid was dispersed in 440 g of ion-exchanged water with 5.8 g of nonionic surface-active agent (NONIPOL 400 manufactured by Sanyo Chemical Industries, Ltd.), 31 g of anionic surface-active agent (S20-F, a 20 wt % concentration aqueous solution, manufactured by Sanyo Chemical Industries, Ltd.), 15 g of dodecanethiol, and 3 g of carbon tetrabromide. Then, 3 g of potassium persulfate was added to the resultant solution, and emulsion polymerization was performed at 70° C. for 5 hours, followed by an aging treatment at 80° C. for 2 hours. Thus, a resin particle dispersion rl4 was prepared, in which the resin particles having Mn of 4100, Mw of 7600, Mz of 43000, Mp of 7000, Ts of 89° C., Tg of 39° C., and a median diameter of 0.18 μm were dispersed. The pH of this resin particle dispersion was 1.7.

(g) Preparation of Resin Particle Dispersion rl5

A monomer solution including 230.1 g of styrene, 69.9 g of n-butylacrylate, and 4.5 g of acrylic acid was dispersed in 440 g of ion-exchanged water with 4.5 g of nonionic surface-active agent (NONIPOL 400 manufactured by Sanyo Chemical Industries, Ltd.), 37.5 g of anionic surface-active agent (S20-F, a 20 wt % concentration aqueous solution, manufactured by Sanyo Chemical Industries, Ltd.), and 1.5 g of dodecanethiol. Then, 1.5 g of potassium persulfate was added to the resultant solution, and emulsion polymerization was performed at 75° C. for 5 hours, followed by an aging treatment at 80° C. for 2 hours. Thus, a resin particle dispersion rl5 was prepared, in which the resin particles having Mn of 8900, Mw of 61200, Mz of 108400, Mp of 52800, Ts of 142° C., Tg of 57° C., and a median diameter of 0.16 μm were dispersed. The pH of this resin particle dispersion was 1.8.

(h) Preparation of Resin Particle Dispersion rh3

A monomer solution including 255 g of styrene, 45 g of n-butylacrylate, and 4.5 g of acrylic acid was dispersed in 440 g of ion-exchanged water with 5.5 g of nonionic surface-active agent (NONIPOL 400 manufactured by Sanyo Chemical Industries, Ltd.), 32.5 g of anionic surface-active agent (S20-F, a 20 wt % concentration aqueous solution, manufactured by Sanyo Chemical Industries, Ltd.), 15 g of dodecanethiol, and 3 g of carbon tetrabromide. Then, 3 g of potassium persulfate was added to the resultant solution, and emulsion polymerization was performed at 75° C. for 5 hours, followed by an aging treatment at 80° C. for 2 hours. Thus, a resin particle dispersion rh3 was prepared, in which the resin particles having Mn of 2600, Mw of 28300, Mz of 96200, Mp of 2700, Ts of 135° C., Tg of 43° C., and a median diameter of 0.18 μm were dispersed. The pH of this resin particle dispersion was 2.0.

(i) Preparation of Resin Particle Dispersion rh4

A monomer solution including 255 g of styrene, 45 g of n-butylacrylate, and 4.5 g of acrylic acid was dispersed in 350 g of ion-exchanged water with 4.5 g of nonionic surface-active agent (NONIPOL 400 manufactured by Sanyo Chemical Industries, Ltd.) and 37.5 g of anionic surface-active agent (S20-F, a 20 wt % concentration aqueous solution, manufactured by Sanyo Chemical Industries, Ltd.). Then, 3 g of potassium persulfate was added to the resultant solution, and emulsion polymerization was performed at 80° C. for 5 hours, followed by an aging treatment at 90° C. for 2 hours. Thus, a resin particle dispersion rh4 was prepared, in which the resin particles having Mn of 18600, Mw of 238700, Mz of 529000, Mp of 163600, Ts of 182° C., Tg of 67° C., and a median diameter of 0.16 μm were dispersed. The pH of this resin particle dispersion was 2.1.

(3) Pigment Dispersion Production

Table 3 shows the pigments used. Table 4 shows the amount of nonion (g) and the amount of anion (g) of the surface-active agents used for each of the pigment dispersions, and the ratio (wt %) of the amount of nonion to the total amount of the surface-active agents.

TABLE 3

| | |
|---|---|
| PM1 | PERMANENT RUBINE F6B (Clariant) |
| PC1 | KETBLUE111 (Dainippon Ink and Chemicals, Inc.) |
| PY1 | PY74 (Sanyo Color Works, Ltd.) |
| PB1 | MA100S (Mitsubishi Chemical Corporation) |
| PB2 | #45L (Mitsubishi Chemical Corporation) |

TABLE 4

| | Ma | Amount of | Amount of | Ratio of |
|---|---|---|---|---|
| | pigment (g) | nonion (g) | anion (g) | nonion |
| PM1 | 20 | 2 | 0 | 100.0% |
| PM2 | 20 | 1.5 | 1.2 | 55.6% |
| pm3 | 20 | 1.2 | 1.4 | 46.2% |
| pm4 | 20 | 0 | 2 | 0.0% |

(a) Preparation of Colorant Particle Dispersion PM1

20 g of magenta pigment (PERMANENT RUBINE F6B manufactured by Clariant), 2 g of nonionic surface-active agent (ELEMINOL NA 400 manufactured by Sanyo Chemical Industries, Ltd.), and 78 g of ion-exchanged water were mixed and dispersed by using an ultrasonic dispersing device at an oscillation frequency of 30 kHz for 20 minutes. Thus, a colorant particle dispersion PM1 was prepared, in which the colorant particles having a median diameter of 0.12 μm were dispersed.

(b) Preparation of Colorant Particle Dispersion PC1

20 g of cyan pigment (KETBLUE111 manufactured by Dainippon Ink and Chemicals, Inc.), 2 g of nonionic surface-active agent (ELEMINOL NA 400 manufactured by Sanyo Chemical Industries, Ltd.), and 78 g of ion-exchanged water were mixed and dispersed by using an ultrasonic dispersing device at an oscillation frequency of 30 kHz for 20 minutes. Thus, a colorant particle dispersion PC1 was prepared, in which the colorant particles having a median diameter of 0.12 μm were dispersed.

(c) Preparation of Colorant Particle Dispersion PY1

20 g of yellow pigment (PY74 manufactured by Sanyo Color Works, Ltd.), 2 g of nonionic surface-active agent (ELEMINOL NA 400 manufactured by Sanyo Chemical Industries, Ltd.), and 78 g of ion-exchanged water were mixed and dispersed by using an ultrasonic dispersing device at an oscillation frequency of 30 kHz for 20 minutes. Thus, a colorant particle dispersion PY1 was prepared, in which the colorant particles having a median diameter of 0.12 μm were dispersed.

(d) Preparation of Colorant Particle Dispersion PB1

20 g of black pigment (MA100S manufactured by Mitsubishi Chemical Corporation), 2 g of nonionic surface-active agent (ELEMINOL NA 400 manufactured by Sanyo Chemical Industries, Ltd.), and 78 g of ion-exchanged water were mixed and dispersed by using an ultrasonic dispersing device at an oscillation frequency of 30 kHz for 20 minutes. Thus, a colorant particle dispersion PB1 was prepared, in which the colorant particles having a median diameter of 0.12 μm were dispersed.

(e) Preparation of Colorant Particle Dispersion PB2

20 g of black pigment (#45L manufactured by Mitsubishi Chemical Corporation), 2 g of nonionic surface-active agent (ELEMINOL NA 400 manufactured by Sanyo Chemical Industries, Ltd.), and 78 g of ion-exchanged water were mixed and dispersed by using an ultrasonic dispersing device at an oscillation frequency of 30 kHz for 20 minutes. Thus, a colorant particle dispersion PB1 was prepared, in which the colorant particles having a median diameter of 0.12 μm were dispersed.

(f) Preparation of Colorant Particle Dispersion PM2

20 g of magenta pigment (PERMANENT RUBINE F6B manufactured by Clariant), 1.5 g of nonionic surface-active agent (NONIPOL 400 manufactured by Sanyo Chemical Industries, Ltd.), 6 g of anionic surface-active agent (S20-F, a 20 wt % concentration aqueous solution, manufactured by Sanyo Chemical Industries, Ltd.), and 78 g of ion-exchanged water were mixed and dispersed by using an ultrasonic dispersing device at an oscillation frequency of 30 kHz for 20 minutes. Thus, a colorant particle dispersion PM2 was prepared, in which the colorant particles having a median diameter of 0.12 μm were dispersed.

(g) Preparation of Colorant Particle Dispersion pm3

20 g of magenta pigment (PERMANENT RUBINE F6B manufactured by Clariant), 1.2 g of nonionic surface-active agent (NONIPOL 400 manufactured by Sanyo Chemical Industries, Ltd.), 7 g of anionic surface-active agent (S20-F, a 20 wt % concentration aqueous solution, manufactured by Sanyo Chemical Industries, Ltd.), and 78 g of ion-exchanged water were mixed and dispersed by using an ultrasonic dispersing device at an oscillation frequency of 30 kHz for 20 minutes. Thus; a colorant particle dispersion pm3 was prepared, in which the colorant particles having a median diameter of 0.12 μm were dispersed.

(h) Preparation of Colorant Particle Dispersion pm4

20 g of magenta pigment (PERMANENT RUBINE F6B manufactured by Clariant), 10 g of anionic surface-active agent (S20-F, a 20 wt % concentration aqueous solution, manufactured by Sanyo Chemical Industries, Ltd.), and 78 g of ion-exchanged water were mixed and dispersed by using an ultrasonic dispersing device at an oscillation frequency of 30 kHz for 20 minutes. Thus, a colorant particle dispersion pm4 was prepared, in which the colorant particles having a median diameter of 0.12 μm were dispersed.

(4) Wax Dispersion Production

Tables 5, 6 and 7 show the wax materials (W-1, W-2, W-3, W-4, W-5, W-6, W-7, W-8, W-11, W-12 and W-13) and their characteristics used for the production of wax particle dispersions (WA1, WA2, WA3, WA4, WA5, WA6, WA7, and WA8) of the present invention and comparative wax particle dispersions (wa9, wa10, wa11, wa12, wa13, wa14 and wa15) that were prepared as examples of producing the wax particle dispersion.

TABLE 5

| | | Melting | | | |
|---|---|---|---|---|---|
| | | point | Heating | | Saponi- |
| | | Tmw1 | loss Ck | Iodine | fication |
| Wax | Material | (° C.) | (wt %) | value | value |
| W-1 | Maximum hydrogenated | 68 | 2.8 | 2 | 95.7 |
| | jojoba oil | | | | |
| W-2 | Maximum hydrogenated | 71 | 2.5 | 2 | 90 |
| | meadowfoam oil | | | | |
| W-3 | Carnauba wax | 84 | 1.5 | 8 | 88 |
| W-4 | Jojoba oil fatty acid | 84 | 3.4 | 2 | 120 |
| | pentaerythritol monoester | | | | |
| W-5 | Stearyl stearate | 58 | 2 | | |
| W-6 | Triglyceride stearate | 63 | 1.5 | | |
| W-7 | Behenyl behenate | 74 | 1.2 | | |
| W-8 | Glycerol triester | 85 | 1.9 | | |
| | (hydrogenated castor oil) | | | | |

TABLE 6

| | | Melting | | |
|---|---|---|---|---|
| | | point | | |
| | | Tmw2 | Acid | Penetration |
| | | (° C.) | value | number |
| W-11 | Saturated hydrocarbon wax | 85 | | 1 |
| | (FNP0085 manufactured by | | | |
| | Nippon Seiro Co., Ltd.) | | | |
| W-12 | Saturated hydrocarbon wax | 90.2 | | 1 |
| | (FNP0090 manufactured by | | | |
| | Nippon Seiro Co., Ltd.) | | | |
| W-13 | Polyolefin wax (PE890 | 94 | | 1 |
| | manufactured by Clariant) | | | |

TABLE 7

| | First | Second | PR16 | PR50 | PR84 | PR84/ |
|---|---|---|---|---|---|---|
| Dispersion | wax | wax | (nm) | (nm) | (nm) | PR16 |
| WA1 | W-1(1) | W-11(5) | 98 | 133 | 168 | 1.71 |
| WA2 | W-2(1) | W-12(2) | 109 | 159 | 209 | 1.92 |
| WA3 | W-3(1) | W-13(1) | 198 | 293.5 | 389 | 1.96 |
| WA4 | W-4(1) | W-13(2) | 187 | 272.5 | 358 | 1.91 |
| WA5 | W-5(1) | W-11(4) | 108 | 148.5 | 189 | 1.75 |
| WA6 | W-6(1) | W-12(5) | 110 | 158 | 206 | 1.87 |
| WA7 | W-7(1) | W-11(5) | 112 | 160 | 208 | 1.86 |
| WA8 | W-8(1) | W-13(3) | 124 | 187 | 246 | 1.99 |
| wa9 | W-1(1) | | 112 | 155 | 198 | 1.77 |
| wa10 | W-3(1) | | 168 | 236 | 304 | 1.81 |
| wa11 | W-11(1) | | 168 | 250 | 332 | 1.98 |
| wa12 | W-13(1) | | 168 | 240 | 312 | 1.86 |
| wa13 | W-5(3) | W-11(2) | 189 | 289 | 389 | 2.06 |
| wa14 | W-6(1) | W-12(5) | 132 | 199.5 | 267 | 2.02 |
| wa15 | W-6(l) | W-12(5) | 119 | 208.5 | 298 | 2.50 |

Table 7 shows the composition of the wax components and the particle properties of each of the wax particle dispersions (WA1 to WA8) of the present invention and the comparative wax particle dispersions (wa9 to wa15) produced. In Table 7, the “first wax” and the “second wax” represent the wax materials used in the wax particle dispersions, and the values in parentheses after the wax materials indicate the amount of composition of the mixed wax (weight ratio). Moreover, “PR16” indicates the value of the particle size at 16% accumulated from a smaller particle diameter side in the volume-based particle size distribution of the wax particles in the wax particle dispersion. Similarly, “PR50” indicates 50% diameter and “PR84” indicates 84% diameter. “PR84/PR16” indicates the ratio of the 84% diameter (PR84) to the 16% diameter (PR16).

TABLE 8

| | Amount of | Amount of | | Amount of | Amount of |
|---|---|---|---|---|---|
| | nonion | anion | Ratio of | first wax | second wax |
| Dispersion | (g) | (g) | nonion | (g) | (g) |
| WA1 | 2 | 1 | 67% | 5 | 25 |
| WA2 | 1.8 | 1.2 | 60% | 10 | 20 |
| WA3 | 2.5 | 0.5 | 83% | 15 | 15 |
| WA4 | 2.7 | 0.3 | 90% | 10 | 20 |
| WA5 | 3 | 0 | 100% | 6 | 24 |
| WA6 | 3 | 0 | 100% | 5 | 25 |
| WA7 | 1.8 | 1.2 | 60% | 5 | 25 |
| WA8 | 3 | 0 | 100% | 7.5 | 22.5 |
| wa9 | 3 | 0 | 100% | 30 | |
| wa10 | 3 | 0 | 100% | 30 | |
| wa11 | 3 | 0 | 100% | 30 | |
| wa12 | 3 | 0 | 100% | 30 | |
| wa13 | 3 | 0 | 100% | 18 | 12 |
| wa14 | 1.4 | 1.6 | 47% | 5 | 25 |
| wa15 | 0 | 3 | 0% | 5 | 25 |

Table 8 shows the amount of nonion (g) and the amount of anion (g) of the surface-active agents used for each of the wax particle dispersions, and the ratio (wt %) of the amount of nonion to the total amount of the surface-active agents.

(a) Preparation of Wax Particle Dispersion WA1

FIG. 3 is a schematic view of a stirring/dispersing device, and FIG. 4 is a plan view of the same. As shown in FIG. 3, cooling water is introduced from 808 to the inside of an outer tank 801 and then is discharged from 807. Reference numeral 802 is a shielding board that stops the flow of the liquid to be treated. The shielding board 802 has an opening in the central portion, and the treated liquid is drawn from the opening and taken out of the device through 805. Reference numeral 803 is a rotating body that is secured to a shaft 806 and rotates at high speed. There are holes (about 1 to 5 mm in size) in the side of the rotating body 803, and the liquid to be treated can move through the holes. The liquid to be treated is put into the tank in an amount of about one-half the capacity (120 ml) of the tank. The maximum rotational speed of the rotating body 803 is 50 m/s. The rotating body 803 has a diameter of 52 mm, and the tank 801 has an internal diameter of 56 mm. Reference numeral 804 is a material inlet used for a continuous treatment. In the case of a batch treatment, the material inlet 804 is closed.

The tank was kept at atmospheric pressure, and 67 g of ion-exchanged water, 2 g of nonionic surface-active agent (ELEMINOL NA 400 manufactured by Sanyo Chemical Industries, Ltd.), 5 g of anionic surface-active agent (S20-F, a 20 wt % concentration aqueous solution, manufactured by Sanyo Chemical Industries, Ltd.), 5 g of the first wax (W-1), and 25 g of the second wax (W-11) were blended and treated while the rotating body rotated at a rotational speed of 30 m/s for 5 minutes, and then 50 m/s for 2 minutes. Thus, a wax particle dispersion WA1 was provided.

(b) Preparation of Wax Particle Dispersion WA2

Under the same conditions as the preparation of the wax particle dispersion WA1, 67 g of ion-exchanged water, 1.8 g of nonionic surface-active agent (ELEMINOL NA 400 manufactured by Sanyo Chemical Industries, Ltd.), 6 g of anionic surface-active agent (S20-F, a 20 wt % concentration aqueous solution, manufactured by Sanyo Chemical Industries, Ltd.), 10 g of the first wax (W-2), and 20 g of the second wax (W-12) were blended and treated while the rotating body rotated at a rotational speed of 30 m/s for 3 minutes, and then 50 m/s for 2 minutes. Thus, a wax particle dispersion WA2 was provided.

(c) Preparation of Wax Particle Dispersion WA3

Under the same conditions as the preparation of the wax particle dispersion WA1 except that the tank was pressurized at 0.4 Mpa, 67 g of ion-exchanged water, 2.5 g of nonionic surface-active agent (ELEMINOL NA 400 manufactured by Sanyo Chemical Industries, Ltd.), 2.5 g of anionic surface-active agent (S20-F, a 20 wt % concentration aqueous solution, manufactured by Sanyo Chemical Industries, Ltd.), 15 g of the first wax (W-3), and 15 g of the second wax (W-13) were blended and treated while the rotating body rotated at a rotational speed of 20 m/s for 3 minutes, and then 45 m/s for 2 minutes. Thus, a wax particle dispersion WA3 was provided.

(d) Preparation of Wax Particle Dispersion WA4

Under the same conditions as the preparation of the wax particle dispersion WA1 except that the tank was pressurized at 0.4 Mpa, 67 g of ion-exchanged water, 2.7 g of nonionic surface-active agent (ELEMINOL NA 400 manufactured by Sanyo Chemical Industries, Ltd.), 1.5 g of anionic surface-active agent (S20-F, a 20 wt % concentration aqueous solution, manufactured by Sanyo Chemical Industries, Ltd.), 10 g of the first wax (W-4), and 20 g of the second wax (W-13) were blended and treated while the rotating body rotated at a rotational speed of 30 m/s for 3 minutes, and then 50 m/s for 2 minutes. Thus, a wax particle dispersion WA4 was provided.

(e) Preparation of Wax Particle Dispersion WA5

FIG. 5 is a schematic view of a stirring/dispersing device, and FIG. 6 is a plan view of the same. Reference numeral 850 is an inlet and 852 is a stator with a floating structure. The stator 852 is pressed down by springs 851, but pushed up by a force created when a rotor 853 rotates at high speed. Therefore, a narrow gap of about 1 μm to 10 μm is formed between the stator 852 and the rotor 853. Reference numeral 854 is a shaft connected to a motor (not shown). Materials are fed into the device from the inlet 850, subjected to a strong shearing force in the gap between the stator 852 and the rotor 853, and thus formed into fine particles dispersed in the liquid. The material liquid thus treated is drawn from outlets 856. As shown in FIG. 6, the material liquid 855 is released radially and collected in a closed container. The rotor 853 has an outer diameter of 100 mm.

The material liquid, in which wax and a surface-active agent were predispersed in a pressurized and heated aqueous medium, was introduced from the inlet 850 and treated instantaneously to make a fine particle dispersion. The amount of material liquid supplied was 1 kg/h, and the maximum rotational speed of the rotor 853 was 100 m/s.

67 g of ion-exchanged water, 3 g of nonionic surface-active agent (ELEMINOL NA 400 manufactured by Sanyo Chemical Industries, Ltd.), 6 g of the first wax (W-5), and 24 g of the second wax (W-11) were blended and treated in a supplied amount of 1 kg/h while the rotor rotated at a rotational speed of 100 m/s. Thus, a wax particle dispersion WA5 was provided.

(f) Preparation of Wax Particle Dispersion WA6

Under the same conditions as the preparation of the wax particle dispersion WA1, 67 g of ion-exchanged water, 3 g of nonionic surface-active agent (ELEMINOL NA 400 manufactured by Sanyo Chemical Industries, Ltd.), 5 g of the first wax (W-6), and 25 g of the second wax (W-12) were blended and treated while the rotating body rotated at a rotational speed of 20 m/s for 3 minutes, and then 50 m/s for 2 minutes. Thus, a wax particle dispersion WA6 was provided.

(g) Preparation of Wax Particle Dispersion WA7

Under the same conditions as the preparation of the wax particle dispersion WA1 except that the tank was pressurized at 0.4 Mpa, 67 g of ion-exchanged water, 1.8 g of nonionic surface-active agent (ELEMINOL NA 400 manufactured by Sanyo Chemical Industries, Ltd.), 6 g of anionic surface-active agent (S20-F, a 20 wt % concentration aqueous solution, manufactured by Sanyo Chemical Industries, Ltd.), 5 g of the first wax (W-7), and 25 g of the second wax (W-11) were blended and treated while the rotating body rotated at a rotational speed of 20 m/s for 3 minutes, and then 50 m/s for 2 minutes. Thus, a wax particle dispersion WA7 was provided.

(h) Preparation of Wax Particle Dispersion WA8

Under the same conditions as the preparation of the wax particle dispersion WA1, 67 g of ion-exchanged water, 3 g of nonionic surface-active agent (ELEMINOL NA 400 manufactured by Sanyo Chemical Industries, Ltd.), 7.5 g of the first wax (W-8), and 22.5 g of the second wax (W-13) were blended and treated while the rotating body rotated at a rotational speed of 20 m/s for 3 minutes, and then 50 m/s for 2 minutes. Thus, a wax particle dispersion WA8 was provided.

(i) Preparation of Wax Particle Dispersion wa9

Under the same conditions as the preparation of the wax particle dispersion WA1, 67 g of ion-exchanged water, 3 g of nonionic surface-active agent (ELEMINOL NA 400 manufactured by Sanyo Chemical Industries, Ltd.), and 30 g of the wax (W-1) were blended and treated while the rotating body rotated at a rotational speed of 20 m/s for 3 minutes, and then 50 m/s for 2 minutes. Thus, a wax particle dispersion wa9 was provided.

(j) Preparation of Wax Particle Dispersion wa10

Under the same conditions as the preparation of the wax particle dispersion WA5, 67 g of ion-exchanged water, 3 g of nonionic surface-active agent (ELEMINOL NA 400 manufactured by Sanyo Chemical Industries, Ltd.), and 30 g of the wax (W-3) were blended and treated in a supplied amount of 1 kg/h while the rotor rotated at a rotational speed of 100 m/s. Thus, a wax particle dispersion WA10 was provided.

(k) Preparation of Wax Particle Dispersion wa11

Under the same conditions as the preparation of the wax particle dispersion WA1, 67 g of ion-exchanged water, 3 g of nonionic surface-active agent (ELEMINOL NA 400 manufactured by Sanyo Chemical Industries, Ltd.), and 30 g of the wax (W-11) were blended and treated while the rotating body rotated at a rotational speed of 20 m/s for 3 minutes, and then 50 m/s for 2 minutes. Thus, a wax particle dispersion wa11 was provided.

(l) Preparation of Wax Particle Dispersion wa12

Under the same conditions as the preparation of the wax particle dispersion WA1 except that the tank was pressurized at 0.4 Mpa, 67 g of ion-exchanged water, 3 g of nonionic surface-active agent (ELEMINOL NA 400 manufactured by Sanyo Chemical Industries, Ltd.), and 30 g of the wax (W-13) were blended and treated in a supplied amount of 1 kg/h while the rotor rotated at a rotational speed of 100 m/s. Thus, a wax particle dispersion wa12 was provided.

(m) Preparation of Wax Particle Dispersion wa13

Under the same conditions as the preparation of the wax particle dispersion WA4, 67 g of ion-exchanged water, 3 g of nonionic surface-active agent (ELEMINOL NA 400 manufactured by Sanyo Chemical Industries, Ltd.), 18 g of the first wax (W-5), and 12 g of the second wax (W-11) were blended and treated while the rotating body rotated at a rotational speed of 30 m/s for 3 minutes, and then 50 m/s for 2 minutes. Thus, a wax particle dispersion wa13 was provided.

(n) Preparation of Wax Particle Dispersion wa14

Under the same conditions as the preparation of the wax particle dispersion WA6, 67 g of ion-exchanged water, 1.4 g of nonionic surface-active agent (ELEMINOL NA 400 manufactured by Sanyo Chemical Industries, Ltd.), 8 g of anionic surface-active agent (S20-F, a 20 wt % concentration aqueous solution, manufactured by Sanyo Chemical Industries, Ltd.), 5 g of the first wax (W-6), and 25 g of the second wax (W-12) were blended and treated while the rotating body rotated at a rotational speed of 20 m/s for 3 minutes, and then 50 m/s for 2 minutes. Thus, a wax particle dispersion wa14 was provided.

(o) Preparation of Wax Particle Dispersion wa15

Under the same conditions as the preparation of the wax particle dispersion WA6, 67 g of ion-exchanged water, 15 g of anionic surface-active agent (S20-F, a 20 wt % concentration aqueous solution, manufactured by Sanyo Chemical Industries, Ltd.), 5 g of the first wax (W-6), and 25 g of the second wax (W-12) were blended and treated while the rotating body rotated at a rotational speed of 20 m/s for 3 minutes, and then 50 m/s for 2 minutes. Thus, a wax particle dispersion wa15 was provided.

(5) Toner Base Production

Table 9 shows the compositions and the characteristics of each of toner bases (M1, M2, M3d, M4d, M5d, M6, M7, M8, M9, M10, M11, and M12) of the present invention and comparative toner bases (m21, m22, m23, m24, m25, m26, m27, m28, m29, m30, m31, and m32) that were prepared as examples of producing the toner base. In Table 9, d50 (μm) is a volume-average particle size of the toner base particles, and the “coefficient of variation” indicates the degree of expansion of the volume-based particle size distribution of the toner base particles in each of the toner bases produced.

TABLE 9

| | | | | | | Volume-based |
|---|---|---|---|---|---|---|
| | First resin | Wax | Pigment | Second resin | d50 | coefficient |
| Toner | dispersion | dispersion | dispersion | dispersion | (μm) | of variation |
| M1 | RL1 | WA1 | PM1 | RH1 | 3.8 | 16.1 |
| M2 | RL1 | WA2 | PM1 | RH1 | 6.7 | 16.9 |
| M3d | RL1 | WA3 | PM1 | RH2 | 4.2 | 15.1 |
| M4d | RL1 | WA4 | PM1 | RH2 | 3.8 | 15.4 |
| M5d | RL2 | WA5 | PM1 | RH1 | 6.3 | 16.1 |
| M6 | RL2 | WA6 | PM1 | RH1 | 4 | 15.9 |
| M7 | RL2 | WA7 | PM1 | RH1 | 4.2 | 16.8 |
| M8 | RL2 | WA8 | PM1 | RH2 | 5.9 | 16.1 |
| M9 | RL2 | WA7 | PM2 | RH1 | 4.3 | 19.1 |
| M10 | RL1 | WA4 | PM1 | RH2 | 3.8 | 15.4 |
| M11 | RL2 | WA8 | PM1 | RH2 | 5.9 | 16.1 |
| M12 | RL2 | WA5 | PB2 | RH2 | 6.5 | 17.1 |
| m21 | RL2 | WA6 | PB1 | rh3 | 10.8 | 29.8 |
| m22 | RL2 | wa9 | P1 | RH1 | 6.8 | 25.8 |
| m23 | RL1 | wa11 | PM1 | RH1 | 5.9 | 25.9 |
| m24 | RL2 | WA7 | PM1 | RH1 | 4.5 | 26.2 |
| m25 | RL1 | WA3 | PM1 | RH2 | 7.2 | 27.1 |
| m26 | RL1 | wa13 | PM1 | RH2 | 6.2 | 26.8 |
| m27 | RL2 | wa14 | PM1 | RH1 | 8.4 | 27.9 |
| m28 | RL2 | wa15 | PM1 | RH1 | 10.9 | 31.8 |
| m29 | rl4 | WA6 | PM1 | rh3 | 15.3 | 32.5 |
| m30 | rl5 | WA7 | PM1 | rh4 | 4.9 | 37.6 |
| m31 | RL2 | WA7 | pm3 | RH1 | 8.2 | 26.8 |
| m32 | RL2 | WA7 | pm4 | RH1 | 11.4 | 33.9 |

(1) Preparation of Toner Base M1

In a 2000 ml four-neck flask equipped with a thermometer, a cooling tube, a stirring rod, and a pH meter were placed 204 g of the first resin particle dispersion RL1, 45 g of the colorant particle dispersion PM1, 85 g of the wax particle dispersion WA1, and 480 ml of ion-exchanged water, and then mixed for 10 minutes by using a homogenizer (Ultratalax T25 manufactured by IKA CO., LTD.). Thus, a mixed dispersion was prepared. The pH of the mixed dispersion was 3.5.

Then, the pH was increased to 11.8 by adding 1N NaOH to the mixed dispersion, and this was stirred for 10 minutes. Subsequently, the temperature was raised from 20° C. at a rate of 1° C./min. When the temperature reached 70° C., 240 g of magnesium sulfate aqueous solution (23 wt % concentration) was dropped continuously for a duration of 30 minutes and heat-treated for 1 hour. Thereafter, the temperature was raised to 90° C., and the mixture was heat-treated for 3 hours, thus forming core particles. The pH of the core particle dispersion was 9.2.

Moreover, the water temperature was raised to 92° C., and then 165 g of the second resin particle dispersion RH1 with an adjusted pH of 8.5 was added at a drop rate of 5 g/min. After completion of the dropping, this mixture was heat-treated for 1.5 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base M1 with a volume-average particle size of 3.8 μm and a coefficient of variation of 16.1.

If the pH of the mixed dispersion before heating was less than 9.5, the core particles became coarser to the extent that the volume-average particle size was 11 μm or more. If the pH was 12.5, the amount of liberated wax was increased, and it was difficult to incorporate the wax uniformly. The mixed dispersion remained white and cloudy.

If the pH of the mixed dispersion at the time of forming the core particles was more than 9.5, the numbers of liberated wax or colorant particles were increased in the aqueous medium due to poor aggregation.

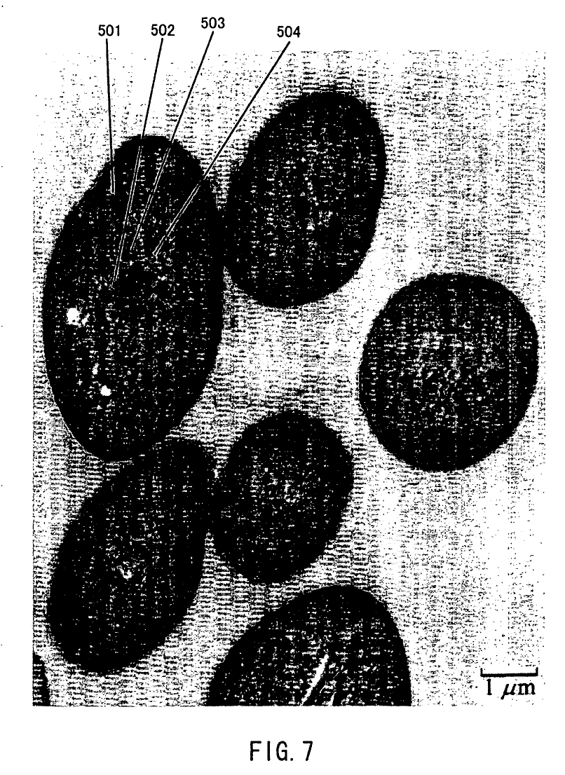

FIG. 7 shows a TEM (transmission electron microscope) cross-sectional image of the toner base particles M1 (magnification: 20000×). The TEM used in this example was H7650 manufactured by Hitachi, Ltd., with an accelerating voltage of 100 kV. The sample was stained with a ruthenium acid (0.2% aqueous solution) for 5 minutes to clarify the structure of the sample. Then, the sample was embedded in a room temperature curing epoxy resin, and cross sections of the sample were produced by ultramicrotomy for TEM observation.

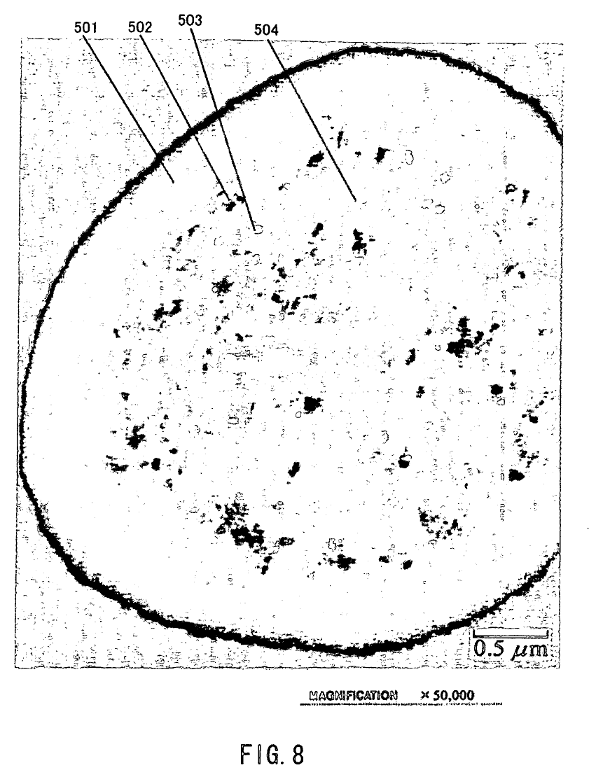

In FIG. 7, it can be seen that the second resin particles form a shell resin fused layer 501 with a thickness of about 0.5 μm as an outer shell. Moreover, each of the toner base particles is formed so that black particles 502, which are considered as a pigment, the first resin particles 504, and the wax are melted, mixed., and dispersed inside the toner base particle. The white particles 503 appear to be the wax. However, it seems that many wax particles and the resin dissolve in each other, and such wax cannot be identified in this TEM image. In any event, the wax of this configuration is not present like islands (e.g., domains that are several microns in size), but may be characterized by its mixed and dispersed state with the pigment and the resin. This may contribute to achieving the fixability, the offset resistance, and the storage stability. FIG. 8 shows a magnified TEM image (magnification: 50000×). In FIG. 8, the black thin film that seems to be an outermost shell results from staining to make the boundary clearer for TEM observation and thus is irrelevant to the toner.

(2) Preparation of Toner Base M2

In a 2000 ml four-neck flask equipped with a thermometer, a cooling tube, a stirring rod, and a pH meter were placed 204 g of the first resin particle dispersion RL1, 45 g of the colorant particle dispersion PM1, 80 g of the wax particle dispersion WA2, and 2.40 ml of ion-exchanged water, and then mixed for 10 minutes by using a homogenizer (Ultratalax T25 manufactured by IKA CO., LTD.). Thus, a mixed dispersion was prepared. The pH of the mixed dispersion was 2.8.

Then, the pH was increased to 9.7 by adding 1N NaOH to the mixed dispersion, and this was stirred for 10 minutes. Subsequently, the temperature was raised from 20° C. at a rate of 1° C./min. When the temperature reached 80° C., 480 g of magnesium sulfate aqueous solution (23 wt % concentration) was dropped continuously for a duration of 100 minutes and heat-treated for 1 hour. Thereafter, the temperature was raised to 90° C., and the mixture was heat-treated for 3 hours, thus forming core particles. The pH of the core particle dispersion was 7.2.

Moreover, the water temperature was kept at 90° C., and then 165 g of the second resin particle dispersion RH1 with an adjusted pH of 6.8 was added at a drop rate of 5 g/min. After completion of the dropping, this mixture was heat-treated at 90° C. for 1.5 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base M2 with a volume-average particle size of 6.7 μm and a coefficient of variation of 16.9.

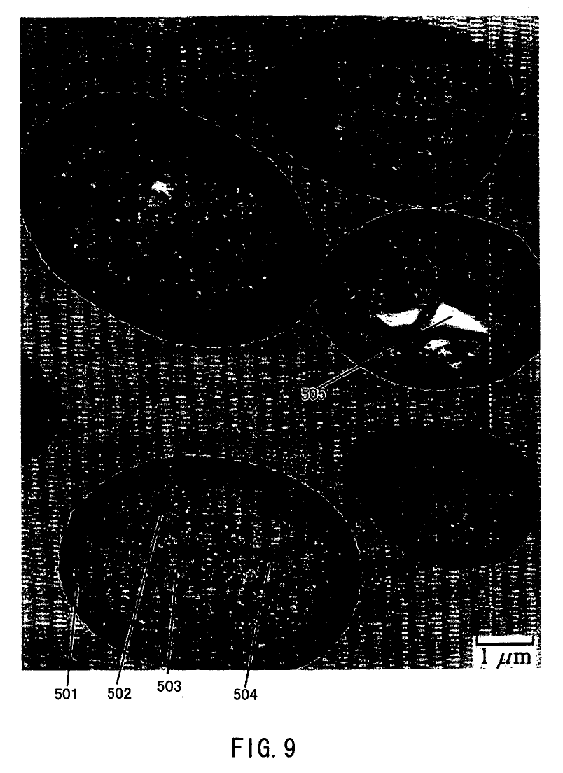

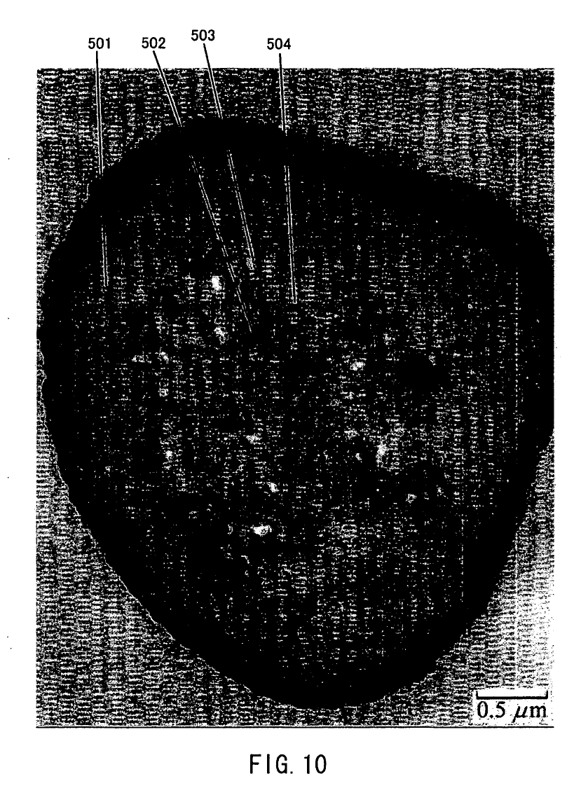

FIG. 9 shows a TEM (transmission electron microscope) cross-sectional image of the toner base particles M2 (magnification: 20000×). In FIG. 9, as with the toner base M1, it can be seen that the second resin particles form a shell resin fused layer 501 with a thickness of about 0.5 μm as an outer shell. Moreover, each of the toner base particles is formed so that black particles 502, which are considered as a pigment, the first resin particles 504, and the wax are melted, mixed, and dispersed inside the toner base particle. The white particles 503 appear to be the wax. However, it seems that many wax particles and the resin dissolve in each other, and such wax cannot be identified in this TEM image. In any event, the wax of this configuration is not present like islands (e.g., domains that are several microns in size), but may be characterized by its mixed and dispersed state with the pigment and the resin. This may contribute to achieving the fixability, the offset resistance, and the storage stability. In FIG. 9, a white portion 505 is considered to be a flaw caused by peeling of the particle when the cross sections were cut with a microtome. FIG. 10 shows a magnified TEM image (magnification: 50000×).

(3) Preparation of Toner Base M3

In a 2000 ml four-neck flask equipped with a thermometer, a cooling tube, a stirring rod, and a pH meter were placed 204 g of the first resin particle dispersion RL1, 31 g of the colorant particle dispersion PM1, 40 g of the wax particle dispersion WA3, and 220 ml of ion-exchanged water, and then mixed for 10 minutes by using a homogenizer (Ultratalax T25 manufactured by MA CO., LTD.). Thus, a mixed dispersion was prepared. The pH of the mixed dispersion was 3.8.

Then, the pH was increased to 11.1 by adding 1N NaOH to the mixed dispersion, and this was stirred for 10 minutes. Subsequently, the temperature was raised from 20° C. at a rate of 1° C./min. When the temperature reached 80° C., 250 g of magnesium sulfate aqueous solution (23 wt % concentration) was dropped continuously for a duration of 30 minutes and heat-treated for 1 hour. Thereafter, the temperature was raised to 95° C., and the mixture was heat-treated for 3 hours, thus forming core particles. The pH of the core particle dispersion was 8.5.

Moreover, the water temperature was kept at 95° C., and then 50 g of the second resin particle dispersion RH2 with an adjusted pH of 7.5 was added at a drop rate of 1 g/min. After completion of the dropping, this mixture was heat-treated at 95° C. for 2 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base M3d with a volume-average particle size of 4.2 μm and a coefficient of variation of 15.1.

Table 10 shows the initial pH of the mixed dispersion of the first resin particle dispersion, the colorant particle dispersion, and the wax particle dispersion, and changes in the temperature (° C.) inside the container and in the volume-average particle size (d50 (μm)) of the core particles growing in the liquid with time during the core particle formation process after the dropping of an aggregating agent into the mixed dispersion. Moreover, Table 10 shows changes in the temperature inside the container and in the volume-average particle size (d50 (μm)) of the core particles fused with the resin particles with time during the second resin particle fusion process (adhesion and melting) after the dropping of the second resin particle dispersion. Further, Table 10 shows the volume-average particle size and the shape factor of the core particles fused with the resin particles at 2 hours (h) after completion of the dropping of the second resin particle dispersion.

The “R: (figure)” in the column referred to as “at the time of completion of the dropping” of the second resin particle dispersion indicates the adjusted pH value of the second resin particle dispersion. M3a to M3i indicate the characteristic values corresponding to the adjusted pH values of 10.5, 9.5, 8.5, 7.5, 6.5, 5.5, 4.5, 3.5, and 2.5 of the second resin particle dispersion, respectively.

M3a to M3i were produced by way of trial under the same conditions as M3d, but differ only in the adjusted pH value of the second resin particle dispersion to be dropped. In the core particle formation processes of M3b to M3c and M3e to M3i, the pH and the temperature inside the container were the same, and the d50 value also was substantially the same for each. Therefore, they are omitted from Table 10.

TABLE 10

| | | Formation of core particles | | | | | Fusion of second resin particles | | | 2 h after | |
|---|---|---|---|---|---|---|---|---|---|---|---|
| | | | At the | 1 h | 2 h | 3 h | At the | | | completion of dropping | |
| Toner | Treat- | | time of | after | after | after | time of | 1 h after | 2 h after | Coefficient | |
| base | ment | After | reaching | reaching | reaching | reaching | completion | completion | completion | of variation | Shape |
| particles | time (h) | mixing | 95° C. | 95° C. | 95° C. | 95° C. | of dropping | of dropping | of dropping | in volume | factor |
| M3a | pH | 11.2 | | | | 8.5 | R: 10.5 | | | | |
| | Temper- | | 90° C. | 90° C. | 90° C. | 90° C. | 90° C. | 95° C. | 95° C. | | |
| | ature | | | | | | | | | | |
| | (° C.) | | | | | | | | | | |
| | d50(μm) | | 2.28 | 2.78 | 3.04 | 3.34 | 4.21 | 5.02 | 5.12 | 19.8 | 141 |
| M3b | pH | | | | | | R: 9.5 | | | | |
| | d50(μm) | | | | | | 3.99 | 4.85 | 4.78 | 17.9 | 136 |
| M3c | pH | | | | | | R: 8.5 | | | | |
| | d50(μm) | | | | | | 3.98 | 4.78 | 4.56 | 16.8 | 130 |
| M3d | pH | | | | | | R: 7.5 | | | | |
| | d50(μm) | | | | | | 3.87 | 4.18 | 4.22 | 15.1 | 127 |
| M3e | pH | | | | | | R: 6.5 | | | | |
| | d50(μm) | | | | | | 3.78 | 4.18 | 4.28 | 18.4 | 119 |
| M3f | pH | | | | | | R: 5.5 | | | | |
| | d50(μm) | | | | | | 3.67 | 4.28 | 4.41 | 21.8 | 120 |
| M3g | pH | | | | | | R: 4.5 | | | | |
| | d50(μm) | | | | | | 3.87 | 4.19 | 4.43 | 22.8 | 121 |
| M3h | pH | | | | | | R: 3.5 | | | | |
| | d50(μm) | | | | | | 3.76 | 3.89 | 3.98 | 23.7 | 118 |
| M3i | pH | | | | | | R: 2.5 | | | | |
| | d50(μm) | | | | | | 3.57 | 3.67 | 3.78 | 41.2 | 120 |

When the pH value of the second resin particle dispersion was increased from 7.5 to 10.5, the particles were likely to be irregular in shape, and the volume-average particle size tended to be larger. At the pH of 11.8, the particles produced became coarser to the extent that the volume-average particle size was 12 μm or more.

As the pH value decreased, the adhesion of the second resin particles to the core particles was gradually difficult to proceed. When the second resin particle dispersion was dropped after adjusting the pH to 3.2, the second resin particles did not adhere easily to the core particles. Thus, the fusion of the second resin particles with the core particles took 5 hours or more. In this case, the coefficient of variation in volume was 32, and the particle size distribution was considerably broader. At the pH of 2.5, no second resin particle adhered to the core particles while the second resin particle dispersion was dropped. Therefore, only the second resin particles were aggregated, resulting in a considerably broader particle size distribution in which the coefficient of variation in volume was 40 or more. The dispersion remained white and cloudy.

Using Real Surface View Microscope (VE7800) manufactured by KEYENCE CORPORATION, the toner base (also referred to as colored particles) was magnified by 1000 times, and about 100 particles were taken to measure the circumference and the cross-sectional area. The shape factor (KC) was determined by the following formula.

KC(shape factor)=d²/(4π·A)×100

where d is a circumference of the toner base, and A is a cross-sectional area of the toner base.

(4) Preparation of Toner Base M4

In a 2000 ml four-neck flask equipped with a thermometer, a cooling tube, a stirring rod, and a pH meter were placed 204 g of the first resin particle dispersion RL1, 31 g of the colorant particle dispersion PM1, 40 g of the wax particle dispersion WA4, and 250 ml of ion-exchanged water, and then mixed for 10 minutes by using a homogenizer (Ultratalax T25 manufactured by IKA CO., LTD.). Thus, a mixed dispersion was prepared. The pH of the mixed dispersion was 3.8.

Then, the pH was increased to 11.9 by adding 1N NaOH to the mixed dispersion. Subsequently, the temperature was raised from 20° C. at a rate of 1° C./min. When the temperature reached 90° C., 220 g of magnesium sulfate aqueous solution (23 wt % concentration) was dropped continuously for a duration of 30 minutes. Thereafter, the mixture was heat-treated for 3 hours, thus forming core particles. The pH of the core particle dispersion was 9.3.

Moreover, the water temperature was kept at 90° C., and then 50 g of the second resin particle dispersion RH2 with an adjusted pH of 6.5 was added at a drop rate of 1 g/min. After completion of the dropping, this mixture was heat-treated at 90° C. for 2 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base M4d with a volume-average particle size of 3.8 μm and a coefficient of variation of 15.4.

Table 11 shows the initial pH of the mixed dispersion of the first resin particle dispersion, the colorant particle dispersion, and the wax particle dispersion; and changes in the temperature (° C.) inside the container and in the volume-average particle size (d50 (μm)) of the core particles growing in the liquid with time during the core particle formation process after the dropping of an aggregating agent into the mixed dispersion. Moreover, Table 11 shows changes in the temperature inside the container and in the volume-average particle size (d50 (μm)) of the core particles fused with the resin particles with time during the second resin particle fusion process (adhesion and melting) after the dropping of the second resin particle dispersion. Further, Table 11 shows the volume-average particle size and the shape factor of the core particles fused with the resin particles at 2 hours (h) after completion of the dropping of the second resin particle dispersion.

The “R: (figure)” in the column referred to as “at the time of completion of the dropping” of the second resin particle dispersion indicates the adjusted pH value of the second resin particle dispersion. M4a to M4i indicate the characteristic values corresponding to the adjusted pH values of 10.5, 9.5, 8.5, 7.5, 6.5, 5.5, and 4.5 of the second resin particle dispersion, respectively.

M4a to M4g were produced by way of trial under the same conditions as M4d, but differ only in the adjusted pH value of the second resin particle dispersion to be dropped. In the core particle formation processes of M4b to M4c and M4e to M4g, the pH and the temperature inside the container were the same, and the d50 value also was substantially the same for each. Therefore, they are omitted from Table 11.

TABLE 11

| | | Formation of core particles | | | | | Fusion of second resin particles | | | 2 h after | |
|---|---|---|---|---|---|---|---|---|---|---|---|
| | | | At the | 1 h | 2 h | 3 h | At the | | | completion of dropping | |
| Toner | Treat- | | time of | after | after | after | time of | 1 h after | 2 h after | Coefficient | |
| base | ment | After | reaching | reaching | reaching | reaching | completion | completion | completion | of variation | Shape |
| particles | time (h) | mixing | 90° C. | 90° C. | 90° C. | 90° C. | of dropping | of dropping | of dropping | in volume | factor |
| M4a | pH | 11.9 | | | | 9.3 | R: 10.5 | | | | |
| | Temper- | | 90° C. | 90° C. | 90° C. | 90° C. | 90° C. | 90° C. | 90° C. | | |
| | ature | | | | | | | | | | |
| | (° C.) | | | | | | | | | | |
| | d50(μm) | | 2 | 2.08 | 2.12 | 2.34 | 3.87 | 5.38 | 5.27 | 20.3 | 140 |
| M4b | pH | | | | | | R: 9.5 | | | | |
| | d50(μm) | | | | | | 3.47 | 4.68 | 4.78 | 17.8 | 135 |
| M4c | pH | | | | | | R: 8.5 | | | | |
| | d50(μm) | | | | | | 3.17 | 3.87 | 3.92 | 17.4 | 129 |
| M4d | pH | | | | | | R: 7.5 | | | | |
| | d50(μm) | | | | | | 3.07 | 3.78 | 3.81 | 15.4 | 121 |
| M4e | pH | | | | | | R: 6.5 | | | | |
| | d50(μm) | | | | | | 3.08 | 3.67 | 3.89 | 15.9 | 120 |
| M4f | pH | | | | | | R: 5.5 | | | | |
| | d50(μm) | | | | | | 3.12 | 3.78 | 3.98 | 16.7 | 118 |
| M4g | pH | | | | | | R: 4.5 | | | | |
| | d50(μm) | | | | | | 3.14 | 3.24 | 3.35 | 43.8 | 120 |

When the pH value of the second resin particle dispersion was increased from 8.5 to 10.5, the particles were likely to be irregular in shape, and the volume-average particle size tended to be larger. At the pH of 11, the particles produced became coarser to the extent that the volume-average particle size was 13 μm or more.

As the pH value decreased, the adhesion of the second resin particles to the core particles was gradually difficult to proceed. When the second resin particle dispersion was dropped after adjusting the pH to 3.2, the second resin particles did not adhere easily to the core particles. Thus, the fusion of the second resin particles with the core particles took 5 hours or more. This led to a considerably broader particle size distribution in which the coefficient of variation in volume was 40 or more. The dispersion remained white and cloudy.

(5) Preparation of Toner Base M5

In a 2000 ml four-neck flask equipped with a thermometer, a cooling tube, a stirring rod, and a pH meter were placed 204 g of the first resin particle dispersion RL2, 42 g of the colorant particle dispersion PM1, 90 g of the wax particle dispersion WA5, and 160 ml of ion-exchanged water, and then mixed for 10 minutes by using a homogenizer (Ultratalax T50 manufactured by IKA CO., LTD.). Thus, a mixed dispersion was prepared. The pH of the mixed dispersion was 2.2.

Then, the pH was increased to 9.7 by adding 1N NaOH to the mixed dispersion. Subsequently, the temperature was raised from 20° C. at a rate of 1° C./min. When the temperature reached 70° C., 520 g of magnesium sulfate aqueous solution (23 wt % concentration) was dropped continuously for a duration of 110 minutes and heat-treated for 1 hour. Thereafter, the temperature was raised to 90° C., and the mixture was heat-treated for 3 hours, thus forming core particles. The pH of the core particle dispersion was 7.

Moreover, the water temperature was kept at 90° C., and then 145 g of the second resin particle dispersion RH1 with an adjusted pH of 5 was added at a drop rate of 10 g/min. After completion of the dropping, this mixture was heat-treated at 90° C. for 1.5 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base M5f with a volume-average particle size of 6.3 μm and a coefficient of variation of 16.1.

Table 12 shows the initial pH of the mixed dispersion of the first resin particle dispersion, the colorant particle dispersion, and the wax particle dispersion, and changes in the temperature (° C.) inside the container and in the volume-average particle size (d50 (μm)) of the core particles growing in the liquid with time during the core particle formation process after the dropping of an aggregating agent into the mixed dispersion. Moreover, Table 12 shows changes in the temperature inside the container and in the volume-average particle size (d50 (μm)) of the core particles fused with the resin particles with time during the second resin particle fusion process (adhesion and melting) after the dropping of the second resin particle dispersion. Further, Table 12 shows the volume-average particle size and the shape factor of the core particles fused with the resin particles at 2 hours (h) after completion of the dropping of the second resin particle dispersion.

The “R: (figure)” in the column referred to as “at the time of completion of the dropping” of the second resin particle dispersion indicates the adjusted pH value of the second resin particle dispersion. M5a to M5h indicate the characteristic values corresponding to the adjusted pH values of 10, 9, 8, 7, 6, 5, 4, and 3.5 of the second resin particle dispersion, respectively.

M5a to M5h were produced by way of trial under the same conditions as M5d, but differ only in the adjusted pH value of the second resin particle dispersion to be dropped. In the core particle formation processes of M5b to M5e and M5g to M5h, the pH and the temperature inside the container were the same, and the d50 value also was substantially the same for each. Therefore, they are omitted from Table 12.

TABLE 12

| | | Formation of core particles | | | | | Fusion of second resin particles | | | 1.5 h after | |
|---|---|---|---|---|---|---|---|---|---|---|---|
| | | | At the | 1 h | 2 h | 3 h | At the | | | completion of dropping | |
| Toner | Treat- | | time of | after | after | after | time of | 1 h after | 1.5 h after | Coefficient | |
| base | ment | After | reaching | reaching | reaching | reaching | completion | completion | completion | of variation | Shape |
| particles | time (h) | mixing | 90° C. | 90° C. | 90° C. | 90° C. | of dropping | of dropping | of dropping | in volume | factor |
| M5a | pH | 9.6 | | | | 7 | R: 10 | | | | |
| | Temper- | | 90° C. | 90° C. | 90° C. | 90° C. | 90° C. | 90° C. | 90° C. | | |
| | ature | | | | | | | | | | |
| | (° C.) | | | | | | | | | | |
| | d50(μm) | | 4.08 | 4.23 | 4.34 | 4.78 | 6.04 | 6.48 | 6.89 | 21.1 | 139 |
| M5b | pH | | | | | | R: 9 | | | | |
| | d50(μm) | | | | | | 6.01 | 6.37 | 6.48 | 17.8 | 134 |
| M5c | pH | | | | | | R: 8 | | | | |
| | d50(μm) | | | | | | 5.87 | 6.31 | 3.41 | 16.5 | 131 |
| M5d | pH | | | | | | R: 7 | | | | |
| | d50(μm) | | | | | | 5.78 | 6.28 | 6.38 | 16.4 | 131 |
| M5e | pH | | | | | | R: 6 | | | | |
| | d50(μm) | | | | | | 5.87 | 6.18 | 6.32 | 16.1 | 124 |
| M5f | pH | | | | | | R: 5 | | | | |
| | d50(μm) | | | | | | 5.74 | 6.21 | 6.24 | 17.1 | 121 |
| M5g | pH | | | | | | R: 4 | | | | |
| | d50(μm) | | | | | | 5.64 | 5.98 | 6.24 | 17.8 | 118 |
| M5h | pH | | | | | | R: 3.5 | | | | |
| | d50(μm) | | | | | | 4.71 | 4.78 | 4.97 | 42.8 | 119 |

When the pH value of the second resin particle dispersion was increased from 6 to 9, the particles were likely be irregular in shape, and the volume-average particle size tended to be larger. At the pH of 11.3, the particles produced became coarser to the extent that the volume-average particle size was 12 μm or more.

As the pH value decreased, the adhesion of the second resin particles to the core particles gradually became more difficult. When the second resin particle dispersion was dropped after adjusting the pH to 3, the second resin particles did not adhere easily to the core particles. Thus, the fusion of the second resin particles with the core particles took 5 hours or more. This led to a considerably broader particle size distribution in which the coefficient of variation in volume was 30 or more. At the pH of 2.5, no second resin particle adhered to the core particles while the second resin particle dispersion was dropped. The dispersion remained white and cloudy.

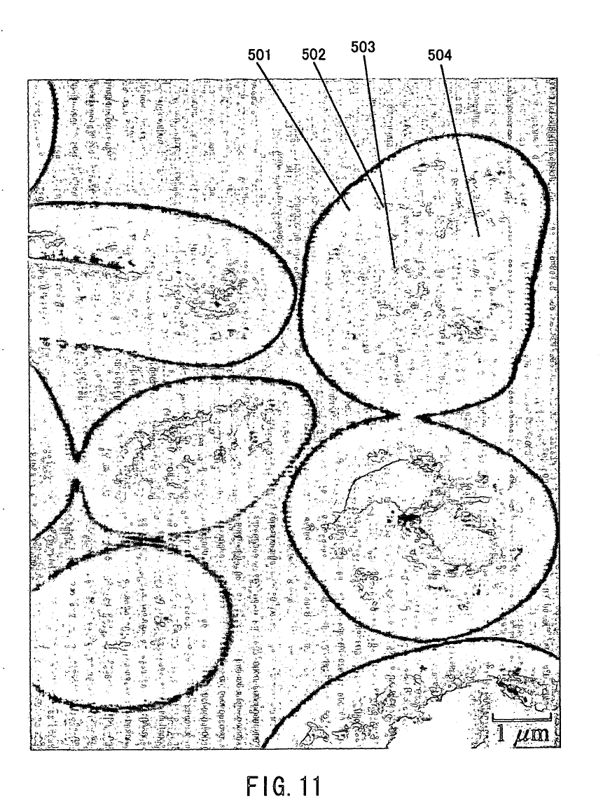

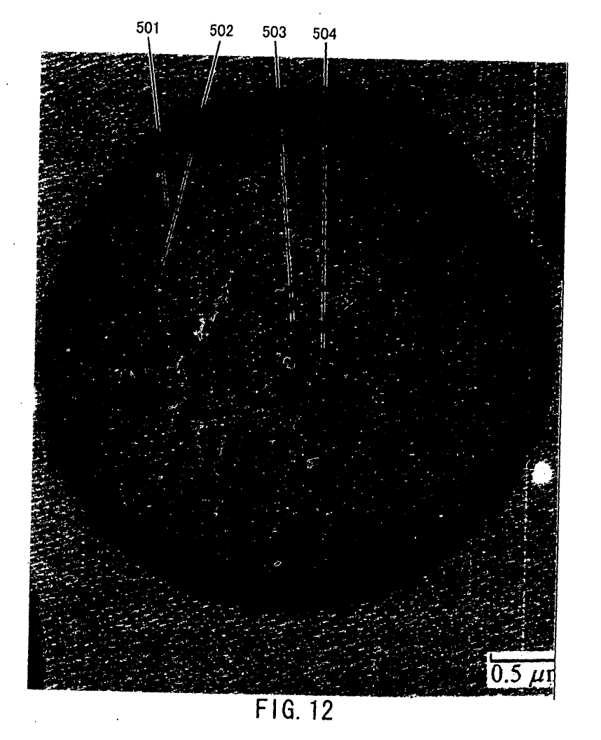

FIG. 11 shows a TEM (transmission electron microscope) cross-sectional image of the toner base particles M5f (magnification: 20000×). In FIG. 11, as with the toner bases M1 and M2, it can be seen that the second resin particles form a shell resin fused layer 501 with a thickness of about 0.5 as an outer shell. Moreover, each of the toner base particles is formed so that black particles 502, which are considered as a pigment, the first resin particles 504, and the wax are melted, mixed, and dispersed inside the toner base particle. The white particles 503 appear to be the wax. However, it seems that many wax particles and the resin dissolve in each other, and such wax cannot be identified in this TEM image. In any event, the wax of this configuration is not present like islands (e.g., domains that are several microns in size), but may be characterized by its mixed and dispersed state with the pigment and the resin. This may contribute to achieving the fixability, the offset resistance, and the storage stability. FIG. 12 shows a magnified TEM image (magnification: 50000×).

(6) Preparation of Toner Base M6

In a 2000 ml four-neck flask equipped with a thermometer, a cooling tube, a stirring rod, and a pH meter were placed 204 g of the first resin particle dispersion RL2, 42 g of the colorant particle dispersion PM1, 50 g of the wax particle dispersion WA6, and 340 ml of ion-exchanged water, and then mixed for 10 minutes by using a homogenizer (Ultratalax T50 manufactured by TKA CO., LTD.). Thus, a mixed dispersion was prepared. The pH of the mixed dispersion was 3.8.

Then, the pH was increased to 11.8 by adding 1N NaOH to the mixed dispersion, and this was stirred for 10 minutes. Subsequently, the temperature was raised from 20° C. at a rate of 1° C./min. When the temperature reached 80° C., 310 g of magnesium sulfate aqueous solution (23 wt % concentration) was dropped continuously for a duration of 40 minutes and heat-treated for 1 hour. Thereafter, the temperature was raised to 90° C., and the mixture was heat-treated for 2.5 hours, thus forming core particles. The pH of the core particle dispersion was 9.2.

Moreover, the water temperature was kept at 90° C., and then 145 g of the second resin particle dispersion RH1 with an adjusted pH of 5 was added at a drop rate of 5 g/min. After completion of the dropping, this mixture was heat-treated at 95° C. for 1.5 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base M6 with a volume-average particle size of 4.0 μm and a coefficient of variation of 15.9.

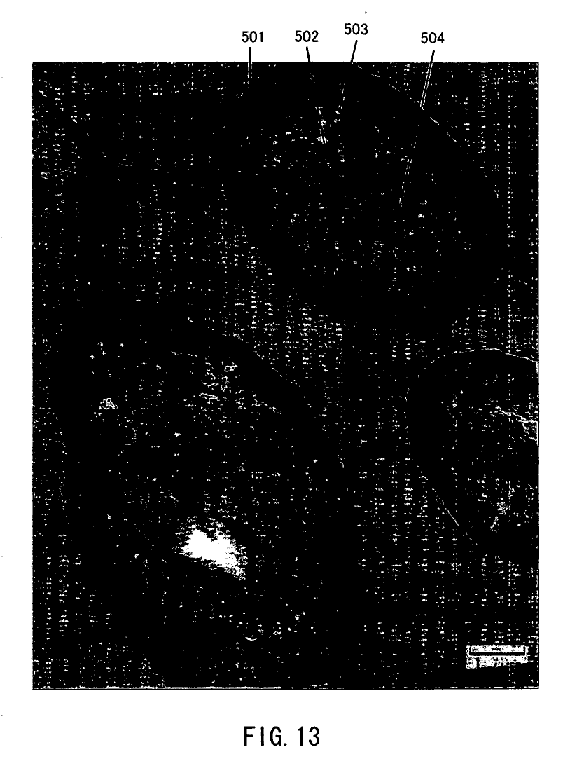

FIG. 13 shows a TEM (transmission electron microscope) cross-sectional image of the toner base particles M6 (magnification: 20000×). In FIG. 13, as with the toner bases M1 and M2, it can be seen that the second resin particles form a shell resin fused layer 501 with a thickness of about 0.5 μm as an outer shell. Moreover, each of the toner base particles is formed so that black particles 502, which are considered as a pigment, the first resin particles 504, and the wax are melted, mixed, and dispersed inside the toner base particle. The white particles 503 appear to be the wax. However, it seems that many wax particles and the resin dissolve in each other, and such wax cannot be identified in this TEM image. In any event, the wax of this configuration is not present like islands (e.g., domains that are several microns in size), but may be characterized by its mixed and dispersed state with the pigment and the resin. This may contribute to achieving the fixability, the offset resistance, and the storage stability.

(7) Preparation of Toner Base M7

In a 2000 ml four-neck flask equipped with a thermometer, a cooling tube, a stirring rod, and a pH meter were placed 204 g of the first resin particle dispersion RL2, 42 g of the colorant particle dispersion PM1, 50 g of the wax particle dispersion WA7, and 360 ml of ion-exchanged water, and then mixed for 10 minutes by using a homogenizer (Ultratalax T50 manufactured by IKA CO., LTD.). Thus, a mixed dispersion was prepared. The pH of the mixed dispersion was 2.9.

Then, the pH was increased to 11.7 by adding 1N NaOH to the mixed dispersion, and this was stirred for 10 minutes. Subsequently, the temperature was raised from 20° C. at a rate of 1° C./min. When the temperature reached 90° C., 280 g of magnesium sulfate aqueous solution (23 wt % concentration) was dropped continuously for a duration of 5 minutes. Thereafter, the mixture was heat-treated for 3 hours, thus forming core particles. The pH of the core particle dispersion was 9.2.

Moreover, the water temperature was kept at 90° C., and then 145 g of the second resin particle dispersion RH1 with an adjusted pH of 5 was added at a drop rate of 5 g/min. After completion of the dropping, this mixture was heat-treated at 95° C. for 1.5 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base M7 with a volume-average particle size of 4.2 μm and a coefficient of variation of 16.8.

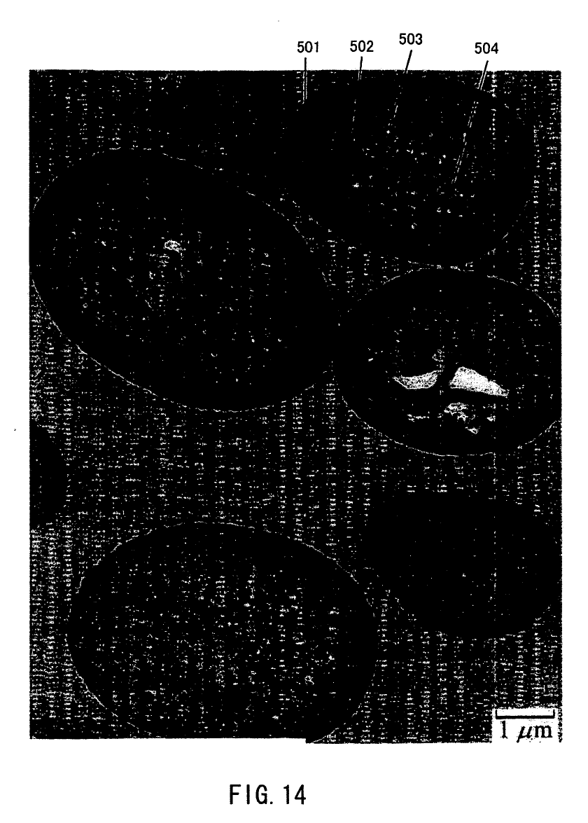

FIG. 14 shows a TEM (transmission electron microscope) cross-sectional image of the toner base particles M7 (magnification: 20000×). In FIG. 14, as with the toner bases M1 and M2, it can be seen that the second resin particles form a shell resin fused layer 501 with a thickness of about 0.5 μm as an outer shell. Moreover, each of the toner base particles is formed so that black particles 502, which are considered as a pigment, the first resin particles 504, and the wax are melted, mixed, and dispersed inside the toner base particle. The white particles 503 appear to be the wax. However, it seems that many wax particles and the resin dissolve in each other, and such wax cannot be identified in this TEM image. In any event, the wax of this configuration is not present like islands (e.g., domains that are several microns in size), but may be characterized by its mixed and dispersed state with the pigment and the resin. This may contribute to achieving the fixability, the offset resistance, and the storage stability.

(8) Preparation of Toner Base M8

In a 2000 ml four-neck flask equipped with a thermometer, a cooling tube, a stirring rod, and a pH meter were placed 204 g of the first resin particle dispersion RL2, 32 g of the colorant particle dispersion PM1, 60 g of the wax particle dispersion WA8, and 130 ml of ion-exchanged water, and then mixed for 10 minutes by using a homogenizer (Ultratalax T25 manufactured by IKA CO., LTD.). Thus, a mixed dispersion was prepared. The pH of the mixed dispersion was 1.8.

Then, the pH was increased to 9.7 by adding 1N NaOH to the mixed dispersion, and this was stirred for 10 minutes. Subsequently, the temperature was raised from 20° C. at a rate of 1° C./min When the temperature reached 90° C., 380 g of magnesium sulfate aqueous solution (23 wt % concentration) was dropped continuously for a duration of 20 minutes. Thereafter, the mixture was heat-treated for 3 hours, thus forming core particles. The pH of the core particle dispersion was 7.2.

Moreover, the water temperature was kept at 90° C., and then 60 g of the second resin particle dispersion RH2 with an adjusted pH of 4.5 was added at a drop rate of 10 g/min. After completion of the dropping, this mixture was heat-treated at 95° C. for 2 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base M8 with a volume-average particle size of 5.9 μm and a coefficient of variation of 16.1.

(9) Preparation of Toner Base M9

In a 2000 ml four-neck flask equipped with a thermometer, a cooling tube, a stirring rod, and a pH meter were placed 204 g of the first resin particle dispersion RL2, 42 g of the colorant particle dispersion PM2, 50 g of the wax particle dispersion WA7, and 360 ml of ion-exchanged water, and then mixed for 10 minutes by using a homogenizer (Ultratalax T50 manufactured by IKA CO., LTD.). Thus, a mixed dispersion was prepared. The pH of the mixed dispersion was 2.6.

Then, the pH was increased to 11.7 by adding 1N NaOH to the mixed dispersion, and this was stirred for 10 minutes. Subsequently, the temperature was raised from 20° C. at a rate of 1° C./min. When the temperature reached 90° C., 282 g of magnesium sulfate aqueous solution (23 wt % concentration) was dropped continuously for a duration of 10 minutes. Thereafter, the mixture was heat-treated for 3 hours, thus forming core particles. The pH of the core particle dispersion was 9.2.

Moreover, the water temperature was kept at 90° C., and then 145 g of the second resin particle dispersion RH1 with an adjusted pH of 5 was added at a drop rate of 5 g/min. After completion of the dropping, this mixture was heat-treated at 95° C. for 1.5 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base M9 with a volume-average particle size of 4.3 μm and a coefficient of variation of 19.1.

(10) Preparation of Toner Base M10

In a 2000 ml four-neck flask equipped with a thermometer, a cooling tube, a stirring rod, and a pH meter were placed 204 g of the first resin particle dispersion RL1, 31 g of the colorant particle dispersion PM1, 40 g of the wax particle dispersion WA4, and 250 ml of ion-exchanged water, and then mixed for 10 minutes by using a homogenizer (Ultratalax T25 manufactured by IKA CO., LTD.). Thus, a mixed dispersion was prepared. The pH of the mixed dispersion was 3.8.

Then, the pH was increased to 11.9 by adding 1N NaOH to the mixed dispersion, and this was stirred for 10 minutes. Subsequently, the temperature was raised from 20° C. at a rate of 1° C./min. When the temperature reached 90° C. (the pH value of the mixed dispersion was 10.4), 220 g of magnesium sulfate aqueous solution (23 wt % concentration) whose pH value was adjusted to 7.2 was dropped continuously for a duration of 30 minutes. Thereafter, the mixture was heat-treated for 3 hours, thus forming core particles. The pH of the core particle dispersion was 9.3.

Moreover, the water temperature was kept at 90° C., and then 50 g of the second resin particle dispersion RH2 with an adjusted pH of 6.5 was added at a drop rate of 1 g/min. After completion of the dropping, this mixture was heat-treated at 90° C. for 2 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base M10 with a volume-average particle size of 3.8 μm and a coefficient of variation of 15.4.

(11) Preparation of Toner Base M11

In a 2000 ml four-neck flask equipped with a thermometer, a cooling tube, a stirring rod, and a pH meter were placed 204 g of the first resin particle dispersion RL2, 32 g of the colorant particle dispersion PM1, 60 g of the wax particle dispersion WA8, and 130 ml of ion-exchanged water, and then mixed for 10 minutes by using a homogenizer (Ultratalax T25 manufactured by IKA CO., LTD). Thus, a mixed dispersion was prepared. The pH of the mixed dispersion was 1.8.

Then, the pH was increased to 9.7 by adding 1N NaOH to the mixed dispersion, and this was stirred for 10 minutes. Subsequently, the temperature was raised from 20° C. at a rate of 1° C./min. When the temperature reached 90° C. (the pH value of the mixed dispersion was 8.4), 380 g of magnesium sulfate aqueous solution (23 wt % concentration) whose pH value was adjusted to 10.2 was dropped continuously for a duration of 20 minutes. Thereafter, the mixture was heat-treated for 3 hours, thus forming core particles. The pH of the core particle dispersion was 7.8.

Moreover, the water temperature was kept at 90° C., and then 60 g of the second resin particle dispersion RH2 with an adjusted pH of 4.5 was added at a drop rate of 10 g/min. After completion of the dropping, this mixture was heat-treated at 95° C. for 2 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base M11 with a volume-average particle size of 5.9 μm and a coefficient of variation of 16.1.

(12) Preparation of Toner Base M12

In a 2000 ml four-neck flask equipped with a thermometer, a cooling tube, a stirring rod, and a pH meter were placed 204 g of the first resin particle dispersion RL2, 42 g of the colorant particle dispersion PB2, 90 g of the wax particle dispersion WA5, and 160 ml of ion-exchanged water, and then mixed for 10 minutes by using a homogenizer (Ultratalax T50 manufactured by IRA CO., LTD.). Thus, a mixed dispersion was prepared. The pH of the mixed dispersion was 2.2.

Then, the pH was increased to 9.7 by adding 1N NaOH to the mixed dispersion, and this was stirred for 10 minutes. Subsequently, the temperature was raised from 15° C. at a rate of about 0.5° C./min. When the temperature reached 90° C., 520 g of magnesium sulfate aqueous solution (23 wt % concentration) was dropped continuously for a duration of 30 minutes. Thereafter, the mixture was heat-treated for 1.75 hours, thus forming core particles. The pH of the core particle dispersion was 7.

Moreover, the water temperature was kept at 90° C., and then 145 g of the second resin particle dispersion RH1 with an adjusted pH of 5 was added at a drop rate of 10 g/min. After completion of the dropping, this mixture was heat-treated at 90° C. for 1.5 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base M12 with a volume-average particle size of 7.1 μm and a coefficient of variation of 17.1.

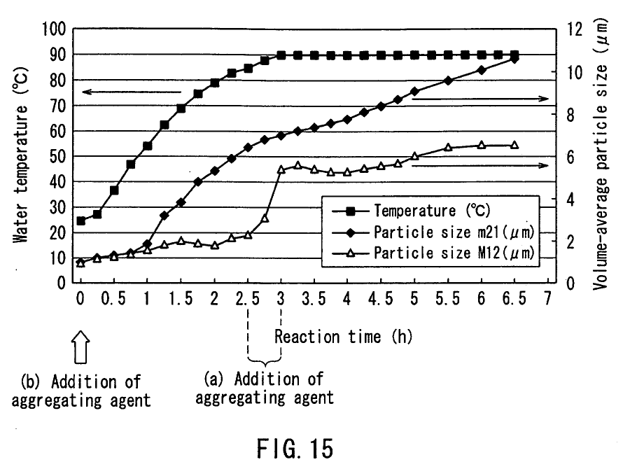

The particle size transition in this example is shown in FIG. 15. In FIG. 15, the elapsed time (h) of the reaction is plotted on the horizontal axis, the water temperature (° C.) is plotted on the right vertical axis, and the particle size (μm) is plotted on the left vertical axis. A black square (▪) mark represents the liquid temperature. An open triangle (Δ) mark represents the transition of the toner base M12. The magnesium sulfate aqueous solution (aggregating agent) was dropped starting at a reaction time of 2.5 h for 30 minutes (a). The particles were hardly aggregated before dropping the magnesium sulfate aqueous solution, and particles with a size of about 5 μm were formed upon completion of the dropping. At this time, the reaction liquid was already transparent, and the carbon black, the wax, and the resin particles were formed into the aggregated particles. Moreover, the second resin particle dispersion was dropped continuously, and then heat-treated for 1.5 hours, so that the toner base M12 was produced.

(13) Preparation of Toner Base m21

In a 2000 ml four-neck flask equipped with a thermometer and a cooling tube were placed 204 g of the first resin particle dispersion RL2, 45 g of the colorant particle dispersion PB1, 50 g of the wax particle dispersion WA6, and 0.420 ml of ion-exchanged water, and then mixed for 10 minutes by using a homogenizer (Ultratalax T25 manufactured by IKA CO., LTD.). Thus, a mixed dispersion was prepared. The pH of the mixed dispersion was 3.9.

Then, the pH was increased to 9.7 by adding 1N NaOH to the mixed dispersion. Subsequently, 260 g of magnesium sulfate aqueous solution (23 wt % concentration) was added collectively and stirred for 10 minutes. Then, the temperature was raised from 15° C. to 90° C. at a rate of 0.5° C./min. The aggregation of the particles proceeded during temperature rise. Thereafter, the mixture was heat-treated for 2 hours, thus forming core particles. The pH of the core particle dispersion was 7.

Moreover, the water temperature was kept at 90° C., and then 165 g of the second resin particle dispersion rh3 was added at a drop rate of 5.5 g/min. After completion of the dropping, this mixture was heat-treated at 90° C. for 1.5 hours, thereby providing particles fused with the second resin particles. In this reaction, the particle size tended to grow larger, and a toner base m21 with a volume-average particle size of 10.8 μm and a coefficient of variation of 29.8 was produced. In the toner base m21, the particle size distribution became broader.

FIG. 15 shows the particle size transition. A black diamond (♦) mark represents the transition of the toner base m21. After the aggregating agent was dropped (b), the particle size was increased gradually with temperature rise, and continued to grow larger even after the dropping of the second resin particle dispersion.

(14) Preparation of Toner Base m22

In a 2000 ml four-neck flask equipped with a thermometer, a cooling tube, a stirring rod, and a pH meter were placed 204 g of the first resin particle dispersion RL2, 45 g of the colorant particle dispersion PM1, 50 g of the wax particle dispersion wa9, and 390 ml of ion-exchanged water, and then mixed for 10 minutes by using a homogenizer (Ultratalax T25 manufactured by IKA CO., LTD.). Thus, a mixed dispersion was prepared. The pH of the mixed dispersion was 1.8.

Then, the pH was increased to 9.7 by adding 1N NaOH to the mixed dispersion. Subsequently, the temperature was raised from 20° C. at a rate of about 1° C./min. When the temperature reached 90° C., 280 g of magnesium sulfate aqueous solution (23 wt % concentration) was dropped collectively. Thereafter, the mixture was heat-treated for 3 hours, thus forming core particles. The pH of the core particle dispersion was 7.2.

Moreover, the water temperature was kept at 90° C., and then 165 g of the second resin particle dispersion RH2 with an adjusted pH of 4 was added at a drop rate of 5 g/min. After completion of the dropping, this mixture was heat-treated at 90° C. for 1.5 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base m22 with a volume-average particle size of 6.8 μm and a coefficient of variation of 25.81.

(15) Preparation of Toner Base m23

In a 2000 ml four-neck flask equipped with a thermometer, a cooling tube, a stirring rod, and a pH meter were placed 204 g of the first resin particle dispersion RL1, 42 g of the colorant particle dispersion PM1, 65 g of the wax particle dispersion wa11, and 350 ml of ion-exchanged water, and then mixed for 10 minutes by using a homogenizer (Ultratalax T50 manufactured by IKA CO., LTD.). Thus, a mixed dispersion was prepared. The pH of the mixed dispersion was 2.3.

Then, the pH was increased to 11.8 by adding 1N NaOH to the mixed dispersion, and this was stirred for 10 minutes. Subsequently, the temperature was raised from 20° C. at a rate of about 1° C./min. When the temperature reached 90° C., 320 g of magnesium sulfate aqueous solution (23 wt % concentration) was dropped continuously for a duration of 150 minutes. Thereafter, the mixture was heat-treated for 3 hours, thus forming core particles. The pH of the core particle dispersion was 9.2.

Moreover, the water temperature was kept at 90° C., and then 145 g of the second resin particle dispersion RH1 with an adjusted pH of 5 was added at a drop rate of 5 g/min. After completion of the dropping, this mixture was heat-treated at 95° C. for 2 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base m23 with a volume-average particle size of 5.9 μm and a coefficient of variation of 25.9.

(16) Preparation of Toner Base m24

In a 2000 ml four-neck flask equipped with a thermometer, a cooling tube, a stirring rod, and a pH meter were placed 204 g of the first resin particle dispersion RL2, 42 g of the colorant particle dispersion PM1, 50 g of the wax particle dispersion WA7, and 320 ml of ion-exchanged water, and then mixed for 10 minutes by using a homogenizer (Ultratalax T50 manufactured by IKA CO., LTD.). Thus, a mixed dispersion was prepared. The pH of the mixed dispersion was 2.9.

Then, the pH was increased to 11.7 by adding 1N NaOH to the mixed dispersion. Subsequently, the temperature was raised from 20° C. at a rate of about 1° C./min. When the temperature reached 55° C., 320 g of magnesium sulfate aqueous solution (23 wt % concentration) was added and stirred for 2 hours. However, no aggregated particle was formed, and the liquid remained cloudy. Thereafter, the temperature was raised further to 90° C., and the mixture was heat-treated for 4 hours, thus forming core particles. The pH of the core particle dispersion was 9.2. The liquid was not completely transparent.

Moreover, the water temperature was kept at 90° C., and then 145 g of the second resin particle dispersion RH1 with an adjusted pH of 5 was added at a drop rate of 5 g/min. After completion of the dropping, this mixture was heat-treated at 95° C. for 1.5 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base m24 with a volume-average particle size of 4.5 μm and a coefficient of variation of 26.2.

(17) Preparation of Toner Base m25

In a 2000 ml four-neck flask equipped with a thermometer, a cooling tube, a stirring rod, and a pH meter were placed 204 g of the first resin particle dispersion RL1, 31 g of the colorant particle dispersion PM1, 40 g of the wax particle dispersion WA3, and 220 ml of ion-exchanged water, and then mixed for 10 minutes by using a homogenizer (Ultratalax T25 manufactured by IKA CO., LTD.). Thus, a mixed dispersion was prepared. The pH of the mixed dispersion was 3.8.

Then, the pH was increased to 11.1 by adding 1N NaOH to the mixed dispersion, and this was stirred for 10 minutes. Subsequently, the temperature was raised from 20° C. at a rate of about 1° C./min. When the temperature reached 70° C., 260 g of magnesium sulfate aqueous solution (23 wt % concentration) was added and stirred for 2 hours. However, no aggregated particle was formed, and the liquid remained cloudy. Thereafter, the temperature was raised further to 95° C., and the mixture was heat-treated for 3 hours, thus forming core particles. The pH of the core particle dispersion was 7.2. The liquid was not completely transparent.

Moreover, the water temperature was kept at 95° C., and then 50 g of the second resin particle dispersion RH2 with an adjusted pH of 7 was added at a drop rate of 1 g/min. After completion of the dropping, this mixture was heat-treated at 95° C. for 2 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base m25 with a volume-average particle size of 6.2 μm and a coefficient of variation of 27.1

(18) Preparation of Toner Base m26

In a 2000 ml four-neck flask equipped with a thermometer, a cooling tube, a stirring rod, and a pH meter were placed 204 g of the first resin particle dispersion RL1, 31 g of the colorant particle dispersion PM1, 40 g of the wax particle dispersion wa13, and 240 ml of ion-exchanged water, and then mixed for 10 minutes by using a homogenizer (Ultratalax T25 manufactured by IKA CO., LTD.). Thus, a mixed dispersion was prepared. The pH of the mixed dispersion was 2.8.

Then, the pH was increased to 11.7 by adding 1N NaOH to the mixed dispersion. Subsequently, 240 g of magnesium sulfate aqueous solution (23 wt % concentration) was added and stirred for 10 minutes. After the temperature was raised from 20° C. to 90° C. at a rate of 1° C./min, the mixture was heat-treated for 3 hours, thus forming core particles. The pH of the core particle dispersion was 9.1.

Moreover, the water temperature was kept at 90° C., and then 50 g of the second resin particle dispersion RH2 with an adjusted pH of 6.5 was added at a drop rate of 1 g/min. After completion of the dropping, this mixture was heat-treated at 95° C. for 2 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base m26 with a volume-average particle size of 7.4 μm and a coefficient of variation of 26.8. In the toner base m26, the particle size distribution became slightly broader.

(19) Preparation of Toner Base m27

In a 2000 ml four-neck flask equipped with a thermometer, a cooling tube, a stirring rod, and a pH meter were placed 204 g of the first resin particle dispersion RL2, 42 g of the colorant particle dispersion PM1, 50 g of the wax particle dispersion wa14, and 330 ml of ion-exchanged water, and then mixed for 10 minutes by using a homogenizer (Ultratalax T50 manufactured by IKA CO., LTD.). Thus, a mixed dispersion was prepared. The pH of the mixed dispersion was 2.8.

Then, the pH was increased to 11.8 by adding 1N NaOH to the mixed dispersion. Subsequently, 310 g of magnesium sulfate aqueous solution (23 wt % concentration) was added collectively and stirred for 10 minutes. After the temperature was raised from 20° C. to 90° C. at a rate of 1° C./min, the mixture was heat-treated for 3 hours, thus forming core particles. The pH of the core particle dispersion was 9.2.

Moreover, the water temperature was kept at 90° C., and then 145 g of the second resin particle dispersion RH1 with an adjusted pH of 5 was added at a drop rate of 5 g/min. After completion of the dropping, this mixture was heat-treated at 95° C. for 1.5 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base m27 with a volume-average particle size of 8.4 μm and a coefficient of variation of 27.9. In the toner base m27, the particle size distribution became slightly broader, and part of the aqueous medium remained white and cloudy.

(20) Preparation of Toner Base m28

In a 2000 ml four-neck flask equipped with a thermometer, a cooling tube, a stirring rod, and a pH meter were placed 204 g of the first resin particle dispersion RL2, 42 g of the colorant particle dispersion PM1, 50 g of the wax particle dispersion wa15, and 390 ml of ion-exchanged water, and then mixed for 10 minutes by using a homogenizer (Ultratalax T50 manufactured by IKA CO., LTD.). Thus, a mixed dispersion was prepared. The pH of the mixed dispersion was 3.8.

Then, the pH was increased to 11.8 by adding 1N NaOH to the mixed dispersion. Subsequently, 260 g of magnesium sulfate aqueous solution (23 wt % concentration) was added collectively and stirred for 10 minutes. After the temperature was raised from 20° C. to 90° C. at a rate of 1° C./min, the mixture was heat-treated for 3 hours, thus forming core particles. The pH of the core particle dispersion was 9.2.

Moreover, the water temperature was kept at 90° C., and then 145 g of the second resin particle dispersion RH1 with an adjusted pH of 5 was added at a drop rate of 5 g/min. After completion of the dropping, this mixture was heat-treated at 95° C. for 1.5 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base m28 with a volume-average particle size of 10.9 μm and a coefficient of variation of 31.8. In the toner base m28, the particle size distribution became broader, and part of the aqueous medium remained white and cloudy.

(21) Preparation of Toner Base m29

In a 2000 ml four-neck flask equipped with a thermometer and a cooling tube were placed 204 g of the first resin particle dispersion rl4, 45 g of the colorant particle dispersion PM1, 50 g of the wax particle dispersion WA6, and 420 ml of ion-exchanged water, and then mixed for 10 minutes by using a homogenizer (Ultratalax T25 manufactured by IKA CO., LTD.). Thus, a mixed dispersion was prepared. The pH of the mixed dispersion was 3.9.

Then, the pH was increased to 9.7 by adding 1N NaOH to the mixed dispersion. Subsequently, 260 g of magnesium sulfate aqueous solution (23 wt % concentration) was added collectively and stirred for 10 minutes. After the temperature was raised from 20° C. to 90° C. at a rate of 1° C./min, the mixture was heat-treated for 3 hours, thus forming core particles. The pH of the core particle dispersion was 7.

Moreover, the water temperature was kept at 90° C., and then 165 g of the second resin particle dispersion rh3 with an adjusted pH of 6.5 was added at a drop rate of 5 g/min. After completion of the dropping, this mixture was heat-treated at 90° C. for 2 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base m29 with a volume-average particle size of 15.3 μm and a coefficient of variation of 32.5. In the toner base m29, the particle size distribution became broader.

(22) Preparation of Toner Base m30

In a 2000 ml four-neck flask equipped with a thermometer and a cooling tube were placed 204 g of the first resin particle dispersion rl5, 34 g of the colorant particle dispersion PM1, 40 g of the wax particle dispersion WA7, and 300 ml of ion-exchanged water, and then mixed for 10 minutes by using a homogenizer (Ultratalax T25 manufactured by IKA CO., LTD.). Thus, a mixed dispersion was prepared. The pH of the mixed dispersion was 4.1.

Then, the pH was increased to 11.4 by adding 1N NaOH to the mixed dispersion. Subsequently, 220 g of magnesium sulfate aqueous solution (23 wt % concentration) was added collectively and stirred for 10 minutes. After the temperature was raised from 20° C. to 90° C. at a rate of 1° C./min, the mixture was heat-treated for 3 hours, thus forming core particles. The pH of the core particle dispersion was 9.1.

Moreover, the water temperature was kept at 90° C., and then 75 g of the second resin particle dispersion rh4 with an adjusted pH of 7.0 was added at a drop rate of 1 g/min. After completion of the dropping, this mixture was heat-treated at 95° C. for 2 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base m30 with a volume-average particle size of 4.9 μm and a coefficient of variation of 37.6. In the toner base m30, the particle size distribution became broader.

(23) Preparation of Toner Base m31

In a 2000 ml four-neck flask equipped with a thermometer, a cooling tube, a stirring rod, and a pH meter were placed 204 g of the first resin particle dispersion RL2, 42 g of the colorant particle dispersion pm3, 50 g of the wax particle dispersion WA7, and 400 ml of ion-exchanged water, and then mixed for 10 minutes by using a homogenizer (Ultratalax T50 manufactured by IKA CO., LTD.). Thus, a mixed dispersion was prepared. The pH of the mixed dispersion was 3.2.

Then, the pH was increased to 11.7 by adding 1N NaOH to the mixed dispersion. Subsequently, 240 g of magnesium sulfate aqueous solution (23 wt % concentration) was added collectively and stirred for 10 minutes. After the temperature was raised from 20° C. to 90° C. at a rate of 1° C./min, the mixture was heat-treated for 3 hours, thus forming core particles. The pH of the core particle dispersion was 9.2.

Moreover, the water temperature was kept at 90° C., and then 145 g of the second resin particle dispersion RH1 with an adjusted pH of 5 was added at a drop rate of 5 g/min. After completion of the dropping, this mixture was heat-treated at 95° C. for 1.5 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base m31 with a volume-average particle size of 8.2 μm and a coefficient of variation of 26.8. In the toner base m31, the particle size distribution became slightly broader.

(24) Preparation of Toner Base m32

In a 2000 ml four-neck flask equipped with a thermometer, a cooling tube, a stirring rod, and a pH meter were placed 204 g of the first resin particle dispersion RL2, 42 g of the colorant particle dispersion pm4, 50 g of the wax particle dispersion WA7, and 350 ml of ion-exchanged water, and then mixed for 10 minutes by using a homogenizer (Ultratalax T50 manufactured by IKA CO., LTD.). Thus, a mixed dispersion was prepared. The pH of the mixed dispersion was 3.2.

Then, the pH was increased to 11.7 by adding 1N NaOH to the mixed dispersion. Subsequently, 300 g of magnesium sulfate aqueous solution (23 wt % concentration) was added collectively and stirred for 10 minutes. After the temperature was raised from 20° C. to 90° C. at a rate of 1° C./min, the mixture was heat-treated for 3 hours, thus forming core particles. The pH of the core particle dispersion was 9.2.

Moreover, the water temperature was kept at 90° C., and then 145 g of the second resin particle dispersion RH1 with an adjusted pH of 5 was added at a drop rate of 5 g/min. After completion of the dropping, this mixture was heat-treated at 95° C. for 1.5 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, resulting in a toner base m32 with a volume-average particle size of 11.4 μm and a coefficient of variation of 33.9. In the toner base m32, the particle size distribution became broader.

(6) Additive

Next, examples of the additives will be described. Table 13 shows the materials and characteristics of each of additives (S1, S2, S3, S4, S5, S6, S7, S8 and S9) used in this example.

In Table 13, when a plurality of types of treatment materials 1 and 2 are used, the mixing weight ratio of the treatment materials 1 and 2 is shown in parentheses. The “5-minute value” and the “30-minute value” representing the charge amount ([μC/g]) were measured by a blow-off method using frictional charge with an uncoated ferrite carrier. Specifically, under the environmental conditions of 25° C. and 45% RH, 50 g of carrier and 0.1 g of silica or the like were mixed in a 100 ml polyethylene container, and then stirred by vertical rotation at a speed of 100 min⁻¹ for 5 minutes and 30 minutes, respectively. Thereafter, 0.3 g of a sample was taken for each stirring time, and a nitrogen gas was blown on the samples at 1.96×10⁴ [Pa] for 1 minute.

TABLE 13

| Inorganic | | | | Particle | Methanol | | Ignition | Drying | 5-min | 30-min | 5-min/ |
|---|---|---|---|---|---|---|---|---|---|---|---|
| fine | | Treatment | Treatment | size | titration | Moisture | loss | loss | value | value | 30-min |
| powder | Material | material A | material B | (nm) | (%) | absorption | (wt %) | (wt %) | (μC/g) | (μC/g) | value |
| S1 | Silica | Silica treated with | | 6 | 88 | 0.1 | 10.5 | 0.2 | −820 | −710 | 86.59 |
| | | dimethylpolysiloxane | | | | | | | | | |
| S2 | Silica | Silica treated with | | 16 | 88 | 0.1 | 5.5 | 0.2 | −560 | −450 | 80.36 |
| | | methyl hydrogen | | | | | | | | | |
| | | polysiloxane | | | | | | | | | |
| S3 | Silica | Methyl hydrogen | | 40 | 88 | 0.1 | 10.8 | 0.2 | −580 | −480 | 82.76 |
| | | polysiloxane (1) | | | | | | | | | |
| S4 | Silica | Dimethylpolysiloxane | Aluminum | 40 | 84 | 0.09 | 24.5 | 0.2 | −740 | −580 | 78.38 |
| | | (20) | distearate (2) | | | | | | | | |
| S5 | Silica | Methyl hydrogen | Stearic acid | 40 | 88 | 0.1 | 10.8 | 0.2 | −580 | −480 | 82.76 |
| | | polysiloxane (1) | amide (1) | | | | | | | | |
| S6 | Silica | Dimethylpolysiloxan | Fatty acid | 80 | 88 | 0.12 | 15.8 | 0.2 | −620 | −475 | 76.61 |
| | | (2) | pentaerythritol | | | | | | | | |
| | | | monoester (1) | | | | | | | | |
| S7 | Silica | Methyl hydrogen | | 150 | 89 | 0.10 | 6.8 | 0.2 | −580 | −480 | 82.76 |
| | | polysiloxane (1) | | | | | | | | | |
| S8 | Titanium | Diphenylpolysiloxan | Sodium | 80 | 88 | 0.1 | 18.5 | 0.2 | −750 | −650 | 86.67 |
| | oxide | (10) | stearate (1) | | | | | | | | |
| S9 | Silica | Silica treated with | | 16 | 68 | 0.60 | 1.6 | 0.2 | −800 | −620 | 77.50 |
| | | hexamethyldisilazane | | | | | | | | | |

It is preferable that the 5-minute value is −100 to −800 μC/g and the 30-minute value is −50 to −600 μC/g for the negative chargeability. Silica having a high charge amount can exhibit such characteristics in a small quantity.

(7) Toner Composition and Addition Treatment

Next, the toner composition and the addition treatment will be described. Table 14 shows the composition of materials for each of magenta toners (TM1, TM2, TM3, TM4, TM5, TM6, TM7, TM8, TM9, TM10, TM11, and TM12),of the present invention and comparative magenta toners (tm21, tm22, tm23, tm24, tm25, tm26, tm27, tm28, tm29, tm30, tm31, and tm32) that were prepared as examples of producing the toner. In Table 14, each blank indicates that the additive was not added. Moreover, the values in parentheses after the additives indicate the amount (parts by weight) of the additive per 100 parts by weight of the toner base. The addition treatment was performed by using a Henschel mixer FM20B (manufactured by Mitsui Mining Co., Ltd.) with a Z0S0-type mixer blade, an input amount of 1 kg, a number of revolutions of 2000 min⁻¹, and a treating time of 5 minutes.

TABLE 14

| | Toner | Additive | Additive | Additive |
|---|---|---|---|---|
| Toner | base | A | B | C |
| TM1 | M1 | S1(0.6) | S3(2.5) | |
| TM2 | M2 | S2(1.8) | S4(1.5) | |
| TM3 | M3d | S1(1.8) | S5(1.2) | |
| TM4 | M4d | S2(2.5) | | |
| TM5 | M5d | S12.0) | S6(2.0) | |
| TM6 | M6 | S2(1.8) | S7(3.5) | |
| TM7 | M7 | S1(0.6) | S8(2.0) | S7(1.5) |
| TM8 | M8 | S1(0.6) | S7(3.5) | S7(1.5) |
| TM9 | M9 | S2(1.8) | S4(1.5) | |
| TM10 | M10 | S2(2.5) | | |
| TM11 | M11 | S1(0.6) | S7(3.5) | S7(1.5) |
| TM12 | M12 | S2(1.8) | S4(1.5) | |
| tm21 | m21 | S2(2.5) | | |
| tm22 | m22 | S2(2.5) | | |
| tm23 | m23 | S2(2.5) | | |
| tm24 | m24 | S2(2.5) | | |
| tm25 | m25 | S1(0.6) | | |
| tm26 | m26 | S2(2.5) | | |
| tm27 | m27 | S2(2.5) | | |
| tm28 | m28 | S1(0.6) | | |
| tm29 | m29 | S9(0.5) | | |
| tm30 | m30 | S1(0.6) | | |
| tm31 | m31 | S1(0.6) | | |
| tm32 | m32 | S1(0.6) | | |

The compositions of black, cyan, and yellow toners were the same as the composition of a magenta toner except that PB2, PC1, and PY1 were used as pigments, respectively.

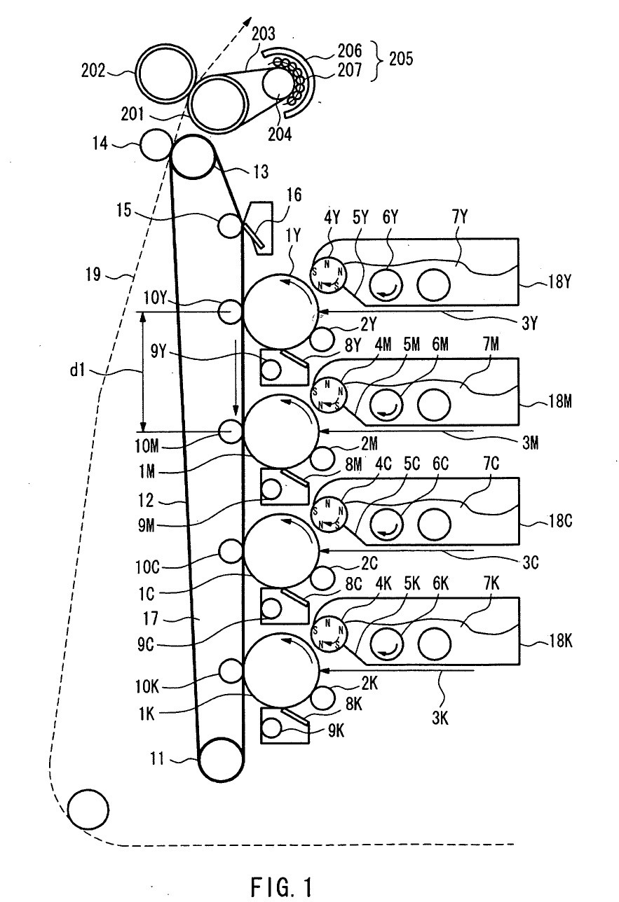

FIG. 1 is a cross-sectional view showing the configuration of a full color image forming apparatus used in this example. In FIG. 1, the outer housing of a color electrophotographic printer is not shown. A transfer belt unit 17 includes a transfer belt 12, a first color (yellow) transfer roller 10Y, a second color (magenta) transfer roller 10M, a third color (cyan) transfer roller 10C, a fourth color (black) transfer roller 10K, a driving roller 11 made of aluminum, a second transfer roller 14 made of an elastic body, a second transfer follower roller 13, a belt cleaner blade 16 for cleaning a toner image that remains on the transfer belt 12, and a roller 15 located opposite to the belt cleaner blade 16. The first to fourth color transfer rollers 10Y, 10M, 10C, and 10K are made of an elastic body. A distance between the first color (Y) transfer position and the second color (M) transfer position is 70 mm (which is the same as a distance between the second color (M) transfer position and the third color (C) transfer position and a distance between the third color (C) transfer position and the fourth color (K) transfer position). The circumferential velocity of a photoconductive member is 125 mm/s.

The transfer belt 12 can be obtained by kneading a conductive filler in an insulating resin and making a film with an extruder. In this example, polycarbonate resin (e.g., European Z300 manufactured by Mitsubishi Gas Kagaku Co., Ltd.) was used as the insulating resin, and 5 parts by weight of conductive carbon (e.g., “KETJENBLACK”) were added to 95 parts by weight of the polycarbonate resin to form a film. The surface of the film was coated with a fluorocarbon resin. The film had a thickness of about 100 μm, a volume resistance of 10⁷ to 10¹²Ω·cm, and a surface resistance of 10⁷ to 10¹²Ω/□ (square). The use of this film can improve the dot reproducibility and prevent slackening of the transfer belt 12 over a long period of use and charge accumulation effectively. By coating the film surface with a fluorocarbon resin, the filming of toner on the surface of the transfer belt 12 due to a long period of use also can be suppressed effectively. If the volume resistance is less than 10⁷Ω·cm, retransfer is likely to occur. If the volume resistance is more than 10¹²Ω·cm, the transfer efficiency is degraded.

A first transfer roller 10 is a conductive polyurethane foam including carbon black and has an outer diameter of 8 mm. The resistance value is 10² to 10⁶Ω. In the first transfer operation, the first transfer roller 10 is pressed against a photoconductive member 1 with a force of about 1.0 to 9.8 (N) via the transfer belt 12, so that the toner is transferred from the photoconductive member 1 to the transfer belt 12. If the resistance value is less than 10²Ω, retransfer is likely to occur. If the resistance value is more than 10⁶Ω, a transfer failure is likely to occur. The force less than 1.0 (N) may cause a transfer failure, and the force more than 9.8 (N) may cause transfer voids.

The second transfer roller 14 is a conductive polyurethane foam including carbon black and has an outer diameter of 10 mm. The resistance value is 10² to 10⁶Ω. The second transfer roller 14 is pressed against the follower roller 13 via the transfer belt 12 and a transfer medium 19 such as a paper or OHP sheet. The follower roller 13 is rotated in accordance with the movement of the transfer belt 12. In the second transfer operation, the second transfer roller 14 is pressed against the follower roller 13 with a force of 5.0 to 21.8 (N), so that the toner is transferred from the transfer belt 12 to the transfer medium 19. If the resistance value is less than 10²Ω, retransfer is likely to occur. If the resistance value is more than 10⁶Ω, a transfer failure is likely to occur. The force less than 5.0 (N) may cause a transfer failure, and the force more than 21.8 (N) may increase the load and generate jitter easily.

Four image forming units 18Y, 18M, 18C, and 18K for yellow (Y), magenta (M), cyan (C), and black (K) are arranged in series, as shown in FIG. 1.

The image forming units 18Y, 18M, 18C, and 18K have the same components except for a developer contained therein. For simplification, only the image forming unit 18Y for yellow (Y) will be described, and an explanation of the other units will not be repeated.

The image forming unit is configured as follows. Reference numeral 1 is a photoconductive member, 3 is pixel laser signal light, and 4 is a developing roller of aluminum that has an outer diameter of 10 mm and includes a magnet with a magnetic force of 1200 gauss. The developing roller 4 is located opposite to the photoconductive member 1 with a gap of 0.3 mm between them, and rotates in the direction of the arrow. A stirring roller 6 stirs toner and a carrier in a developing unit and supplies the toner to the developing roller 4. The mixing ratio of the toner to the carrier is read from a permeability sensor (not shown), and the toner is supplied as needed from a toner hopper (not shown). A magnetic blade 5 is made of metal and controls a magnetic brush layer of a developer on the developing roller 4. In this example, 150 g of developer was introduced, and the gap was 0.4 mm. Although a power supply is not shown in FIG. 1, a direct voltage of −500 V and an alternating voltage of 1.5 kV (p-p) at a frequency of 6 kHz were applied to the developing roller 4. The circumferential velocity ratio of the photoconductive member 1 to the developing roller 4 was 1:1.6. The mixing ratio of the toner to the carrier was 93:7. The amount of developer in the developing unit was 150 g.

A charging roller 2 is made of epichlorohydrin rubber and has an outer diameter of 10 mm. A direct-current bias of −1.2 kV is applied to the charging roller 2 for charging the surface of the photoconductive member 1 to −600 V. Reference numeral 8 is a cleaner, 9 is a waste toner box, and 7 is a developer.

A paper is conveyed from the lower side of the transfer belt unit 17, and a paper conveying path is formed so that a paper 19 is transported by a paper feed roller (not shown) to a nip portion where the transfer belt 12 and the second transfer roller 14 are pressed against each other.

The toner is transferred from the transfer belt 12 to the paper 19 by +1000 V applied to the second transfer roller 14, and then is conveyed to a fixing portion in which the toner is fixed. The fixing portion includes a fixing roller 201, a pressure roller 202, a fixing belt 203, a heat roller 204, and an induction heater 205.

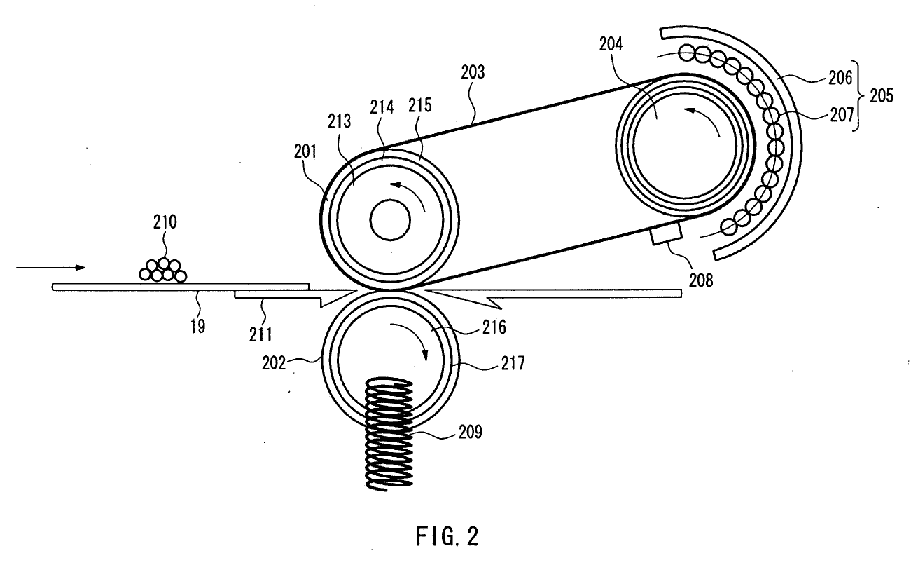

FIG. 2 shows a fixing process. A belt 203 runs between the fixing roller 201 and the heat roller 204. A predetermined load is applied between the fixing roller 201 and the pressure roller 202 so that a nip is formed between the belt 203 and the pressure roller 202. The induction heater 205 including a ferrite core 206 and a coil 207 is provided on the periphery of the heat roller 204, and a temperature sensor 208 is provided on the outer surface.

The belt 203 is formed by arranging a Ni substrate (30 μm), silicone rubber (150 μm), and PFA (tetrafluoroethylene-perfluoroalkyl vinyl ether copolymer) (30 μm) in layers.

The pressure roller 202 is pressed against the fixing roller 201 by a spring 209. A recording material 19 with the toner 210 is moved along a guide plate 211.

The fixing roller 201 (fixing member) includes a hollow core 213, an elastic layer 214 formed on the hollow core 213, and a silicone rubber layer 215 formed on the elastic layer 214. The hollow core 213 is made of aluminum and has a length of 250 mm, an outer diameter of 14 mm, and a thickness of 1 mm. The elastic layer 214 is made of silicone rubber with a rubber hardness (JIS-A) of 20 degrees based on the JIS standard and has a thickness of 3 mm. The silicone rubber layer 215 has a thickness of 3 mm Therefore, the outer diameter of the fixing roller 201 is about 26 mm. The fixing roller 201 is rotated at 125 mm/s with a driving force from a driving motor (not shown).

The heat roller 204 includes a hollow pipe having a thickness of 1 mm and an outer diameter of 20 mm. The surface temperature of the fixing belt is controlled to 170° C. with a thermistor.

The pressure roller 202 (pressure member) has a length of 250 mm and an outer diameter of 20 mm, and includes a hollow core 216 and an elastic layer 217 formed on the hollow core 216. The hollow core 216 is made of aluminum and has an outer diameter of 16 mm and a thickness of 1 mm The elastic layer 217 is made of silicone rubber with a rubber hardness (JIS-A) of 55 degrees based on the JIS standard and has a thickness of 2 mm. The pressure roller 202 is mounted rotatably, and a 5.0 mm width nip is formed between the pressure roller 202 and the fixing roller 201 under a one-sided load of 147N from the spring 209.

The operations will be described below. In the full color mode, all the first transfer rollers 10 of Y, M, C, and K are lifted and pressed against the respective photoconductive members 1 of the image forming units via the transfer belt 12. At this time, a direct-current bias of +800 V is applied to each of the first transfer rollers 10. An image signal is transmitted through the laser beam 3 and enters the photoconductive member 1 whose surface has been charged by the charging roller 2, thus forming an electrostatic latent image. The electrostatic latent image formed on the photoconductive member 1 is made visible by the toner on the developing roller 4 that is rotated in contact with the photoconductive member 1.

In this case, the image formation rate (125 mm/s, which is equal to the circumferential velocity of the photoconductive member) of the image forming unit 18Y is set so that the speed of the photoconductive member is 0.5 to 1.5% slower than the traveling speed of the transfer belt 12.

In the image forming process, signal light 3Y is input to the image forming unit 18Y, and an image is formed with Y toner. At the same time as the image formation, the Y toner image is transferred from the photoconductive member 1Y to the transfer belt 12 by the action of the first transfer roller 10Y, to which a direct voltage of +800 V is applied.

There is a time lag between the first transfer of the first color (Y) and the first transfer of the second color (M). Then, signal light 3M is input to the image forming unit 18M, and an image is formed with M toner. At the same time as the image formation, the M toner image is transferred from the photoconductive member 1M to the transfer belt 12 by the action of the first transfer roller 10M. In this case, the M toner is transferred onto the first color (Y) toner that has been formed on the transfer belt 12. Subsequently, the C (cyan) toner and K (black) toner images are formed in the same manner and transferred by the action of the first transfer rollers 10C and 10K. Thus, YMCK toner images are formed on the transfer belt 12. This is a so-called tandem process.

A color image is formed on the transfer belt 12 by superimposing the four color toner images in registration. After the last transfer of the K toner image, the four color toner images are transferred collectively to the paper 19 fed by a feeding cassette (not shown) at matched timing by the action of the second transfer roller 14. In this case, the follower roller 13 is grounded, and a direct voltage of +1 kV is applied to the second transfer roller 14. The toner images transferred to the paper 19 are fixed by a pair of fixing rollers 201 and 202. Then, the paper 19 is ejected through a pair of ejecting rollers (not shown) to the outside of the apparatus. The toner that is not transferred and remains on the transfer belt 12 is cleaned by the belt cleaner blade 16 to prepare for the next image formation.

Example of Visual Image Evaluation

Next, an example of evaluating visual images with toner and a two-component developer will be described. Using an image forming apparatus, running durability tests with 100,000 sheets of A4 paper were conducted for each of various types of two-component developers that differed in a mixing ratio of the toner to the carrier, and the charge amount and the image density were measured. Moreover, background fog in a non-image portion, the uniformity of a solid image, the transfer properties (skipping in characters during transfer, reverse transfer, and transfer voids), and toner filming of the output samples were evaluated. The image density (ID) evaluation was performed by measuring a solid black portion with a reflection densitometer RD-914 (manufactured by Macbeth Division of Kollmorgen Instruments Corporation).

The charge amount was measured by a blow-off method using frictional charge with a ferrite carrier. Specifically, under the environmental conditions of 25° C. and 45% RH, 0.3 g of sample was taken to evaluate the durability, and a nitrogen gas was blown on the sample at 1.96×10⁴ Pa for 1 minute.

Table 15 shows the compositions of the toner and the carrier as the two-component developer, and the results of evaluation of the running durability test with 100,000 sheets of A4 paper for each of two-component developers (DM11, DM12, DM13, DM14, DM15, DM16, DM17, DM18, DM19, DM20, DM21, and DM22) according to the exampled of the present invention and comparative two-component developers (cm24, cm25, cm26, cm27, cm28, cm29, cm30, cm31, and cm32) that were used in this example. In Table 15, “◯” indicates that the evaluation was good, and “X” indicates that there were some problems.

TABLE 15

| | | | Filming on | | | | Uniformity | Transfer | | |
|---|---|---|---|---|---|---|---|---|---|---|
| | | | photoconductive | Image density (ID) | | | of solid | skipping in | Reverse | Transfer |
| Developer | Toner | Carrier | member | initial/after test | | Fog | image | characters | transfer | voids |
| DM11 | TM1 | A1 | Not occur | 1.45 | 1.44 | ∘ | ∘ | ∘ | ∘ | ∘ |
| DM12 | TM2 | B1 | Not occur | 1.48 | 1.45 | ∘ | ∘ | ∘ | ∘ | ∘ |
| DM13 | TM3 | C1 | Not occur | 1.50 | 1.52 | ∘ | ∘ | ∘ | ∘ | ∘ |
| DM14 | TM4 | A2 | Not occur | 1.35 | 1.32 | ∘ | ∘ | ∘ | ∘ | ∘ |
| DM15 | TM5 | A1 | Not occur | 1.46 | 1.42 | ∘ | ∘ | ∘ | ∘ | ∘ |
| DM16 | TM6 | B1 | Not occur | 1.44 | 1.41 | ∘ | ∘ | ∘ | ∘ | ∘ |
| DM17 | TM7 | A1 | Not occur | 1.42 | 1.41 | ∘ | ∘ | ∘ | ∘ | ∘ |
| DM18 | TM8 | C1 | Not occur | 1.49 | 1.42 | ∘ | ∘ | ∘ | ∘ | ∘ |
| DM19 | TM9 | A2 | Not occur | 1.36 | 1.32 | ∘ | ∘ | ∘ | ∘ | ∘ |
| DM20 | TM10 | A1 | Not occur | 1.35 | 1.32 | ∘ | ∘ | ∘ | ∘ | ∘ |
| DM21 | TM11 | A1 | Not occur | 1.49 | 1.42 | ∘ | ∘ | ∘ | ∘ | ∘ |
| DM22 | TM12 | A1 | Not occur | 1.44 | 1.41 | ∘ | ∘ | ∘ | ∘ | ∘ |
| cm24 | tm24 | A1 | Not occur | 1.44 | 1.40 | x | x | x | x | x |
| cm25 | tm25 | A1 | Not occur | 1.45 | 1.44 | x | x | x | x | x |
| cm26 | tm26 | B1 | Occur | 1.48 | 1.45 | x | x | x | x | x |
| cm27 | tm27 | C1 | Occur | 1.50 | 1.52 | x | x | x | x | x |
| cm28 | tm28 | A2 | Occur | 1.35 | 1.32 | x | x | x | x | x |
| cm29 | tm29 | A1 | Occur | 1.46 | 1.42 | x | x | x | x | x |
| cm30 | tm30 | B1 | Occur | 1.44 | 1.41 | x | x | x | x | x |
| cm31 | tm31 | C1 | Occur | 1.49 | 1.42 | x | x | x | x | x |
| cm32 | tm32 | B1 | Occur | 1.48 | 1.45 | x | x | x | x | x |

For all the two-component developers DM11 to DM22 according to the examples of the present invention, toner filming on the photoconductive member was not a problem for practical use after the running durability test with 100,000 sheets of A4 paper. The toner filming on the transfer belt also was not a problem for practical use. Moreover, a cleaning failure of the transfer belt did not occur. In the case of a full color image formed by superimposing three colors, a paper was not wound around the fixing belt.

With respect to the image density before and after the running durability test, high-resolution images having a density of 1.3 or more were obtained by each of the two-component developers DM11 to DM22 according to the examples of the present invention. Even after the durability test with 100,000 sheets of A4 paper, the flowability of the two-component developers was stable, the image density was 1.3 or more and not changed much, and stable characteristics were maintained.

With respect to fog in the non-image portion and the solid image uniformity, the two-component developers DM11 to DM22 according to the examples of the present invention had a high image density, caused neither background fog in the non-image portion nor toner scattering, and achieved high resolution. The solid images in development also had good uniformity.

Moreover, no streak occurred in the images over continuous use. There was almost no spent of the toner components on the carrier. Both a change in carrier resistance and a decrease in charge amount were suppressed. When the solid images were developed continuously, and then the toner was supplied quickly, the charge build-up property was good. Fog was not increased under high humidity conditions. Moreover, high saturation charge was maintained over a long period of use. The charge amount hardly varied at low temperature and low humidity.

With respect to the transfer properties (skipping in characters during transfer, reverse transfer, and transfer voids), for all the two-component developers DM11 to DM22 according to the examples of the present invention, transfer voids or the like were not a problem for practical use, and no transfer defect occurred in the full color image consisting of three superimposed colors. The transfer efficiency was about 95%.

Even if the mixing ratio of the toner to the carrier was changed by 5 to 20 wt %, the two-component developers DM11 to DM22 according to the examples of the present invention changed little in image density and image quality such as background fog. Thus, the toner concentration was controlled in a wide range.

On the other hand, toner filming on the photoconductive member occurred in the comparative two-component developers cm24 to cm32 during the running durability test. With respect to the image density before and after the running durability test, the image density was low or reduced due to an increase in charge amount over a long period of use, and fog in the non-image portion was increased. When the solid images were developed continuously, and then the toner was supplied quickly, the charge was decreased, and fog was increased. This phenomenon became worse, particularly under high humidity conditions. Moreover, when the mixing ratio of the toner to the carrier was in the range of 6 to 8 wt %, the image density and the image quality such as background fog were changed little, even if the toner concentration was changed. However, the image density was reduced as the mixing ratio was smaller than this range, while the background fog was increased as the mixing ratio was larger than this range.

Next, Table 16 shows the results of the evaluation of the fixability, offset resistance, high-temperature storage stability, and winding of paper around the fixing belt of a full color image. In Table 16, “◯” indicates that the evaluation was good, and “X” indicates that there were some problems. In this case, a solid image was fixed in an amount of 1.2 mg/cm² at a process speed of 125 mm/s by using a fixing device provided with an oilless belt, and the OHP film transmittance (fixing temperature: 160° C.), the minimum fixing temperature, and the temperature at which high-temperature offset occurs were measured. As to the storage stability, the state of the toner was evaluated after being left standing at 55° C. for 24 hours. The OHP film transmittance was measured with 700 nm light by using a spectrophotometer (U-3200 manufactured by Hitachi, Ltd.).

TABLE 16

| | OHP | Minimum fixing | High-temperature | Storage | |
|---|---|---|---|---|---|
| | transmittance | temperature | offset generation | stability | Winding around |
| Toner | (%) | (° C.) | temperature (° C.) | test | fixing belt |
| TM1 | 88.9 | 125 | 210 | ∘ | Not occur |
| TM2 | 87.9 | 130 | 210 | ∘ | Not occur |
| TM3 | 82.7 | 135 | 220 | ∘ | Not occur |
| TM4 | 83.2 | 135 | 220 | ∘ | Not occur |
| TM5 | 87.4 | 130 | 220 | ∘ | Not occur |
| TM6 | 86.7 | 130 | 220 | ∘ | Not occur |
| TM7 | 86.9 | 130 | 220 | ∘ | Not occur |
| TM8 | 83.5 | 135 | 220 | ∘ | Not occur |
| TM9 | 82.1 | 140 | 230 | ∘ | Not occur |
| TM10 | 83.2 | 135 | 220 | ∘ | Not occur |
| TM11 | 83.5 | 135 | 220 | ∘ | Not occur |
| tm22 | 88.9 | 135 | 160 | ∘ | Occur |
| tm23 | 64.2 | 170 | 230 | ∘ | Not occur |
| tm26 | 90.2 | 140 | 180 | x | Occur |
| tm27 | 83.2 | 150 | 210 | x | Occur |
| tm28 | 81.8 | 150 | 210 | x | Occur |
| tm29 | 90.7 | 130 | 140 | x | Occur |
| tm30 | 55.1 | 180 | 230 | ∘ | Not occur |

All the toners TM1 to TM11 according to the examples of the present invention exhibited good fixability, since the OHP film transmittance was 80% or more. With respect to the offset resistance, the offset resistance temperature range was increased by using the fixing roller without oil. Moreover, the fixable temperature range (from the minimum fixing temperature to the temperature at which high-temperature offset occurs) was wide. No offset occurred in the test of the formation of full color solid images on 200,000 sheets of plain paper. Even if a silicone or fluorine-based fixing belt was used without oil, the surface of the belt did not wear. With respect to the high temperature storage stability, agglomeration hardly was observed in the storage stability test of 50° C. for 24 hours. With respect to the winding of paper around the fixing belt, no paper jam occurred in the nip portion of the fixing device.

For the toners tm22, tm26, and tm29, the offset resistance was low, and a margin of the fixable range was narrow. For the toners tm23 and tm30, the low-temperature fixability was low, and a margin of the fixable range was narrow. For the toners tm26, tm27, tm28, and tm29, the storage stability was degraded, which was attributed to the effect of suspended wax or resin particles remaining in the toner.

### INDUSTRIAL APPLICABILITY

The present invention is useful not only for an electrophotographic system including a photoconductive member, but also for a printing system in which the toner adheres directly on paper or the toner including a conductive material is applied on a substrate as a wiring pattern.

1. A toner comprising aggregated particles produced by preparing in an aqueous medium a mixed dispersion comprising at least a first resin particle dispersion in which first resin particles are dispersed, a colorant particle dispersion in which colorant particles are dispersed, and a wax particle dispersion in which wax particles are dispersed, heating the mixed dispersion so that at least part of the wax particles is melted, and aggregating the first resin particles, the colorant particles, and the wax particles at least part of which is melted by addition of an aqueous solution containing an aggregating agent.

2. The toner according to claim 1, wherein the aggregating agent is added after a water temperature of the aqueous medium reaches a melting point or more of the wax particles.

3. The toner according to claim 1, wherein the colorant particles are carbon particles, and a color of the toner is black.

4. The toner according to claim 1, wherein the wax particles comprise at least a first wax and a second wax,
an endothermic peak temperature (melting point Tmw1 (° C.)) of the first wax based on a DSC method is 50° C. to 90° C.,
an endothermic peak temperature (melting point Tmw2 (° C.)) of the second wax based on the DSC method is 80° C. to 120° C., and
the melting point of the second wax is 5° C. to 50° C. higher than that of the first wax.

5. The toner according to claim 1, wherein at least one dispersion selected from the first resin particle dispersion, the colorant particle dispersion, and the wax particle dispersion is produced by emulsification and dispersion treatment with a surface-active agent that includes a nonionic surface-active agent.

6. The toner according to claim 1, wherein the aggregating agent is at least one water-soluble inorganic salt selected from an alkali metal salt and an alkaline-earth metal salt.

7. The toner according to claim 1, wherein the mixed dispersion comprising the first resin particle dispersion, the colorant particle dispersion, and the wax particle dispersion has a pH of 8.4 to 10.4, and when this pH is identified as HG, a pH of the aqueous solution containing the aggregating agent is adjusted in a range of HG+2 to HG−4.

8. The toner according to claim 1, wherein the aggregated particles serve as core particles, and a second resin particle dispersion in which second resin particles are dispersed is added, mixed, and heated so that the second resin particles are fused with the surfaces of the core particles.

9. The toner according to claim 8, wherein the second resin particle dispersion has a pH of 3.5 to 11.5.

10. The toner according to claim 8, wherein a surface-active agent used for at least one resin dispersion selected from the first resin particle dispersion and the second resin particle dispersion is a mixture of a nonionic surface-active agent and an ionic surface-active agent, and
the nonionic surface-active agent is 50 to 95 wt % of a total surface-active agent.

11. A method for producing a toner comprising:
preparing in an aqueous medium a mixed dispersion comprising at least a first resin particle dispersion in which first resin particles are dispersed, a colorant particle dispersion in which colorant particles are dispersed, and a wax particle dispersion in which wax particles are dispersed;
heating the mixed dispersion so that at least part of the wax particles is melted; and
producing aggregated particles by aggregating the first resin particles, the colorant particles, and the wax particles at least part of which is melted by addition of an aqueous solution containing an aggregating agent.

12. The method according to claim 11, wherein the aggregating agent is added after a water temperature of the aqueous medium reaches a melting point or more of the wax particles.

13. The method according to claim 11, wherein the colorant particles are carbon particles, and a color of the toner is black.

14. The method according to claim 11, wherein the wax particles comprise at least a first wax and a second wax,
an endothermic peak temperature (melting point Tmw1 (° C.)) of the first wax based on a DSC method is 50° C. to 90° C.,
an endothermic peak temperature (melting point Tmw2 (° C.)) of the second wax based on the DSC method is 80° C. to 120° C., and
the melting point of the second wax is 5° C. to 50° C. higher than that of the first wax.

15. The method according to claim 11, wherein at least one dispersion selected from the first resin particle dispersion, the colorant particle dispersion, and the wax particle dispersion is produced by emulsification and dispersion treatment with a surface-active agent that includes a nonionic surface-active agent.

16. The method according to claim 11, wherein the aggregating agent is at least one water-soluble inorganic salt selected from an alkali metal salt and an alkaline-earth metal salt.

17. The method according to claim 11, wherein the mixed dispersion comprising the first resin particle dispersion, the colorant particle dispersion, and the wax particle dispersion has a pH of 8.4 to 10.4, and when this pH is identified as HG, a pH of the aqueous solution containing the aggregating agent is adjusted in a range of HG+2 to HG−4.

18. The method according to claim 11, wherein the aggregated particles serve as core particles, and a second resin particle dispersion in which second resin particles are dispersed is added, mixed, and heated so that the second resin particles are fused with the surfaces of the core particles.

19. The method according to claim 18, wherein the second resin particle dispersion has a pH of 3.5 to 11.5.

20. The method according to claim 18, wherein a surface-active agent used for at least one resin dispersion selected from the first resin particle dispersion and the second resin particle dispersion is a mixture of a nonionic surface-active agent and an ionic surface-active agent, and
the nonionic surface-active agent is 50 to 95 wt % of a total surface-active agent.
